(19) United States
(12) Patent Application Publication
(10) Pub. No.: US 2026/0195406 A1
(43) Pub. Date: Jul. 9, 2026

(54) Hierarchical Activation Broadcast Network for Column-Oriented Neural-Network Compute Arrays

(71) Applicant: Kia Silverbrook, Sydney (AU)

(72) Inventor: Kia Silverbrook, Sydney (AU)

(21) Appl. No.: 19/433,853

(22) Filed: Dec. 28, 2025

Related U.S. Application Data
(60) Provisional application No. 63/739,623, filed on Dec. 29, 2024.
(60) Provisional application No. 63/739,624, filed on Dec. 29, 2024.
(60) Provisional application No. 63/739,635, filed on Dec. 29, 2024.
(60) Provisional application No. 63/739,638, filed on Dec. 29, 2024.
(60) Provisional application No. 63/739,642, filed on Dec. 29, 2024.
(60) Provisional application No. 63/739,659, filed on Dec. 29, 2024.
(60) Provisional application No. 63/739,660, filed on Dec. 29, 2024.
(60) Provisional application No. 63/756,064, filed on Feb. 8, 2025.
(60) Provisional application No. 63/784,978, filed on Apr. 8, 2025.
(60) Provisional application No. 63/852,850, filed on Jul. 29, 2025.
(60) Provisional application No. 63/863,514, filed on Aug. 14, 2025.
(60) Provisional application No. 63/867,005, filed on Aug. 20, 2025.

(51) Int. Cl. G06F 17/16

(52) U.S. Cl. CPC G06F 17/16

(57) ABSTRACT

A hierarchical activation-broadcast network for column-oriented neural-network compute arrays is disclosed. Activation values corresponding to each processing row are distributed concurrently to all columns of processing elements through a hierarchical latch tree that fans out the signals synchronized within one clock period. The broadcast network maintains precise timing alignment among columns while minimizing capacitive loading and clock skew. The distribution fabric may be fabricated on a separate die or interposer and connected to the compute die by high-density hybrid bonds. The approach enables wide, low-skew activation delivery across large arrays, reducing energy consumption and improving frequency scalability for CASCADE architectures.

### TECHNICAL FIELD

The present invention relates to signal-distribution networks for neural-network compute hardware and, more particularly, to hierarchical and resonant activation-broadcast networks that deliver activation values with minimal skew to column-oriented matrix-multiplication arrays.

### BACKGROUND

Matrix-multiplication accelerators employing column-oriented computation require that activation values for each processing row be broadcast to all columns with precise timing alignment. As array dimensions and frequencies increase, the capacitive load and skew associated with conventional bus-based distribution networks become a dominant limitation. Clock and signal distribution meshes used for timing synchronization consume substantial power and area when scaled to large arrays. There is therefore a need for a hierarchical broadcast network that can fan out activation values efficiently while maintaining synchronization among thousands of columns, particularly in three-dimensional and wafer-scale implementations.

### SUMMARY OF THE INVENTION

The invention provides activation-distribution architectures that deliver row-wise activation values simultaneously to all columns of a column-oriented compute array with minimal skew and energy loss. A hierarchical or resonant broadcast network replaces conventional wide bus routing and enables synchronous activation arrival across very large arrays.

In one aspect, a computing apparatus comprises processing elements arranged as vertical columns and a broadcast-distribution network implemented as a hierarchical latch tree or resonant mesh. For each processing row, an activation value is concurrently delivered through the network to all columns. The hierarchical structure divides the capacitive load over multiple branching stages, while the resonant mesh equalizes propagation delay and reduces power consumption.

In another aspect, a three-dimensional integrated circuit stack includes a compute die containing the column arrays and a second die or interposer implementing the broadcast network. High-density hybrid bonds couple the activation outputs of the second die to the column inputs of the compute die, providing uniform electrical path length and low-skew timing. The network may include phase-balanced routing, synchronization latches, and active repeaters to preserve timing uniformity.

In a further aspect, a method distributes activation values by propagating signals through hierarchical or resonant structures such that all columns receive each activation within one clock period. Multiple broadcast planes may be used to deliver independent activation groups concurrently. Phase and drive parameters can be adaptively tuned based on temperature or supply conditions to maintain uniform arrival time across columns.

The hierarchical activation broadcast network thereby enables large CASCADE arrays to operate synchronously without the power or routing penalties of a monolithic high-fan-out driver network.

### BRIEF DESCRIPTION OF THE DRAWINGS

Specific embodiments of the invention will now be described, by way of a non-limiting example only, with reference to the accompanying drawings, in which:

FIG. 1 shows a 300 mm silicon wafer configured as a WSSCB ZettaLith.

FIG. 2a shows a 1×4 SCB module array showing stress relief structures in the SCB.

FIG. 2b shows a V beam stress relief structure for high interconnect density regions.

FIG. 2c shows an enlargement of a Fermat-Archimedean (FA) spiral stress relief structure aligned in the Y direction on the wafer.

FIG. 2d shows a FA spiral stress relief structure aligned in the X direction on the wafer.

FIG. 3a shows a FA spiral stress relief structure in nominal position, with no stress.

FIG. 3b shows a FA spiral stress relief structure under tensile stress, showing expansive strain.

FIG. 3c shows a FA spiral stress relief structure under compressive stress, showing compression strain.

FIG. 3d shows a FA spiral stress relief structure under shear stress, showing in-plane shear strain.

FIG. 3e shows a FA spiral stress relief structure in nominal position, showing the position of the cross section of FIGS. 3f and 3g.

FIG. 3f shows a cross section of the FA spiral stress relief structure of FIG. 3e.

FIG. 3g shows a cross section of the FA spiral stress relief structure of FIG. 3e with large out-of-plane deflection caused by a foreign particle in manufacturing equipment or in use.

FIG. 3h shows a V beam SCB stress relief structure suitable for high signal densities.

FIG. 3i shows an enlargement of a section of a V beam SCB stress relief structure.

FIG. 4a shows a cross section of four layers of signals lines in a silicon interposer RDL, with signal lines in two orthogonal directions (prior art)

FIG. 4b shows a cross section of four layers of signals lines, with extensive fault tolerance.

FIG. 5 shows a cross section of a small portion of a WSSCB attached to a TRIMERA stack

FIG. 6a shows the main signal interconnects between the HBM stack, the BID, the HILT, and the ZSLD of an SCB module.

FIG. 6b shows the SHAPE format ZSLD of the TRIMERA stack.

FIG. 6c shows the HILT die of the TRIMERA stack.

FIG. 6d shows the BID of the TRIMERA stack, showing approximate areas for functions.

FIG. 7a shows the edge-to-edge CASCADE arrays of the SHAPE ZSLD.

FIG. 7b shows the FP4 processing elements of CASCADE array.

FIG. 8 shows a block diagram of the CREST and CASCADE logic between successive CASCADE arrays of FP4 processing elements (PE).

FIG. 9 shows a block diagram of the bias addition, extra-large array accumulation, and storage of completed sums at the end of the columns of CASCADE arrays.

FIG. 10a shows CREST testing column 4 of a small section of a CASCADE array, with no defects. Each square is a CASCADE column of 64 PEs, not a single PE.

FIG. 10b shows CREST testing column 5, with a defect detected.

FIG. 10c shows CREST testing if the defect in column 5 is in CRow(1).

FIG. 10d shows CREST testing if the defect in column 5 is in CRow(2).

FIG. 10e shows CREST testing if the defect in column 5 is in CRow(3).

FIG. 10f shows CREST repairing the defect in column 5, CRow(3) using a spare CASCADE column.

FIG. 10g shows CREST testing column 13 after having repaired multiple faults in the first 16 CRows of an array.

FIG. 11a shows a top view of a ZettaLith PSU PCB.

FIG. 11b shows a side view of a ZettaLith PSU PCB.

FIG. 11c shows an end view of a ZettaLith PSU PCB from the WSSCB end.

FIG. 11d shows an end view of a ZettaLith PSU PCB from the 48 VDC power end.

FIG. 12a shows a top view of a ZettaLith PSU PCB stack, with a side view of the 800 GbE PCBs.

FIG. 12b shows a side view of a ZettaLith PSU PCB stack, with a side view of the PCIe 6.0 PCBs.

FIG. 13 shows an end view of a ZettaLith PSU PCB stack, with an end view of the 800 GbE PCBs and PCIe 6.0 PCBs.

FIG. 14 shows a cross section of a ZettaLith tank using JETSTREAM 2-PIC cooling.

FIG. 15 shows a cross section of a ZettaLith pressure vessel using JETSCI supercritical CO₂.

FIG. 16 shows a block diagram of an ExaLith PCIe card.

FIG. 17 shows a cross section of a small part of a prior-art silicon interposer.

FIG. 18a shows a cross section of a small section of an SCB after formation of the integrated DTC decoupling capacitors.

FIG. 18b shows the SCB cross section after DRIE of blind holes for large diameter low density power and ground TSVs.

FIG. 18c shows the SCB cross section after silicon oxide layer, stress polymer layer, electroplating seed layer, and copper electroplating fill of the TSVs.

FIG. 18d shows the SCB cross section after all RDL layers have been formed using prior art processing flows.

FIG. 18e shows the SCB cross section after the RDL layers have been etched using a mask for silicon spring gaps and SCB edges.

FIG. 18f shows the SCB cross section after inversion and attachment to a handle wafer.

FIG. 18g shows the inverted SCB cross section after backgrinding and a scratch-removal plasma etch.

FIG. 18h shows the inverted SCB cross section after TSV and silicon planarization using CMP.

FIG. 18i shows the inverted SCB cross section after dielectric deposition and etch, and UBM deposition and etch.

FIG. 18j shows the inverted SCB cross section after deposition, exposure and developing of the backside DRIE mask, and use of that mask to etch the backside dielectric layer.

FIG. 18k shows the inverted SCB cross section after full thickness backside DRIE of the spring gaps and SCB edges.

FIG. 18l shows the SCB cross section after re-inversion and detachment from the handle wafer.

FIG. 18m shows the SCB cross section after underfill.

FIG. 19a shows a top view of a portion of the MEMS probe chip.

FIG. 19b shows a side view of MEMS spiral probes as they make initial contact with the SCB under test.

FIG. 19c shows a side view of MEMS spiral probes when they are fully compressed in contact with the SCB under test.

### GLOSSARY OF NEW TERMS

This glossary defines terms and acronyms that are new or unique to the ZettaLith technology. Acronyms that are common in the semiconductor and AI hardware industries (e.g., HBM, UCIe, PCIe, HBF, 2-PIC, W4A8) retain their standard meanings and are not redefined here.

### ABLT—Activation Broadcast Latch Tree

The activation broadcast latch tree (ABLT) takes the activations HILT FP8 outputs and replicates the one activation to be provided simultaneously to all columns (including spare/CREST columns) of the cascade array.

### All-Silicon Domain

A contiguous region of silicon-fabricated circuitry in which the active processing elements and their high-bandwidth interconnects are integrated entirely with semiconductor (typically silicon) substrates, excluding conventional board-level and rack-level interconnection mechanisms such as printed circuit boards, backplanes, Ethernet cables, and optical fibers. The WSSCB enables the formation of large all-silicon domains. PSGCBs are specifically included in the definition of all-silicon domain, as the fast data is limited to the RDL layers of the panel, and do not traverse the panel glass. If implemented at the same line width, chip-stack to chip-stack ZettaLinks and HBM links will have comparable performance on a PSGCB as a WSSCB.

### BID—Base Interface Die

A semiconductor die incorporating high-speed I/O, control, and test circuitry that supports TRIMERA or CPU stacks. The BID provides standardized interfaces between internal and external connections, including HBM and HBF memory stacks and adjacent BID-enabled TRIMERA or CPU stacks, using UCIe 2.0 data-fabric links.

### BID Array

A distributed set of Base Interface Dies that collectively form the interface layer between TRIMERA compute stacks and I/O wiring in redistribution layers. The array aggregates control, clock, and communication functions to scale bandwidth across the WSSCB or PSGCB.

### BN ZettaLith

A ZettaLith configuration in which TRIMERA stacks contain CASCADE arrays of BitNet 1.58 processing elements (PEs) instead of FP4 PEs, optimized for ultra-low-precision transformer inference.

CASCADE—Column-Array Systolic Computation with Accumulation During Execution

A column-oriented matrix-multiply architecture that eliminates data skewing and inter-chip partial-sum transfers by performing independent vertical computation down each of many parallel columns.

### CASCADE Column

The minimal compute unit within a CASCADE array, consisting of a vertical chain of PEs that perform systolic multiply-accumulate operations with local accumulation.

### CREST—Cyclic Redundant Spare Testing

A real-time fault-tolerance system integrated into the ZettaLith architecture that continuously monitors, isolates, and remaps defective CASCADE columns during AI inference to maintain full-array yield and reliability.

### CREST Column-Redundancy Ratio (CREST CRR)

The percentage of spare CASCADE columns per CASCADE row reserved for automatic substitution under CREST control, determining fault-tolerance headroom of PEs, at the granularity of CASCADE columns of 32 PEs.

### CREST Row-Redundancy Ratio (CREST RRR)

The percentage of spare CASCADE rows per CASCADE array reserved for automatic substitution under CREST control, determining fault-tolerance headroom of Activation HILTs and ABLTs.

### ExaLith

An exa-scale AI inference system for desktop and workstation environments. ExaLith employs a small number of ZettaLith chips in the form of silicon module for inclusion in board-level systems, e.g. PCIe card AI accelerators, network attached AI accelerators, server blades, drive computers, humanoid robot computers, and other configurations. The ZettaLith related portions of the software of ExaLith systems are software-compatible with ZettaLith.

### FA Spiral—Fermat-Archimedean Spiral

A silicon spring design that combines Fermat and Archimedean spiral geometries to elastically release stress in the X, Y, and Z directions simultaneously while maintaining a compact footprint.

### Folded Beam

A silicon spring geometry that balances mechanical compliance and routing density, providing a compromise between thermal stress relief and signal-path compactness.

### GCB—Glass Circuit Board

A glass substrate that serves as a circuit board replacement for traditional PCBs. A GCB is analogous to a silicon interposer but fabricated using flat-panel-display manufacturing methods. A PSGCB is a panel-scale GCB.

### HILT—Hierarchical Integrated Latch Tree

A sequential-access memory structure composed of pipelined latch arrays multiplexed via transmission gates in a hierarchical tree topology. It replaces traditional SRAM in ultra-high-bandwidth applications such as AI inference but is not a general SRAM substitute.

JETSCI—Jet-Enhanced Thermoregulation using Supercritical CO₂ Immersion

A cooling system that directs precisely tuned jets of supercritical CO₂ (sCO₂) within a fully immersed environment to achieve high local heat-transfer coefficients on silicon surfaces.

### JETSCI Manifold

A 3D-printed manifold that distributes sCO₂ coolant jets precisely across multiple hot surfaces in a JETSCI cooling assembly.

### JETSTREAM—Jet-Surface Thermal Regulation via Evaporative Array Manifold

A two-phase immersion cooling system that directs arrays of coolant jets to microchannel heat-sink fins etched into the back surfaces of silicon chips, enabling sustained heat fluxes above 500 W/cm².

### JETSTREAM Manifold

A 3D-printed manifold that distributes two-phase coolant jets evenly across multiple chips, ensuring uniform temperature control in high-density ZettaLith assemblies.

### PetaLith

A peta-scale edge-optimized semiconductor IP core derived from ZettaLith technology. PetaLith targets AI inference and embedded workloads in cost, size, thermal and electrical power-constrained environments without employing the full ZettaLith chip set.

### PSGCB—Panel-Scale Glass Circuit Board

A passive glass substrate manufactured using flat-panel-display processes, substituting for a WSSCG, but with potentially larger area and therefore allowing more chip-stacks to be attached in a single all silicon domain.

### SCB—Silicon Circuit Board

A passive silicon substrate analogous to a printed-circuit board but fabricated on a silicon wafer using semiconductor processes. The SCB contains only interconnects and no active devices. It supports attachment of chiplets and TRIMERA stacks via microbumps, replacing traditional PCBs, package substrates, and silicon interposers.

### SHAPE—Simple Hybrid Array of Processing Elements

A processing architecture employing a ZettaLith SOTA Logic Die (ZSLD) containing a high-density array of ultra-simple PEs. The logic die can be custom-fabricated before the availability of standard-cell libraries or mixed-signal IP; circuits requiring these functions reside on other dies hybrid-bonded to the ZSLD.

### Silicon Springs

Micromechanical structures etched into silicon to provide thermal and mechanical stress relief. These features isolate sources of thermal and mechanical stress by orders of magnitude, typically limiting propagated stress to ~1 cm² regions.

### TRIMERA—TRIchip Module for Exascale Reasoning Applications

A high-performance 3D integrated-circuit architecture consisting of three vertically stacked silicon dies—logic, memory, and interface—hybrid-bonded together to form a dedicated AI inference accelerator.

### TRIMERA Stack

The physical assembly of the three TRIMERA dies with vertical interconnects, forming a self-contained compute tile attachable to the WSSCB.

### V-beam

A silicon spring geometry optimized for routing density and minimal signal skew, trading some mechanical compliance for higher interconnect capacity.

### WSSCB—Wafer-Scale Silicon Circuit Board

A wafer-scale array of SCBs. A WSSCB is a passive silicon substrate analogous to a printed-circuit board but fabricated on a full 300 mm wafer using semiconductor processes. The WSSCB wafer contains only interconnects and no active devices. It supports attachment of chiplets and TRIMERA stacks via microbumps, replacing traditional PCBs, package substrates, and silicon interposers. A WSSCB enables large all-silicon domains.

### ZettaLink

A high-bandwidth, intra-system interconnect fabric linking TRIMERA stacks across a WSSCB or PSGCB. ZettaLink aggregates multiple UCIe 2.0 lanes to form a coherent, low-latency mesh for ultra-high bandwidth AI inference.

### ZettaLith

A zetta-scale AI inference system combining a passive WSSCB with CASCADE arrays in SHAPE format, TRIMERA stacks, CREST fault tolerance, and advanced JETSTREAM or JETSCI cooling.

### ZettaPanel

A zetta-scale AI inference system structurally similar to ZettaLith but employing a PSGCB instead of a silicon WSSCB. ZettaPanel offers larger potential size and performance but carries higher risk due to the relative immaturity of large-panel glass processing for through-panel vias and high density wiring.

### ZSLD—ZettaLith State-of-the-Art Logic Die

A semiconductor die fabricated in the most advanced available process node (e.g., TSMC A16 or A14), containing digital logic circuits optimized for high performance and low power, and typically using SHAPE principles. The ZSLD forms the computational core of each TRIMERA stack.

### DETAILED DESCRIPTION

Transformer neural networks have become the dominant architecture for state-of-the-art artificial intelligence applications, with model sizes rapidly expanding into the trillions of parameters. However, the computational demands of these models have created significant practical constraints on their deployment and application. Inference costs, particularly for reasoning models, remain a limiting factor for widespread utilization of large transformer models in many applications.

### ZettaLith

ZettaLith is a novel compute engine optimized specifically for transformer inference that achieves a calculated 1.452 zettaFLOPS (1,452,571 sparse PFLOPS) using FP4 weights and FP8 activations (W4A8). ZettaLith enables inference of AI models with up to 20 trillion parameters within a single rack consuming 198 kW for compute. The system represents a fundamental rethinking of the computing stack for AI inference, enabling an alternative to current systems where large transformer models must be distributed across multiple devices, racks, and communication fabrics.

The ZettaLith architecture is a wafer-scale, 3D-stacked compute system designed to deliver AI inference performance and cost improvements exceeding three orders of magnitude relative to current GPU-based racks. Power efficiency improves by more than two orders of magnitude.

ZettaLith is built as a distributed array of 24.2 billion high-speed processing elements, arranged so that the entire transformer inference workload remains within a single 260 mm×200 mm×2 mm all-silicon domain—without ever traversing the multilayer hierarchy of PCBs, backplanes, cables, racks, or optical links that dominate latency, cost, and power consumption in GPU-based AI datacenters.

ZettaLith is optimized exclusively for inference. A single silicon domain can host and inference LLMs up to 20 trillion parameters, along with other transformer-based models, without off-domain communication. The architecture scales down naturally to ExaLith desktop systems and PetaLith edge devices. Multiple subsystem design alternatives are included to provide engineering flexibility while preserving the core performance and efficiency gains.

### Specialization

ZettaLith is explicitly specialized for AI inference with FP4 weights and FP8 activations. It does not support AI training or high performance computing (HPC) workloads, nor does it attempt to preserve the general-purpose functionality of GPUs. This deliberate narrowing of scope enables radical efficiency gains at the expense of flexibility, making ZettaLith a purpose-built engine for inference of the dominant class of large language and multimodal transformer models.

### Compute, Memory, Network, and Software

Existing AI systems can be divided into four main categories:

Compute: Dominated by matrix multiplications, the compute requirements are far larger, and far more parallelizable, than traditional (non AI) computer systems. ZettaLith takes an extreme approach to compute, by using billions of tiny simple processing engines (PEs) running at high clock rates. ZettaLith sacrifices flexibility for extreme performance.

Memory: The memory required for AI is typically measured in TB instead of GB, and memory bandwidth in TB/s rather than GB/s for traditional systems. Memory tends to be the most expensive part of AI GPUs. Memory is also the most expensive part of ZettaLith. Currently the amount of high bandwidth memory (HBM) that can fit in a ZettaLith is insufficient for AI LLM training, so the ZettaLith architecture is efficient for inference only. ZettaLith uses HILT to provide the billions of PEs with extreme memory bandwidth at low power.

Network: High speed networks between compute cores across multiple racks in a datacenter, all while maintaining cache coherency, are exceedingly complex, expensive, and power hungry. ZettaLith eliminates almost all of this by using an all-silicon domain with 39 TB/s data links between adjacent TRIMERA compute stacks. This is well matched to the requirements of AI inference.

Software: The software stack, and specifically Nvidia's CUDA, is a major differentiator in AI systems. However, ZettaLith is not a general purpose GPU, is not used for high performance computing (HPC) or AI training, or graphics, and does not have complex networking issues or scheduling issues. The amount of software needed is a tiny fraction of a full CUDA stack.

### Wafer-Scale Integration for Large-Model Inference

In one embodiment, the system is configured to perform inference for large-scale transformer models entirely within a single integrated silicon structure. This structure comprises a passive Wafer-Scale Silicon Circuit Board (WSSCB) populated with a plurality of compute modules and memory stacks (e.g., HBM or HBF), forming a unified compute domain.

Conventional large-scale inference systems typically distribute model parameters across a hierarchy of physical interconnects, ranging from on-chip buses and interposer connections to printed circuit boards, backplanes, copper cabling, and optical fibers. Traversal of these hierarchical levels introduces significant latency and power consumption overheads. By contrast, the architecture described herein maintains data traffic primarily within the silicon substrate and redistribution layers of the WSSCB during the execution of the model.

Consequently, the reliance on external high-speed switches, inter-rack cabling, and complex distributed scheduling for intra-model communication is substantially reduced. The entire inference operation is configured to proceed within the high-bandwidth, low-latency domain of the WSSCB.

### ZettaLith Integration

ZettaLith achieves its scale, and much of its efficiency, from calculating the entire transformer inference in a single silicon domain, operating at native silicon speeds, power, and component density. This is achieved by 344 advanced chip stacks (172 logic and 172 HBM) attached ZettaLith's wafer-scale silicon circuit board (WSSCB)—a passive silicon substrate analogous to a printed circuit board but fabricated using semiconductor processes. Containing no transistors—only interconnects—the WSSCB supports attachment of chiplets and chip stacks with standard microbumps, replacing conventional PCB, package substrate and silicon interposer functions in a single integrated structure. The passive WSSCB essentially functions as an extremely high performance PCB equivalent.

### Architectural Innovations

The performance and power advantages described herein arise from the combined and interdependent operation of multiple architectural elements; no single mechanism described in isolation is sufficient to achieve the stated system-level gains.

The performance advantage arises from the combined effect of many inventions:
All-silicon domain: all AI inference occurs in a single unified silicon domain, eliminating the slow and power-hungry transmission of data across PCBs, backplanes, racks, pods, and the entire datacenter.
Tiny PEs: ZettaLith gets it performance advantage from billions of tiny, fast, low power processing elements, specialized for FP4 AI inference.
Improved HBM efficiency: the architecture allows a single instance of model weights to be shared across the entire domain, reducing the aggregate memory bandwidth requirement relative to distributed compute nodes.
CASCADE Arrays: column-systolic giant matrix multiplications without inter-chip partial sum transfers, with extensive built-in fault tolerance.
TRIMERA Stacks: vertically integrated stacks of chiplets optimizing compute, memory, and I/O, using three layer hybrid bonding of differing process nodes.
SHAPE: methodology enabling early adoption of cutting-edge CMOS nodes before standard cell libraries and other IP are available, and before production-level yields are achieved.
HILT Memory: latch-based hierarchical memory providing extreme bandwidth at lower area and power than SRAM.
CREST Fault Tolerance: continuous fine-grained monitoring and substitution of faulty array columns with no service interruption. This improves yield and reliability.
WSSCB: passive silicon substrate mounting and connecting many wafers' worth of active silicon chip stacks.
Silicon Springs: compliant through-wafer silicon structures isolate thermal and mechanical stress across the wafer substrate and prevent fracture and warping of the WSSCB, thus making the WSSCB robust.
ZettaLink Fabric: extremely broad UCIe 2.0 links delivering multi-petabyte-per-second aggregate data bandwidth between chip stacks in a single ZettaLith.
Inverted Hierarchy: the normal electronic hierarchy mounts multiple pieces of silicon on a single PCB. ZettaLith mounts multiple PCBs on a single piece of silicon, effectively inverting the conventional board-centric electronic hierarchy, and enabling the all-silicon domain.
JETSTREAM Cooling: 2-phase immersion jet cooling of each individual chip-stack using 3D-printed titanium manifolds, enabling sustained operation at extremely high-power densities.
Post GPU: by exclusively focusing on FP4 (W4A8) AI inference, ZettaLith addresses the enormous forthcoming AI inference requirements without the complexity of supporting varied GPU workloads such as AI training or HPC.

Each element is individually incremental but combined they yield large multiplicative gains that remain within short-term CMOS scaling trajectories.

### Scalability

The same principles scale both upward and downward. At rack scale, ZettaLith sustains trillion-parameter inference with efficiency unmatched by contemporary systems. Scaling down to workstation scale (ExaLith), a single PCIe accelerator delivers exaFLOPS performance within 600 W. At edge scale (PetaLith), compact SoC IP blocks deliver petaFLOPS-class inference in a smartphone thermal and cost envelope. Scaling up to datacenter scale, vastly greater performance can be provided at the same cost, or the same performance can be provided at vastly lower cost—or anywhere in between.

### Software

### Compiler/Runtime Stack

ZettaLith is designed to integrate seamlessly with the AI ecosystem while delivering its performance advantages. Unlike the hardware architecture—which represents a fundamental reimagining of transformer acceleration—the software integration approach follows established patterns in heterogeneous computing and presents no fundamental barriers to implementation.

### Software Stack Considerations

ZettaLith's software stack would typically comprise three primary layers:
Device-level firmware and drivers: Managing low-level operations including TRIMERA stack initialization, CREST fault detection and recovery, power management, and thermal monitoring;
Hardware abstraction layer: Exposing ZettaLith's computational capabilities through standard interfaces while abstracting hardware-specific details; and
AI framework integration: Enabling popular frameworks to target ZettaLith for transformer inference workloads.

The device-level layer necessitates custom development specific to ZettaLith hardware but follows conventional patterns for accelerator programming. The standardized UCIe 2.0 interfaces facilitate integration with existing driver models, while the CPU stacks provide familiar execution environments for control software. ZettaLith software is fundamentally similar to current GPU systems, though dramatically simpler.

### Framework Compatibility

ZettaLith is architected to complement rather than replace existing AI ecosystems. As a specialized transformer inference engine, it would typically function as an acceleration target within established frameworks. The specific integration approach would naturally align with the implementing company's existing software infrastructure:
Nvidia: Integration through CUDA and TensorRT for optimized graph execution.
AMD: Implementation via ROCm ecosystem and composable kernel libraries.
Intel: Deployment through OneAPI and OpenVINO inference pathways.
Google: Integration with JAX/TensorFlow and potentially TPU compatibility layers.
Modular: Modular AI has developed a full-stack CUDA alternative called Modular Accelerated eXecution (Max), which supports x86, Arm CPUs, and Nvidia GPUs, aiming to provide a drop-in replacement for CUDA with comparable or better performance. Modular intends to extend support to other hardware platforms.
Independent implementations: The Unified Acceleration Foundation's UXL (Unified Acceleration Interface Layer) provides a vendor-neutral hardware abstraction layer.

### Implementation Approach

The software integration approach for ZettaLith benefits from several simplifying factors:
the highly specialized nature of the hardware dramatically narrows the scope of required software support. Graphics GPU applications, HPC applications, and transformer training do not need to be considered;
the entire transformer inference is done on one machine, without needing control of multiple servers, TOR switches, racks, and pods;
widely varying data latencies—from on-chip to a server rack tens of meters away—do not need to be considered;
the presence of general-purpose CPU stacks allows conventional software architectures to manage the specialized computational elements;
the deterministic, feed-forward nature of transformer inference avoids complex control flow and synchronization challenges; and
established quantization techniques for FP4 inference are directly applicable without requiring novel software innovations.

While a complete software stack is essential to ZettaLith's operation, its development represents a well-known engineering effort following established patterns in heterogeneous computing. The critical innovation in ZettaLith resides in its hardware architecture rather than requiring novel software paradigms, allowing implementing companies to leverage their existing software expertise and ecosystems.

ZettaLith does not Require AI Training Software

The preferred embodiment of ZettaLith is optimized for LLM inference. The initial ZettaLith software can concentrate on AI inference instead of the far more complex task of AI training.

### Secure and On-Premises Inference

Federated, regulated, or classified deployments require cryptographic isolation, deterministic performance, and limited data exfiltration. For the simplest implementation, these functions are performed by the high-performance conventional server that resides in the ZettaLith rack and is used to control ZettaLith. This server would provide hardware accelerated AES-256 and SHA-198/512. Quantum resistant public key encryption and key exchange (e.g. CRYSTALS-Kyber (ML-KEM) standardized as NIST (FIPS 203)) should be built-in from the start.

In preferred embodiments, security is managed directly by the BID hardware as described in the Biase Interface Die section, rather than relying solely on the control server. This ensures cryptographic isolation even if physical access to the rack is compromised.

To ensure a high level of security, each CPU stack and arbitrarily defined group of TRIMERA stacks operate in a self-contained enclave with encryption and decryption performed on the CPU stacks. This requires a hacker to gain access to the WSSCB in an immersed JETSTREAM tank. This would be extremely difficult. In addition to the ZettaLith WSSCB being submerged and not field accessible, the connections that would need to be accessed are extremely broad and fast UCIe 2.0 ZettaLinks. Any connections made to these links more than a few mm long will not transmit the data, and will disrupt the ZettaLink data, and thus be detected. Overall, an attack of this nature would be more difficult than trying to hack connections within a multi-die GPU chip.

This allows secure inference for applications such as financial modeling, medical diagnostics, and national-security domains while maintaining FP4 inference parity. The throughput penalty for encryption is implementation dependent, but minor if hardware encryption/decryption is included in the CPU dies.

### TRIMERA Module Characteristics

Table 1 shows a characteristics of a single TRIMERA module, comprising a TRIMERA compute stack and a HBM or HBF memory stack. The TRIMERA stack is a stack of three die, hybrid bonded together: a ZSLD compute die, a HILT memory die, and a BID interface die. Each TRIMERA is paired with a HBM4 memory stack and connected in an extremely high speed ZettaLink data mesh to 156 TRIMERA stacks and 16 CPU stacks arrayed across a wafer-scale silicon circuit board (WSSCB).

TABLE 1
ZettaLith TRIMERA module characteristics

| Aspect | TRIMERA | Units |
|---|---|---|
| Memory type | HBM4 | Version |
| Inference (FP4 W4A8 Sparse) | 9,311 | PFLOPS |
| Inference (FP4 W4A8 Dense) | 4,656 | PFLOPS |
| SOTA die area (ZSLD) | 143 | mm² |
| HILT die area | 143 | mm² |
| BID die area | 143 | mm² |
| HBMs per accelerator (not CPU) | 1 | HBM |
| Memory per HBM stack | 64 | GB |
| Bandwidth per HBM stack | 1.64 | TB/s |
| Accelerator (not CPU) memory capacity | 64 | GB |
| Accelerator (not CPU) memory bandwidth | 1.64 | TB/s |
| Weights density | 4 | Bits/weight |
| Total weights | 128 | G weights |
| Weights bandwidth from HBM | 3 | T weights/s |
| Direct silicon link | Hybrid bonds | type |
| Bandwidth of silicon links | 407 | TB/s |
| Interchip data fabric | UCIe 2.0 | type |
| Bandwidth of interchip data fabric | 89 | TB/s |
| Active PEs | 155,189,248 | PEs |
| PE operating frequency | 15 | GHz |
| Active PE cycles per second | 2,328 | PHz |
| Power | 1,090 | W |
| Power density | 762 | W/cm² |

### Rack Level Characteristics

At the system level, the key performance metrics in Table 2 demonstrate ZettaLith's capabilities. Table 2 shows a balanced system which provides the memory capacity, memory bandwidth, CPU capacity, CPU memory, chip-to-chip fabric bandwidth and the fabric topology required for the system to keep up with the TRIMERA arrays, albeit with a high weight re-use factor.

TABLE 2
ZettaLith rack level characteristics

| Aspect | ZettaLith | Units |
|---|---|---|
| Number of accelerators | 156 | Chip stacks |
| Number of CPUs | 16 | Chip stacks |
| Inference (FP4 W4A8 Sparse) | 1,452,571 | PFLOPS |
| Inference (FP4 W4A8 Dense) | 726,286 | PFLOPS |
| Active PE cycles per second | 363,143 | PHz |
| Accelerator (not CPU) HBM stacks | 156 | HBMs |
| Accelerator (not CPU) HBM memory | 9,984 | GBytes |
| Total DRAM chips or stacks | 172 | DRAMs |
| Accelerator (not CPU) memory bandwidth | 256 | TB/s |
| Max in-rack transformer inference | 20 | T parameters |
| Weights bandwidth from HBM | 512 | T weights/s |
| Interchip data fabric | UCIe 2.0 | Standard |
| Bandwidth of interchip data fabric | 8,491 | TB/s |
| PCIe for SSDs etc. | PCIe 6.0 | version |
| PCIe links | 16 | links |
| PCIe bandwidth | 2,048 | GB/s |
| Total active PEs | 24,210 | million |
| PE power | 170 | kW |
| Max simultaneous compute power | 198 | kW |
| 48 V DC to ~1 V DC PSU conversion losses | 39 | kW |
| 48 V DC Power into to ZettaLith container | 237 | kW |
| 3-Phase AC to 48 V DC conversion losses | 11 | kW |
| Total 3-Phase AC power consumption | 248 | kW |
| Cooling | 2-PIC | type |

There is only a 28 kW difference between the 170 kW PE power and the 198 kW maximum simultaneous compute power. This is because the HBM stacks, ZettaLinks and some other high power aspects of the ZettaLith are largely idle when the PEs are active.

198 kW is the worst case compute power draw—when the PEs are fully active, the CPU stacks partially active, and the ZettaLinks and HBM are largely idle. ZettaLith is not designed for highly overlapping HBM transfers and compute, as the performance advantage of overlapping is relatively minor compared to the extra difficulty of providing substantially higher power supply and cooling.

### Maximum Memory ZettaLith

The main reason for using HBM4 stacks is the memory bandwidth, but this bandwidth is the same for each HBM4 stack height (4, 8, 12, or 16 dies). This enables memory capacity scaling while maintaining bandwidth, allowing optimization for specific LLM sizes.

Many ZettaLith systems are unlikely to require the maximum memory capacity. The standard memory ZettaLith uses 4 high HBM4 stacks for the TRIMERA compute stacks, while the maximum uses 16 high HBM4 stacks. Other configurations can use 8 high stacks and 12 high stacks. The stack height used by different WSSCB modules need not be the same. For example, a useful configuration is to use minimum HBM4 memories for the TRIMERA modules, and maximum HBM4 memories for the CPU modules.

A ZettaLith with more than the minimum memory is required for inferencing very large LLMs with more than 5 trillion parameters. It is also useful where a variety of large LLMs transformer must be instantly switched between without having time to load in the parameters from SSD into HBM memory. This may be required for future ASI systems containing a variety of large AI transformers that run simultaneously and frequently interact.

Maximum memory ZettaLiths can inference a maximum of 20 trillion FP4 parameters using HBM4 while maintaining a single all-silicon domain.

AIs with more than 20 trillion FP4 parameters can be inferenced by linking multiple ZettaLiths using the 800 GbE links. However, this invokes the complexity and inefficiency inherent in linking multiple GPU racks, and no-longer has the huge benefit of an all-silicon domain.

### Extending Parameter Memory Using HBF

An effective approach to extending the number of parameters is to use a mixture of HBM and HBF. With an equal mix of HBM and HBF—using the HBF for weight storage and the HBM for KV caches and other transient data, a ZettaLith could have 39 TB of HBF, enough to store 78 trillion weights.

### Intermediate Memory ZettaLiths

However, a future ASI with dozens of AIs in the 100 B parameters range, and just a few AIs in the trillion parameters range, would not necessarily require the maximum memory ZettaLith. Intermediate ZettaLiths with 10 trillion and 15 trillion parameter capacities are also possible.

### ZettaLith Architecture & Dataflow

ZettaLith utilizes a distributed array of 24,209,522,688 processing elements (PEs) organized to keep the entire transformer inference resident in a single all-silicon domain without traversing PCBs, backplanes, cables, racks, or optic fibers.

At ZettaLith's core are the CASCADE (Column-Array Systolic Computation with Accumulation During Execution) architecture, TRIMERA (TRIchip Module for Exascale Reasoning Applications) chip stack and WSSCB (Wafer-Scale Silicon Circuit Board), implementing 156 TRIMERA stacks×18,944 rows×8,192 columns matrix multiplications simultaneously. This design fundamentally restructures large-scale matrix multiplications by eliminating inter-chip partial sum transfers.

### Optimized PEs

ZettaLith achieves its high performance through highly optimized PEs calculating FP4 weights×FP8 activations (W4A8) with FP8 accumulation. Each PE has only 697 transistors designed for TSMC's A14 process node (14 Ångstrom=1.4 nm). Each CASCADE array of 262,656 PEs operates within its own synchronous 15 GHz clock domain spanning just 0.242 mm², isolated from the surrounding 1.875 GHz system environment.

In conventional distributed transformer inference systems, partial sum transfers dominate interconnect bandwidth consumption, accounting for approximately 50% of all data movement across chip-to-chip data links. This occurs because partial sum transfers scale quadratically with model hidden dimension size, while activation transfers and full sums scale only linearly. In ZettaLith, partial sums are normally completed on the TRIMERA chip stacks and consume no inter-chip data fabric bandwidth.

Accumulation of partial sums within a column is FP8. Biases are also FP8 and are added in the output sums HILT recirculation system at the bottom of each column. Non-matrix operations (SoftMax, swiGLU, etc.) and layer sequencing are microcode state machines, creating a flexible hybrid architecture that maximizes acceleration of the most computation-intensive components while maintaining adaptability.

### WSSCB Interconnect

ZettaLith's passive wafer-scale silicon circuit board (WSSCB) inverts traditional packaging hierarchy, maintaining all inferencing data and computation within a single all-silicon domain at native silicon speeds. The WSSCB serves as an all-silicon substrate that integrates multiple chiplets into a unified computational domain while eliminating conventional PCBs, interposers, and packages. The WSSCB is completely passive and integrates no active logic.

Integrated silicon spring microstructures reduce thermal and mechanical stress propagation in the WSSCB by orders of magnitude, limiting thermal and stress propagation regions to chip-scale islands less than 2 cm².

### Number of Parameters

A single maximum memory ZettaLith independently computes inference of AIs (e.g. LLM transformers) up to 20 trillion parameters. The standard minimum memory ZettaLith version handles 5 trillion parameters.

### System Reliability

System reliability is enhanced through multiple fault-tolerance mechanisms, including CREST (Cyclic Redundant Spare Testing), which continuously monitors and dynamically replaces faulty CASCADE array columns without service interruption.

### ZettaLink Chip-Stack-to-Chip-Stack Data Fabric

ZettaLith's 156 TRIMERA chip stacks and 16 CPU chip stacks communicate via in-silicon 39 TB/s vertical and 11 TB/s horizontal chip-stack-to-chip-stack links using standard UCIe 2.0 (Universal Chiplet Interconnect Express) pathways. This provides the 8,491 TB/s inter-chip-stack bandwidth used by 156 TRIMERA stacks, each with 155,189,248 active PEs, to function cohesively as an AI inferencing system of 24,209,522,688 PEs in a single all-silicon domain.

### External Connectivity

External connectivity includes 16×PCIe 6.0 channels providing 2 TB/s bandwidth, primarily for SSD access.

Optional external connectivity provides 32 channels of 800 gigabit Ethernet (GbE) to external systems, with a total bandwidth of 25.6 Tb/s (3.2 TB/s). However, 800 GbE connectivity is not necessary for AI inference less than 20 trillion parameters, and is inefficient for expansion, so is omitted in first generation ZettaLith embodiments.

### Extreme Current Regulation

Power is distributed through 86 precision power supply PCBs connected to the WSSCB, featuring 2,580 TLVR (Trans-Inductor Voltage Regulator) modules positioned within 24 mm of their respective silicon loads, with current primarily conducted through solid copper busbars to minimize power loss.

### Extreme Thermal Management

Thermal management is achieved through JET Surface Thermal Regulation via Evaporative Array Manifold (JETSTREAM). The system employs an additively manufactured titanium manifold that directs 172 precision-tuned two-phase immersion coolant jets at silicon heatsink fins deeply etched as microchannels in the back surface of the TRIMERA and CPU chip stacks. It uses an advanced 2-PIC coolant, Chemours Opteon 2P50.

### FP4 Weights×FP8 Activations (W4A8)

A survey of quantization methods for efficient neural network inference can be found in (Gholami et al., 2021).

The FP4 PE forms the core computational unit of the CASCADE array, replicated 155 million times in the TRIMERA ZSLD, and 24,210 million times in a WSSCB ZettaLith. Having 24.2 billion active processing elements simultaneously calculating the transformer at 15 GHz is the reason why ZettaLith performance is so high.

The processing element is extremely simple compared to GPU cores or DSP cores, with only 697 transistors per PE. There are no instructions, no branching operations, no cache, and intra-PE wires and inter-PE wires are sub-micron in length.

The TRIMERA ZSLD contains these FP4 PEs and little else. Even the memory required to feed activations to the CASCADE arrays and collect sums is not in the ZSLD—it is in the HILT die which is face-to-face hybrid bonded to the ZSLD.

The ZSLD is deliberately designed to be as simple as possible, using the SHAPE (Simple Hybrid Array of Processing Elements) system. This dramatically reduces design and mask-making time, and facilitates early transition to the latest SOTA process. Most of the system complexity is in the BID and HILT, not the ZSLD.

### ZettaLith FP4 W4A8 Inference

Table 3 shows a summary of ZettaLith performance and power consumption.

TABLE 3
ZettaLith FP4 W4A8 inference performance

| Aspect | Value | Unit |
|---|---|---|
| Total ZettaLith Modules | 172 | modules |
| TRIMERA modules | 156 | TRIMERAs |
| CPU modules | 16 | CPU stacks |
| TRIMERA die area for each of | 143 | mm² |
| ZSLD-SRAM-BID | | |
| Power-limited operational clock frequency | 15.0 | GHz |
| 2-PIC limited max simultaneous compute | 200 | kW |
| power | | |
| Max power used simultaneously by compute | 198 | kW |
| Max power available for CASCADE Arrays | 171 | kW |
| PE area | 0.92 | μm² |
| PE power at chosen clock frequency | 7.0 | μW |
| Max PEs in ZSLD die area (before array | 156 | million PEs |
| fitting) | | |
| Max active PEs within power or area limit | 156 | million PEs |
| Active CASCADE array columns | 8,192 | columns |
| CASCADE rows (PEs in a CASCADE | 32 | rows |
| column) | | |
| Active PEs in a CASCADE array | 262,144 | PEs |
| Active CASCADE arrays in TRIMERA | 592 | arrays |
| Active CASCADE matrix rows in | 18,944 | rows |
| TRIMERA | | |
| Active CASCADE PEs in TRIMERA (after | 155 | million PEs |
| array fitting) | | |
| Percentage utilization of ZSLD die | 99.8% | full |
| Performance of 1 PE (1 MAC = 2 Ops) | 30 | GFLOPS |
| ZSLD performance (sparse) | 9,311 | PFLOPS |
| ZSLD performance (dense) | 4,656 | PFLOPS |
| ZSLD CASCADE array power | 1,090 | W |
| ZSLD power density | 762 | W/cm² |
| ZettaLink stack-stack data fabric bandwidth | 8,491 | TB/s |
| WSSCB ZettaLith active PEs | 24,210 | million PEs |
| WSSCB ZettaLith performance (sparse) | 1,452 | exaFLOPS |
| WSSCB ZettaLith performance (dense) | 726 | exaFLOPS |
| WSSCB ZettaLith PE power | 170 | kW |
| WSSCB ZettaLith power | 198 | kW |
| WSSCB ZettaLith current at 1.1 V (I/O, | 26 | kA |
| CPU, SRAM) | | |
| WSSCB ZettaLith current at 0.65 V (PEs) | 262 | kA |
| WSSCB total ZettaLith current | 287 | kA |
| ZettaLith 48 VDC max power | 242 | kW |
| ZettaLith 3-Phase to 48 VDC PSU efficiency | 98% | |
| ZettaLith max 3-Phase AC power | 248 | kW |

### ZettaLith FP4/FP8

In ZettaLith, weights are stored as FP4 values, activations as FP8, and the accumulation step is performed in FP8. This means that while the weights benefit from the extreme density and bandwidth savings of four-bit storage, the partial sums enjoy the wider exponent and mantissa of FP8. Overflow and rounding error in deep dot-products are therefore greatly reduced, without sacrificing the efficiency benefits of FP4 weights.

### Short Context Queries

The impact of these choices becomes most visible when applied to trillion-parameter language models. For short query prompts—for example, a few hundred tokens of context and a few hundred tokens of generated answer—compute utilization is the critical factor. In ZettaLith, the specialized FP4/FP8 processing elements and simplified inference-only datapaths deliver a throughput advantage of two orders of magnitude or more. Tokens per second rise into the hundreds of millions per rack, and energy per token falls by a factor of twenty to one hundred, all while accuracy remains within about one percent of FP8. For short prompt inference, the ZettaLith advantage is therefore dominated by sheer arithmetic throughput and efficiency.

### Long Context and Reasoning

The comparison shifts somewhat when the context window expands. For long-context reasoning, such as a 128k-token prompt followed by an extended answer, the bottlenecks are not only arithmetic but also the movement of key/value cache data and the stability of very deep accumulations. Here NVFP4 shows the strength of its block scaling scheme, preserving fidelity even in the presence of wide magnitude distributions. However, utilization of the GPU pipeline drops significantly, often to less than half of peak, as attention bandwidth becomes the limiting factor.

ZettaLith's structure proves valuable under these conditions. Because each dot-product sum is carried in a wider format, accumulation error does not grow as quickly with context length, and inference accuracy is maintained. Utilization also remains higher due to the inference-only fabric and locality of the memory system. As a result, ZettaLith sustains tens to hundreds of millions of tokens per second in long-context runs.

Because ZettaLith is an all-silicon domain, none of the calculation requirements leave the ZettaLith compute domain. The external PCIe 6.0 lanes are not required for calculation. In normal use, the external PCIe 6.0 (or 800 GbE if present) lanes only transfer the initial query, and the final answer. All intermediate calculations and storage, including:
Matmul,
Attention activation,
KV caches,
Reuse,
Batches,
Working memories,
Retrieval of data from on-ZettaLith MCP services (e.g. Wikipedia, corporate databases), and
Data transfer between agents, does not leave the ZettaLith all-silicon domain, so does not use PCIe 6.0 bandwidth.

### Accuracy Retention

ZettaLith trades off flexibility for increased performance. It is optimized for neural net inference in FP4 format and can't run any other numerical format. Transformers and other AI models must therefore either be converted to FP4 or effectively trained in FP4 using quantization-aware training (QAT), where a model is trained end-to-end under simulated low-precision conditions (Jacob et al., 2017). Various systems have been derived to quantize transformer models after training, including GPTQ (Frantar et al., 2022), ZeroQuant (Ren et al., 2022), and SmoothQuant (Xiao et al., 2022). Transformers are proving to be remarkably resilient to extreme quantization, with good performance being achieved even with ternary weights, where weights can have one of only three values (−1, 0, +1) known as 1.58 bit precision. With FP4 precision, weights can have any of 16 different values.

### ZettaLith Contains the Following Custom Chips

Table 4 shows the custom chiplets and passive wafer scale substrate (WSSCB) required to implement ZettaLith, along with recommended processes from major foundries for a first embodiment product introduction. These are the process nodes for which the performance, speed and power in the tables in this specification are calculated. Later ZettaLiths can use more advanced processes to achieve greater performance or reduced power, and more conservative ZettaLith implementations can use less advanced processes at the expense of performance and/or greater power consumption.

TABLE 4

| ZettaLith custom silicon | Suggested process | | |
|---|---|---|---|
| Chip | TSMC | Intel | Samsung |
| WSSCB (process modified | CoWoS-W | Foveros | I-CubeS |
| from:) | | | |
| BID (TRIMERA and CPU) | N12FFC | Intel 16-ET | SF11LLP |
| HILT (TRIMERA stack) | N3E ULP | Intel 18A-PT | SF3 LP/LL |
| ZSLD (TRIMERA stack) | A14 LP | Intel 14A-E | SF1.4 |
| L3/L4 Cache (CPU stack) | N12FFC | Intel 16-ET | SF11LLP |
| CPU (CPU stack) | N3P | Intel 18A | SF3 |

### Advanced CMOS Nodes

The main matrix multiply die, the TRIMERA ZSLD, is configured to be manufactured on the most advanced CMOS node available, to maximize performance within area and power constraints. For a first embodiment, that is TSMC's A14 node, or Intel or Samsung equivalent. If fully utilizing the SHAPE and CREST advantage, TSMC A10 node (or equivalent) can be used. If TSMC's A14 node is not available, the design can be adapted to an older node (e.g., TSMC A16, N2, N3, N4, N7) or Samsung or Intel's foundry service with an appropriate performance adjustment.

In either scenario, the TRIMERA stacks are intensively tested after bonding, using standard test protocols. This ensures that defective chips stacks are intercepted prior to final integration of KGD on the WSSCB.

As a result, the only silicon device with an area larger than chiplet size is the passive WSSCB substrate, which has a large minimum CD of around 0.5 m and is highly fault tolerant.

The total design complexity is approximately equal to that of a single large leading-edge SoC, as each die (except WSSCB) is a 143 mm² chiplet, and ZSLD, HILT and Cache die are very simple.

### The Wafer-Scale Silicon Circuit Board—WSSCB

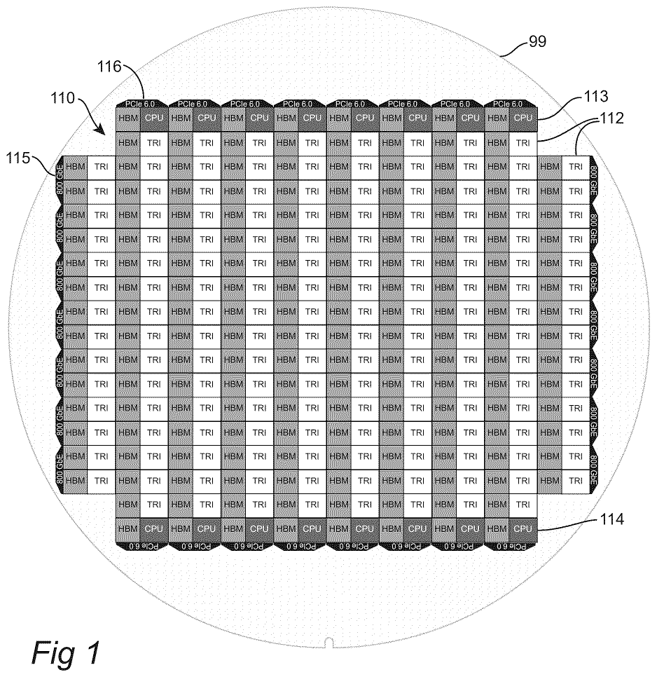

FIG. 1 illustrates ZettaLith implementation on a 300 mm silicon WSSCB 99, accommodating an array of SCB modules 110. The central portion comprises 156 systolic array compute modules 112, with 8×1 arrays of CPU modules above 113 and below 114. TSV connections 115 and 116 lead to 800 GbE and PCIe 6.0 PCBs, facilitating high-speed external communication.

### WSSB is a Passive Routing Substrate

The Wafer Scale Silicon Circuit Board (WSSCB) is a completely passive interconnection substrate. It contains no transistors, logic gates, memory cells, or any other active semiconductor devices. The functionality of the WSSCB is physical support, power routing, through-silicon vias (TSVs), decoupling capacitors, stress relief, and redundant interconnect structures formed in multiple redistribution layers (RDL). The WSSCB therefore functions as an ultra-high-density, wafer-scale backplane that electrically and thermally interconnects the active silicon stacks mounted upon it, but does not itself perform computation or power regulation.

The WSSCB is fabricated using mature 65 nm-class lithography process chosen for yield, mechanical stability, and proven TSV reliability. At this lithographic node, transistor performance would be too low to support the multi-terabit per second interconnect bandwidths of the system, and integrating active devices would severely impact yield due to the wafer-scale area. Consequently, the WSSCB design excludes any transistor-level devices and relies entirely on passive interconnect structures.

All active transceivers and equalization logic for the UCIe 2.0 and HBM/HBF interfaces reside within the Base Interface Die (BID), which is fabricated at the 7 nm process node. This architectural separation confines active signaling and power-control transistors to small, easily tested chiplets of approximately 143 mm², a size that provides extremely high yield at advanced nodes. The BID dies incorporate redundancy within each communication channel, further improving manufacturing tolerance and system-level reliability. This modular approach eliminates the need for large monolithic active wafers, while still achieving wafer-scale connectivity through the passive WSSCB.

### Design Simplicity and Availability of Design Tools

The majority of the routing patterns within the WSSCB—such as those forming the UCIe 2.0 ZettaLink channels—consist solely of many parallel identical metal traces and vias, with redundant routing paths and continuous ground-planes between layers for controlled 50 Ohm impedance, low crosstalk and high frequency isolation.

Despite containing millions of ultra-short (~1.4 mm) interconnects in its RDL stack, the WSSCB layout is remarkably regular and repetitive. Its geometric simplicity allows it to be fully hand-designed using polygon-level EDA tools, without reliance on logic synthesis or placement algorithms. This high degree of regularity, combined with process maturity and the absence of active devices, ensures that the WSSCB achieves exceptionally high wafer-scale yield. It also means that existing polygon-level design tools are adequate, and no new EDA software is required.

### Power Distribution

Power distribution for the system is similarly modular. The WSSCB defines 86 independent power domains, each supplied by a dedicated Power Supply Unit (PSU) printed circuit board mounted vertically beneath the wafer. Each PSU contains high-efficiency multi-phase regulators and control electronics implemented in conventional PCB-mounted components. The WSSCB itself performs only low-impedance power routing between the PSUs and the mounted semiconductor stacks, without any on-wafer voltage regulation or switching functions.

### WSSCB Summary

In summary, the WSSCB serves as a purely passive, wafer-scale electrical and mechanical interconnect medium that forms the foundation of the ZettaLith architecture. All active operations—including signal transmission, equalization, redundancy management, and power control—occur in the attached chiplets, not within the WSSCB. This distinction is critical to understanding the ZettaLith system hierarchy: the WSSCB is passive silicon, while intelligence, computation, and control remain entirely within the active dies mounted upon it. This heterogeneous architecture enables a complete large-scale computing system on a single WSSCB, with data fabric connections providing cohesive operation.

WSSCB solves the yield, thermal stress, physical stress, breakage and testing problems with large silicon interposers, and solves the high current power supply problem by integrating many PSU PCBs using column grid array attachment.

### WSSCB Details

The WSSCB provides μm-scale routing pitches, mechanical and thermal stress-relief structures, and integrated redundancy for each wire. Consequently, high defect densities can be tolerated with no loss of function. The result is a high-yield, passive and robust large silicon substrate providing the interconnections, power distribution, and mechanical support for a large array of active chiplet stacks.

The WSSCB uses near-full-thickness silicon. This is enabled because the WSSCB TSVs are not used for high speed signals within the array—only for power supply and relatively low speed signals. This, in turn, is because the WSSCB takes the role of a silicon-performance “PCB”, not a silicon interposer.

Multiple PCBs are connected to the one silicon substrate, as opposed to multiple chips being attached to one PCB. This makes the silicon thickness irrelevant to high speed signal propagation, keeping all high speed signals contained to the front surface RDL of the WSSCB, the TRIMERA stacks, and the HBM stacks.

### WSSCB Compatibility Across Stack Types

The architectural passivity of the WSSCB provides a key system-level advantage: universal compatibility with multiple classes of active silicon stacks. Because the WSSCB performs only passive electrical routing and power distribution, its electrical interfaces are standardized to the Base Interface Die (BID) format. Each BID die implements the complete set of physical-layer transceivers and dead-stack bypass logic for UCIe 2.0 and HBM/HBF communication channels. As a result, the same BID design can be bonded beneath a TRIMERA stack, a CPU stack, or any future processing or memory stack without modification to the WSSCB layout.

This approach eliminates the need for stack-specific interposer variants and allows the wafer-scale system to host heterogeneous compute elements that share a consistent interconnect and power topology. The WSSCB connects only to BID and HBM/HBF base dies, never directly to high-speed logic. All active link training, redundancy switching, and protocol negotiation are confined within the BID, preserving the WSSCB's status as a passive substrate. This separation of concerns allows future chiplet generations—built on smaller nodes or employing different logic styles—to be adopted simply by redesigning the logic and memory dies hybrid bonded to BID dies in compute stacks, while leaving the WSSCB and BIDs unchanged.

By maintaining this rigid boundary between passive wafer-scale routing and active die functionality, ZettaLith achieves a scalable manufacturing model in which the WSSCB acts as a long-lived infrastructure platform and the BID-based stacks serve as replaceable functional modules. This design philosophy enables rapid technology migration, straightforward multi-generation compatibility, and sustained high yield across both mature and advanced process nodes.

### WSSCB Testing

A WSSCB is a passive silicon device with literally tens of millions of short wire segments connecting pairs of microbumps. It is untestable by conventional semiconductor ATE.

The WSSCB test probe chip is a simple MEMS probe with tens of thousands of integrated MEMS elastic spring probes that can test an entire WSSCB with 100% coverage in a few minutes. As there are no active components on the WSSCB, the test system is very simple—only testing for wire opens and shorts. No test vectors or complex ATE equipment are required.

### Silicon Circuit Boards

Silicon circuit boards (SCBs) enable high system integration through direct silicon-based interconnection. While sharing some characteristics with silicon interposers, SCBs represent a fundamental shift in electronic system architecture, replacing traditional PCBs as the primary integration platform.

Conventional electronic systems employ a hierarchical structure where silicon chips mount to silicon interposers, which mount to package substrates, which in turn mount to PCBs. Silicon interposers provide high-density interconnects between chips but remain limited in size due to manufacturing constraints. The SCB architecture inverts this hierarchy—instead of mounting silicon components to PCBs, the PCBs (primarily for power delivery) mount to a large silicon substrate.

### Mechanical Stress

Mechanical stress and warpage present challenges in larger silicon structures. The CTE and temperature mismatch between silicon, attached dies, and substrate materials creates stress that scales with distance from the neutral point. This stress can impact both manufacturing yield and long-term reliability of connections.

### Thermal Expansion

Thermal expansion effects become particularly significant as silicon substrate size increases. The absolute movement from center to edge grows linearly with distance, potentially exceeding the strain limits of conventional interconnect structures. This movement can stress bump interfaces and affect signal integrity across temperature variations. In existing systems, repeated temperature swings can cause elasto-plastic strain in solder joints. The ZettaLith WSSCB is designed to eliminate this problem Yield

Manufacturing yield has been another key constraint. The probability of defects increases dramatically with substrate area, affecting both RDL processing and TSV formation. This exponential relationship between size and yield has made larger silicon substrates economically impractical using conventional approaches.

### SCB Solutions

The SCB architecture and manufacturing methods address these fundamental challenges through several innovations, with stress relief structures playing a particularly crucial role. These stress relief structures comprise MEMS silicon springs fabricated directly in the SCB substrate. The springs include Fermat-Archimedean spiral springs for regions requiring maximum compliance with minimal signal routing, V-beam springs for areas requiring high-density signal routing such as HBM interfaces, and folded beam springs for regions with intermediate signal routing. These, and other spring structures can be used in a single design and can readily be automated as libraries in EDA software. Silicon springs enable ZettaLith's large passive silicon substrates to tolerate thermal gradients and mechanical stresses without cracking, warping, or causing excess elasto-plastic strain of microbump and CGA solder connections.

Other innovations include redundant interconnect schemes, specialized handling techniques, and thermal management approaches that enable practical implementation of large-scale silicon substrates.

### PSGCB—Panel-Scale Glass Circuit Board Alternative

In an alternative embodiment, the substrate may be formed as a Panel-Scale Glass Circuit Board (PSGCB). A PSGCB is a passive glass substrate manufactured using flat-panel-display (FPD) grade lithography and processing, substituting for a WSSCB. The primary advantage of the PSGCB is the potentially larger available continuous area, allowing a significantly larger number of chip stacks to be attached within a single, low-latency computational domain. While the substrate material is glass rather than silicon, the high-speed signals propagate primarily within the redistribution layers (RDL) on the surface of the PSGCB and do not traverse the bulk substrate material. Consequently, the data processing extent and interconnect density are functionally equivalent between a WSSCB and a PSGCB, and both are considered an “All-Silicon Domain” in the context of the present disclosure, defined by lithographic-grade interconnect pitch rather than the chemical composition of the base handling wafer.

WSSCBs are generally limited to the maximum standard area of semiconductor manufacturing equipment, currently a 300 mm diameter silicon wafer.

In contrast, the flat panel display industry routinely mass-produces active-matrix glass panels at significantly larger scales. Current Generation 10.5 (Gen 10.5) or Generation 11 (Gen 11) glass panels, utilized for large-format television and monitor applications, possess dimensions of approximately 2,940 mm×3,370 mm.

Contemporary glass-core substrate technologies utilize panels of approximately 700 mm×700 mm for chip attachment. However, the architecture described herein may feasibly extend to the maximum dimensions of glass panels used for television production (e.g., Gen 10.5) without requiring the development of entirely new lithographic tool chains, as these tools already exist for display backplane manufacturing.

A PSGCB generally comprises a passive glass core containing Through-Glass Vias (TGVs) and high-density surface interconnects, replacing the traditional combination of printed circuit board (PCB), package substrate, and organic interposer layers. The PSGCB supports the direct attachment of chiplets, HBM stacks, and TRIMERA modules via microbumps.

Table 5 compares two exemplary form factors of a PSGCB (a 700 mm panel and a Gen 10.5 panel) against the WSSCB embodiment utilizing a 300 mm silicon wafer.

TABLE 5
PSGCB compared to WSSCB

| | WSSCB | PSGCB | PSGCB | |
|---|---|---|---|---|
| Aspect | (300 mm) | (700 mm) | Gen 10.5 | Unit |
| Substrate X dimension | 260 | 700 | 3,370 | mm |
| Modules (X-axis) | 10 | 29 | 140 | count |
| Substrate Y dimension | 200 | 700 | 2,940 | mm |
| Modules (Y-axis) | 18 | 63 | 267 | count |
| Total modules | 172 | 1,827 | 37,380 | count |
| Scaling Factor (vs WSSCB) | 1.0× | 10.6× | 217.3× | ratio |
| Max HBM4 capacity | 11 | 117 | 2,392 | TB |
| Capacity Factor (vs WSSCB) | 1.0× | 10.6× | 217.3× | ratio |

It should be noted that the “Max HBM4 Capacity” figures in Table 5 include both the memory allocated to the TRIMERA compute modules and the associated CPU host stacks, distinct from values cited elsewhere referring solely to TRIMERA-attached memory.

Glass panel substrate processing currently lags silicon wafer processing in feature density and aspect ratio capabilities. Due to the absence of a glass-etching process equivalent to the high-aspect-ratio Bosch Deep Reactive Ion Etching (DRIE) of silicon, Through-Glass Vias (TGVs) and stress-relief structures (analogous to silicon springs) are generally less area-efficient than their silicon counterparts. Furthermore, minimum line widths/spacing (L/S) for copper interconnects on large-panel glass are currently larger than those achievable on 300 mm silicon wafers.

However, the scaling potential allows a PSGCB-based system to provide large aggregate memory capacity. As shown in Table 5, a full-scale Gen 10.5 PSGCB system can support over 2,300 Terabytes of HBM4. This capacity and the associated large parallelism render the system suitable for training frontier-scale Large Language Models (LLMs) within a single domain.

For AI training, the ZettaLith SOTA Logic Die (ZSLD) is adapted to support higher numerical precision (e.g., FP8, BF16) and the HILT is adapted to include hardware-accelerated backpropagation.

The power supply requirements and thermal dissipation of a PSGCB system scale linearly with the module count, resulting in total system power loads that are orders of magnitude higher than a single WSSCB rack. However, the inverted-hierarchy power delivery network and the JETSTREAM/JETSCI cooling architectures disclosed herein also scale linearly with module count.

### Silicon Springs—Principles and Operation

Silicon springs are lithographically defined, planar compliance structures etched through the thickness of the wafer-scale silicon circuit board (WSSCB) to mechanically and thermally decouple regions of the wafer while maintaining uninterrupted high-density wiring across those regions. Instead of mounting compliant elements between the WSSCB and attached silicon stacks, the compliance is built directly into the WSSCB itself. The WSSCB is divided into rigid “islands” of solid silicon, each supporting one or more TRIMERA, CPU, or HBM/HBF stacks. Adjacent islands remain fully interconnected by redistribution-layer (RDL) wiring that traverses arrays of through-silicon spring structures formed in the silicon substrate beneath the wiring.

Each silicon spring is an elastic beam path etched through the WSSCB in a pattern defined by a DRIE Bosch process step. Millions of springs are produced simultaneously without assembly, using the same lithographic step that defines the surrounding through-silicon channels. These channels form the voids separating islands and provide the clearance necessary for the springs to flex. The spring geometries are optimized to achieve the required combination of mechanical compliance, wiring density, and thermal isolation. Two principal spring families are used: V-Beam springs and Fermat-Archimedean (FA) spiral springs.

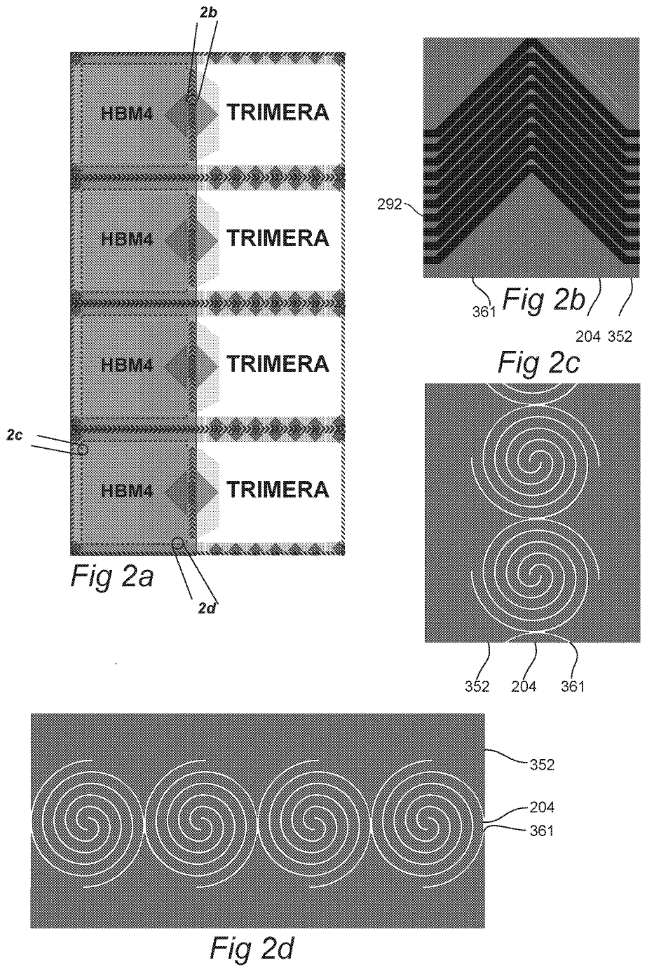

V-Beam springs are used in regions of high interconnect density, such as between logic and memory stacks, or across the horizontal and vertical communication fabrics that form the ZettaLink. Each V-Beam spring consists of paired, inverted-V-shaped silicon elements that zig-zag between adjacent islands. Their geometry provides moderate in-plane and vertical compliance while maintaining an almost direct, high density routing corridor through the spring path. The RDL wiring follows these V-Beam contours, with each dark “V” line visible in FIG. 2B corresponding to 16 parallel conductors per RDL layer, in paired layers for redundancy, and separated by ground-plane layers. The RDL layers are patterned and etched through in register with the subsequent underlying DRIE spring etch, using slightly larger openings to prevent stress-concentrating overhangs. The V-Beam pattern thus provides a mechanically compliant yet electrically dense corridor for thousands of UCIe 2.0 vertical and horizontal links.

Fermat-Archimedean (FA) spirals have several desirable characteristics, including smooth, differentiable continuity from the end of one spring arm to the end of the other, extremely low out-of-plane stiffness and tolerance of high deflection with low peak stress, relatively isotropic in-plane stress relief, and a high degree of stiffness adjustment by varying the arm widths and arm lengths. FA spiral springs are employed in areas of lower wiring density where increased mechanical and thermal compliance is required. Each FA spiral spring follows a compact spiral path that behaves as a multi-turn leaf spring within the wafer plane. FA springs are substantially more compliant than V-Beams—both laterally (X/Y) and out-of-plane (Z)—permitting hundreds of microns of Z elastic deflection without plastic deformation or fracture. This flexibility allows the WSSCB to accommodate local planarity deviations, differential thermal expansion between neighboring chip stacks, and particle stand-offs during assembly. In conjunction with the V-Beam springs, thermal expansion across the WSSCB is not cumulative, by isolated to silicon circuit board (SCB) module islands of around 11 mm×24 mm (1 HBM/HBF stack and one compute stack).

Because deformation of silicon springs during normal use remains fully within silicon's elastic range, there is no fatigue mechanism or wear-out over time. The only practical failure mode is brittle fracture due to overstress, which is avoided through giving ample margins in the spring design to keep the strain within elastic limits, and eliminating stress concentrators.

Both spring types coexist across the WSSCB. Regions requiring dense interconnect and precise alignment—such as between compute and memory islands—use V-Beams, while FA spirals are distributed where routing allows to absorb mechanical and thermal strain. The overall spring lattice provides anisotropic compliance: higher stiffness along interconnect corridors, lower stiffness across thermal gradients, and large Z-direction flexibility to maintain microbump reliability across temperature cycles and WSSCB warpage.

Because silicon springs are defined photolithographically, their geometry can be locally customized without adding process complexity. Thousands of spring variants can be placed across a wafer in a single mask, allowing compliance to be tuned island-by-island if desired. In practice, only a small number of V-Beam and FA spiral variants are required to cover all mechanical and thermal conditions expected in ZettaLith assemblies.

The result is a wafer-scale substrate with deterministic, elastic compliance built directly into the silicon structure. Electrical and power continuity is preserved through the RDL traces that traverse the springs, while the silicon itself provides the mechanical isolation required to prevent warpage, stress propagation, and thermal crosstalk between chip-stack islands. Silicon springs thus transform the WSSCB from a rigid monolithic slab into a segmented, elastic, and electrically continuous foundation—a structure that simultaneously supports extreme I/O density, wafer-level manufacturability, and near-indefinite mechanical reliability.

### Silicon Spring Details

FIGS. 2a to 2d illustrate various stress relief structures integrated into the SCB architecture, which are essential for managing thermal expansion and mechanical stress across large silicon areas while maintaining electrical connectivity.

FIG. 2a presents a 1×4 SCB module array, showing the placement of stress relief structures throughout the SCB. These structures are critical for maintaining mechanical stability and electrical continuity across the multi-module array.

The SCB module comprises silicon springs—mechanical structures etched completely through the silicon wafer that provide thermal and mechanical stress relief This stress relief can isolate sources of thermal and mechanical stress by orders of magnitude, effectively limiting propagated stress to chiplet scale regions of approximately 1 cm².

The springs limit the thermal expansion and warpage stress zones to one HBM or logic chiplet stack (e.g. TRIMERA stack) footprint. This is considerably smaller than the stress zones encountered by current silicon interposers.

FIG. 2b shows an array of V beam stress relief springs specifically designed for regions requiring high interconnect density in the RDL. The V beam configuration 204 incorporates bent channels 361 etched through silicon 352 while accommodating multiple local interconnects 292.

FIG. 2c provides an enlarged view of a line of Fermat-Archimedean spiral (FA spiral) springs decoupling stress from one portion of an SCB to another. This design combines the properties of Fermat and Archimedean spirals to create a structure that can effectively absorb stress in X, Y, and Z directions simultaneously while maintaining a compact footprint. The Fermat spiral has two endpoints on opposite sides, so can connect two opposite solid regions of silicon. However, it has progressively narrowing spiral arm widths, creating problems with fabrication, spring arm strength, and routing of signals across the spiral. An Archimedean spiral has consistent arm width, but one end of the spiral is at the center. This means it cannot connect two opposite solid regions of silicon. The FA spiral combines the desirable properties of both the Fermat spiral and the Archimedean spiral. The FA spiral springs are ideal for areas of low or zero density of wiring in the RDL. The FA spiral might be thought of as a double spiral, except the term double spiral is used to refer to at least three different structures, only one of which is suitable for this application.

The combination of Fermat spiral geometry with Archimedean spiral arm spacing creates a structure that provides optimal stress relief while maintaining consistent spacing between adjacent arms. The stiffness of the FA spiral can be tuned over a very large range by changing the width of the spiral arms and the number of turns of the spiral. The thickness of the spiral is the wafer thickness, and cannot be altered without adding manufacturing complexity.

FIG. 2d depicts the same FA spiral structure aligned in the X direction, demonstrating how the design can be oriented to surround locations of chips attached to the SCB.

These stress relief structures represent a critical innovation in enabling large-scale silicon integration, allowing each SCB to maintain reliable operation despite the significant thermal and mechanical stresses inherent in wafer-scale WSSCB systems.

### Strain of a Spiral Stress Relief Structure Under X, Y Stress

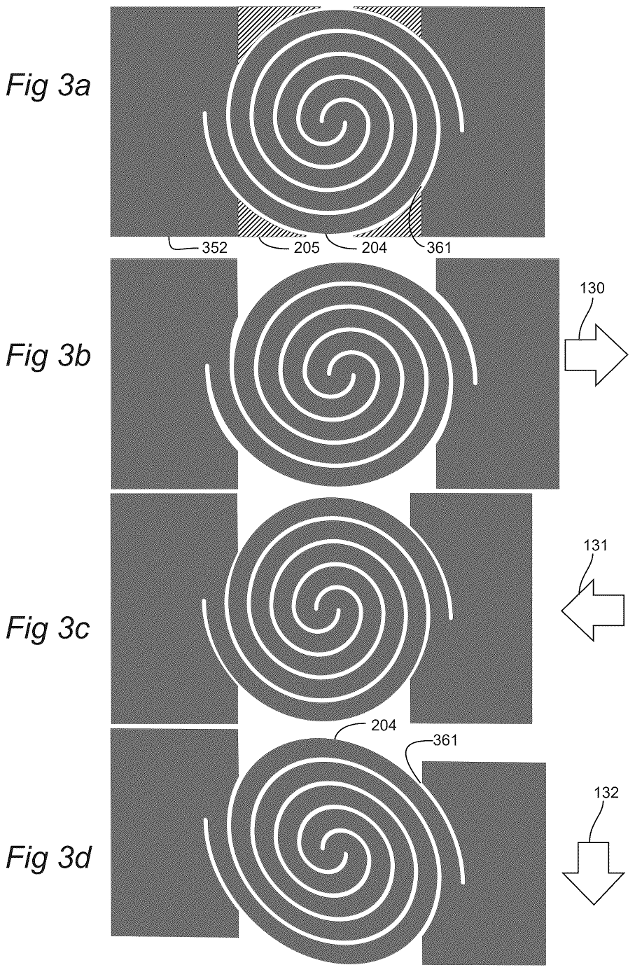

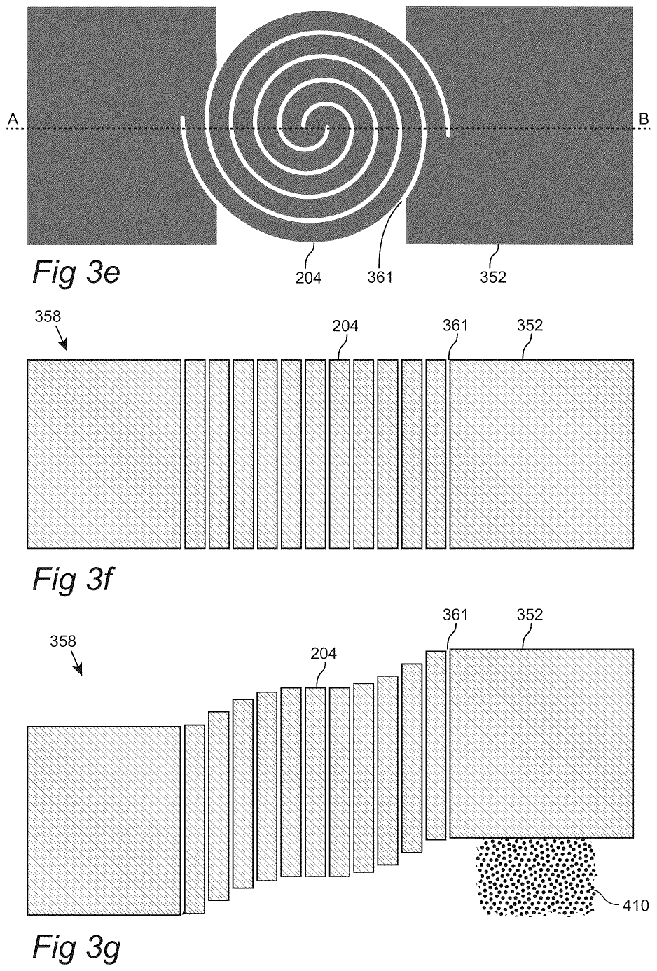

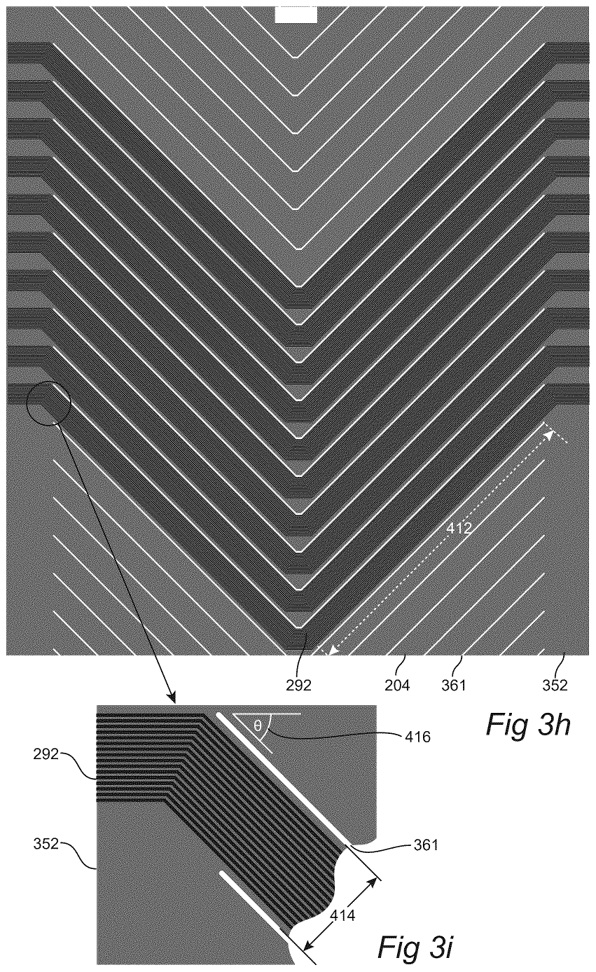

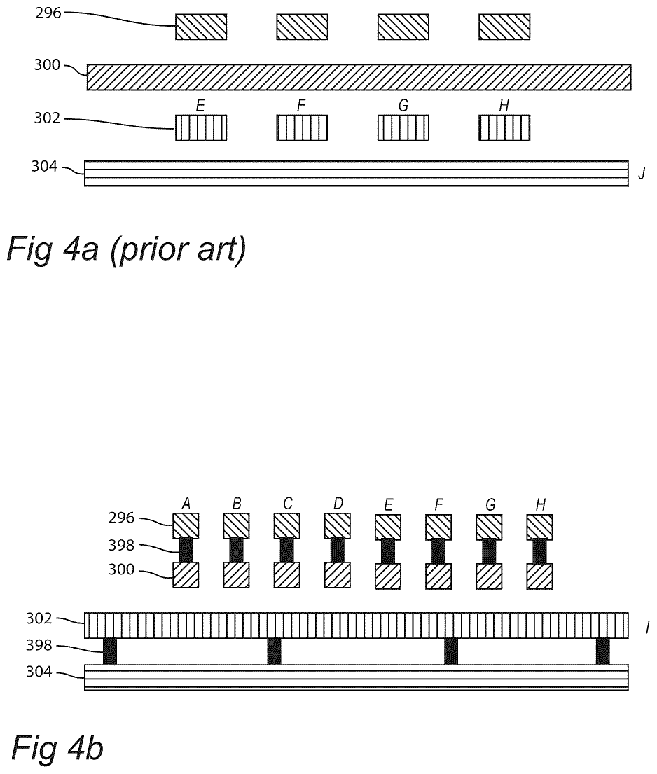

FIGS. 3a to 3d demonstrate how the Fermat-Archimedean (FA) spiral stress relief structures respond to various types of mechanical stress, illustrating their effectiveness in managing the mechanical forces present in large silicon structures.

FIG. 3a shows an FA spiral 204 in its nominal, unstressed position. The spiral structure is formed by channels 361 etched clear through silicon 352, creating a symmetrical pattern of interleaved spiral arms. This represents the baseline configuration when no external forces are applied. The extended regions 205 have been omitted in the FA spiral diagrams for clarity. They do not form part of the spring operation, but are present to keep the etch channel width relatively constant during deep reactive ion etching (DRIE) during manufacturing. Variations of etch channel width cause the DRIE to etch at different rates, and therefore different depths in the time allowed for etching. This causes manufacturing difficulties. The presence of the extended regions 205 have no effect on the functioning of the SCB during normal operation.

FIG. 3b illustrates the FA spiral under tensile stress, with arrow 130 indicating the direction of expansion strain. The spiral arms deform elastically as the surrounding silicon blocks move apart, with the etched channels 361 allowing the silicon spring 204 to elongate while maintaining its fundamental interconnected pattern and electrical connectivity. The strain is exaggerated for clarity. The typical strain encountered by an SCB would be substantially less.

FIG. 3c depicts the FA spiral under compressive stress, with arrow 131 showing the direction of compression strain. The silicon spring 204 compresses as the surrounding silicon blocks 352 move together, with the spiral arms deflecting inward through the deformation of the etched channels 361. The symmetrical design ensures uniform compression, preventing localized stress concentrations.

FIG. 3d shows the FA spiral responding to shear stress, with arrow 132 indicating the direction of shear strain. The silicon spring 204 deforms laterally between the silicon blocks 352, with the etched channels 361 enabling the structure to accommodate in-plane shear stress. Shear stress can occur in springs oriented parallel to the direction of expansion of one module relative to the adjacent module.

An advantage of the FA spiral is that it responds well to any combination of X, Y, and Z stresses.

### Strain of a Spiral Stress Relief Structure Under Z Stress

FIGS. 3e to 3g illustrate how the FA spiral stress relief structures accommodate out-of-plane forces and potential manufacturing or operational contaminants.

FIG. 3e shows an FA spiral spring 204 in its nominal position, with a reference line A-B indicating the location of the cross-sectional views shown in FIGS. 3f and 3g. The spiral structure is defined by channels 361 etched through the silicon 352.

FIG. 3f presents a cross-sectional view of the SCB 358, showing the normal position of the silicon spring 204 when no foreign matter or Z axis strain is present. The through-etched channels 361 create a structure that can flex not only in-plane but also in the vertical direction.

FIG. 3g demonstrates the FA spiral's ability to accommodate significant out-of-plane deflection when encountering a foreign particle contaminant 410. The silicon spring 204 can deflect vertically without damage to either the spring structure or the surrounding SCB 358. Significant Z deflections of 100 μm or more can be accommodated. The amount of Z axis deflection that can be tolerated by the SCB without excessive stress or cracking can be made arbitrarily large by increasing the number of turns of the FA spiral.

This mechanical compliance is crucial for manufacturing yield and operational reliability, as it prevents particle contamination and jig misalignment from causing catastrophic damage to the SCB structure.

This inherent tolerance to foreign particles and non-planarity of the SCB represents an important reliability feature of the FA spiral design, allowing the SCB to maintain functionality even when faced with real-world manufacturing and operational challenges.

### An SCB Stress Relief Structure for Dense Connection Regions.

FIGS. 3h and 3i detail the V beam configuration of silicon springs specifically designed to accommodate the high interconnect density required for HBM4, HBF, and UCIe 2.0 interfaces while maintaining mechanical flexibility.

FIG. 3h presents a V beam silicon spring structure 204 capable of routing the almost 6,000 signal connections required for a single HBM4 memory interface. The structure achieves this high connection density by utilizing four RDL layers, with the V beams etched through the silicon 352 via channels 361 forming the gaps between springs. Each V beam accommodates multiple local interconnects 292, efficiently using the available space while maintaining mechanical compliance.

FIG. 3i shows an enlarged section of a single V beam structure, demonstrating how 64 connections are accommodated within each V beam—16 connections per RDL layer across four layers. The geometry of the V beam is defined by its half-length 412 and beam width 414 and beam angle 416, which are optimized to balance mechanical flexibility with interconnect density. The V shape provides controlled mechanical deformation while maintaining reliable electrical connectivity through the local interconnects 292.

The V beam silicon springs add very little extra length to USR wiring, as the springs are placed in the necessary physical gap between the microbump arrays of two adjacent die. The extra length of a USR wire is thereby not the length of the V beams, but the extra length of the hypotenuse of the triangles resulting from the deflection of the beam from a straight line—i.e. 2×(cos(beam angle 416)/half-length 412 minus half-length 412). This may increase a USR wire that would normally be 2 mm to around 2.1 mm.

This V beam configuration represents an efficient solution for high-density interconnect regions of the SCB, providing the necessary mechanical compliance while supporting the extensive signal routing requirements of modern memory and I/O interfaces.

### Critical Importance of Silicon Springs to WSSCB Reliability

These stress relief structures represent a critical innovation in enabling large-scale silicon integration, allowing the SCB to maintain reliable operation despite the significant thermal and mechanical stresses inherent in large scale silicon substrates. FA spirals can reduce mechanical and thermal stress propagation by orders of magnitude compared to solid silicon. The stress propagation may be made arbitrarily low by tuning the FA spiral—the more turns the spiral has, and the thinner the spiral arms, the more compliant the silicon spring becomes.

### Fault Tolerance in SCB Wiring

FIG. 3b illustrates a method for achieving fault tolerance in RDL wiring without increasing the total number of metal layers or significantly impacting electrical characteristics.

FIG. 3a shows a conventional four-layer RDL stack with, for example, n μm wide signal lines at 2n μm pitch. Metal layer M1 296 contains wires A, B, C, and D running in one direction, while metal layer M2 300 contains wire I running orthogonally. Metal layer M3 302 contains wires E, F, G, and H, with metal layer M4 304 containing wire J running orthogonally.

FIG. 3b demonstrates the fault-tolerant configuration using the same four metal layers. Each signal is implemented as a pair of parallel wires of 0.5n μm width and n μm pitch on adjacent metal layers, connected periodically by vias 398. Wires A through H are now arranged in metal layer M1 296 and M2 300 at half the original width and pitch, each wire in M1 connected to its counterpart in M2 by a via 398. Wire I is shown on both metal layers M3 302 and M4 304, connected by vias 398. Wire J, while present in the same configuration as wire I, is not visible as it is located directly behind wire I in the diagram view.

This redundant configuration provides:
Protection against open-circuit defects with minimum change in resistance, as current can route around defects through the connecting vias;
Maintained signal resistance equivalent to the n μm single traces, as the 2 parallel 0.5n μm lines provide largely the same total cross-sectional area;
No increase in total RDL thickness or layer count; and
Compatibility with existing 65 nm CMOS fab equipment.

This system achieves very high fault tolerance allowing high yields even of WSSCBs with millions of wires between microbump landing pads. Assuming short circuits are detected during optical inspection of each layer, and automatically laser ablated, the system is highly tolerant of open circuits. For an open circuit in a layer to cause an actual open circuit in the wire, there must be another open circuit on the matching layer affecting the same wire between the same set of vias. For random defects the chance of this happening is vanishingly remote. The two masks for adjacent layers will be similar, but typically not identical. Even if the masks are identical, the same mask should not be used for the two layers, as a mask defect can provide a correlated open circuit on both layers, causing an actual defect in the SCB.

This approach achieves fault tolerance through geometric reconfiguration rather than through additional process steps or materials. Parasitic capacitance is increased between wires running parallel to each other (potentially 4 times higher due to the combination of halved spacing and doubled layer interaction) but reduced between orthogonal wires (potentially halved). The increase in parasitic capacitance between parallel wires must be considered for high-speed signals.

In ZettaLith, the majority of wires are parallel wires each just 1.4 mm long for the UCIe 2.0 based vertical ZettaLinks. These parallel wires are short enough that the increased parasitic capacitance does not overwhelm the signal. Ground planes are added between the pairs of signal planes.

### SCB and WSSCB Cross Section

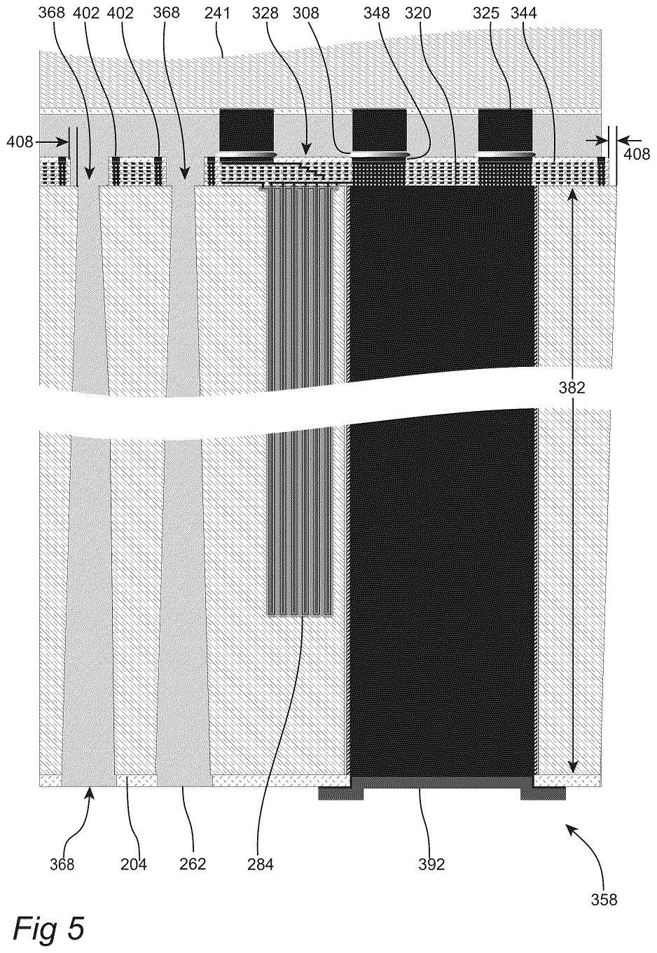

FIG. 5 shows a cross section of a small portion of a WSSCB 358 attached to a TRIMERA stack 241. Details of how to manufacture this structure are contained in a co-pending patent application by the same inventor.

The WSSCB cross section 358 shows an almost full thickness 300 mm silicon wafer of approximately 710 μm thick silicon 382. The WSSCB wafer contains integrated decoupling capacitors 284 and power/ground or slow signal TSVs 320. High speed signals between HBM/HBF stacks (not shown) and TRIMERA stacks 241, and between adjacent TRIMERA stacks attached to the WSSCB travel in the ultra-short range (USR) signal wires 344.

The WSSCB contains silicon springs 204 etched through the wafer at the spring gaps 368. These silicon springs may be FA spiral silicon springs, V beam silicon springs, folded beam silicon springs, or any other configuration of silicon spring appropriate to the design.

An RDL-silicon indent 408 prevents stress concentrators formed from overhang of the RDL layer into the spring gap, which could potentially cause delamination or crack propagation.

An optional elastomeric underfill 262 prevents ingress of the coolant into the WSSCB and its attached chips, without interfering with the elastic deformation of the silicon springs. This underfill 262 is a precaution against contaminants and should not be necessary if the manufacturing process and coolant are sufficiently clean.

TRIMERA stack 241 is connected to the WSSCB through microbump copper pillars 325 joined by solder 308 to microbump landing pads 348 of the redistribution layer (RDL) 328, which contains signal wires 344 and edge seals 402.

The WSSCB has UBM pads 392 for connecting the CGA pillars of the PSU PCBs, the 800 GbE PCBS, and the PCIe 6.0 PCBs.

### TRIMERA Stack Overview

The ZettaLith TRIMERA stacks are CASCADE arrays of FP4 processing elements. Other systems using ZettaLith construction can use different TRIMERA stacks, such as BitNet b1.58 CASCADE arrays, higher resolution transformer inference stacks, HPC stacks or DSP stacks for various applications.

The FP4 TRIMERAs are designed as a Simple Hybrid Array of Processing Elements (SHAPE). They contain edge-to-edge CASCADE arrays of FP4 PEs. This achieves maximum performance, and extreme simplicity. The ZSLD contains 203 million FP4 PEs, each being 697 transistors. There are no bond pads, no TSVs, no SRAM, no analog, and nothing that requires synthesis or standard cells.

All connections to any other circuitry is via hybrid bonding to the HILT die. The ZSLD can be designed for a new process without waiting for standard cells, SRAM, or analog/mixed-signal qualification, or IP blocks for complex designs such as processors or high speed interfaces. All such circuits are in the mainstream process BID or the HILT dies, which can potentially remain unchanged over multiple generations of SOTA process nodes.

While back-side power is scheduled to be available for the A16 node, this is not used. Power is delivered via hybrid bonding to the front side of the wafer.

The ZSLD is intentionally very simple and highly repetitive. This is to make it extremely fast to design, and to port to new processes. It also reduces mask calculation time, which is significant at SOTA logic nodes.

### Main Signal Interconnects of TRIMERA

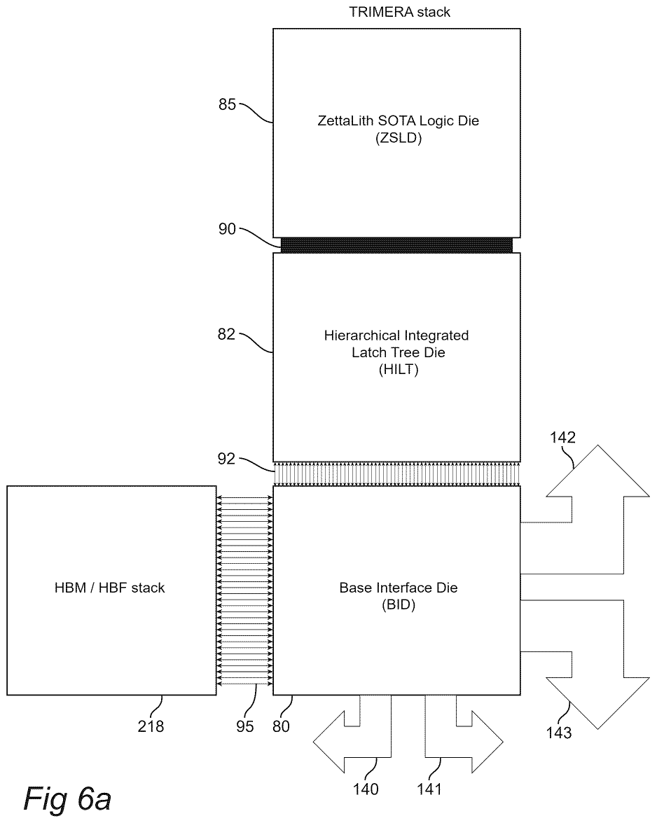

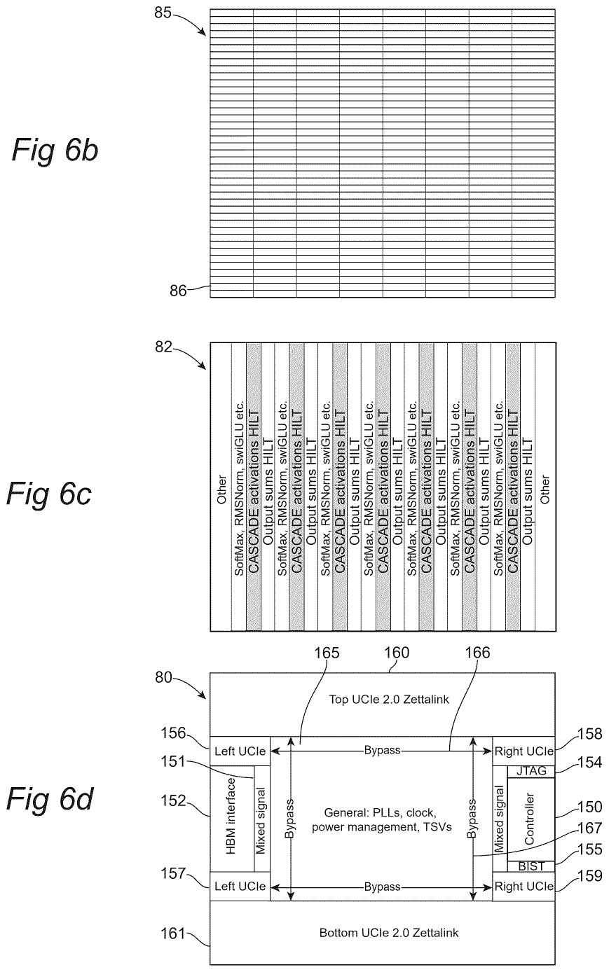

FIG. 6a illustrates the fundamental signal interconnect architecture within an SCB module of a WSSCB, showing how high-bandwidth memory (HBM) interfaces, logic processing, and I/O functions are integrated through interconnection paths.

The ZSLD 85 is integrated with the HILT 82 via very high density face-to-face hybrid bonds 90 providing millions of high-density, low-latency vertical connections between the ZSLD and the HILT. The HILT is integrated with the BID through back-to-back TSV-to-TSV hybrid bonding 92.

The HBM/HBF stack 218 connects to the BID 80 through HBM connections 95 in the RDL of the SCB or WSSCB.

The TRIMERA module achieves connectivity with adjacent SCB modules through UCIe 2.0 connections in the RDL of the SCB or WSSCB in all four orthogonal directions: leftward 140, rightward 141, topward 142, and bottomward 143.

This interconnect architecture enables the creation of a scalable computing platform where multiple modules can work together cohesively. The combination of high-bandwidth memory interfaces, advanced ZSLD logic processing, and mainstream BID functions, all connected through high-density on-silicon connections, provides a balanced architecture that can be replicated across the WSSCB.

### The ZettaLith SOTA Logic Die (ZSLD)

In the ZettaLith, the TRIMERA stacks are CASCADE arrays of FP4 W4A8 processing elements. Other ZettaLiths can have different TRIMERA stacks, such as BitNet b1.58 CASCADE array, higher resolution transformer inference stacks, transformer training stacks, HPC stacks or DSP stacks for various applications.

The FP4 W4A8 TRIMERAs are designed as a Simple Hybrid Array of Processing Elements (SHAPE). They contain edge-to-edge CASCADE arrays of FP4 W4A8 PEs. This achieves maximum performance, and extreme simplicity. There are no bond pads, no TSVs, no SRAM, no analog, and nothing that requires synthesis or standard cells.

All connections to any other circuitry is via W2 W hybrid bonding to the HILT and BID. The ZSLD can be designed for a new process without waiting for standard cells, SRAM, or analog/mixed-signal qualification, or IP blocks for complex designs such as processors or high speed interfaces. All such circuits are in the mainstream process BID or the HILT dies, which can potentially remain unchanged over multiple generations of SOTA process nodes.

While back-side power is scheduled to be available for the A16 node and later, this is not used. Power is delivered via W2 W hybrid bonding to the front side of the wafer.

FIG. 6b shows the SLD 85 which must be the same physical size as the HILT die 82 shown in FIG. 6c and the BID 80 shown in FIG. 6d. This is because the ZSLD, HILT die, and BID are bonded at the wafer level, using W2 W hybrid bonding. W2 W hybrid bonding allows superior alignment, and therefore higher bond density.

### The Base Interface Die (BID)

FIG. 6d illustrates the basic contents of the BID 80, which integrates multiple interface blocks and memory elements in a mainstream process node. This is not a floor plan of the chip, but an approximate use of chip area per function, and approximate arrangement of microbonds to the SCB. The die includes:
HBM4 interface 152
A central controller 150 managing die operations
A configuration NVM for the central controller
Mixed signal circuits 151 containing:
   Analog components and PLLs
   Temperature sensors and thermal management
   Clock generation and distribution
   Power management
   Power-on reset and initialization circuits
System monitoring and telemetry
   JTAG interface 154 for external testing and debugging
   BIST controller 155 for built-in self-testing
   Error logging memory
ESD protection circuits for the signal TSVs
TSVs to convey signal and power connections to the reverse side of the die.
Very high bandwidth UCIE 2.0 data fabric links to the next BID above (160) and below (161)
Split high bandwidth UCIE 2.0 data fabric links to the next BID to the left (156, 157) and to the right (158, 159). These are split to make room for the HBM4 interface, which must be in this location due to the layout of the TRIMERA stack to the HBM/HBF stack.
AI specific engines may be on the BID, but are preferably on the HILT, depending on available space. These include, in region 165:
   SoftMax state machines
   RMSNorm state machines
   SwiGLU state machines
   A final image decoder/VAE for image applications

The BID design includes UCIe-to-UCIe module bypass paths in both horizontal 166 and vertical 167 directions, enabling faulty modules to be mapped out with only a tiny amount of the BID functional. Mapping out the SCB module is the default mode until the BID passes boot-up tests, allowing the modules to be mapped into the array only if they are functional. These bypass circuits, consuming only μW of power, are powered by neighboring modules. In this way, module arrays are fault tolerant even if it is the module's power supply that has failed.

### Security

In embodiments configured for secure multi-tenancy and confidential computing, the BID functions as the hardware root of trust for the vertical compute stack. Unlike conventional architectures where memory protection is managed by software kernels, the BID incorporates a dedicated hardware Memory Protection Unit (MPU) and a secure enclave controller situated on the data path between the ZettaLink fabric and the stack's internal vertical interconnects. This MPU enforces strict aperture control logic, where read/write requests—whether originating from the local ZSLD/HILT compute die or external fabric sources—are validated against active ‘Tenant IDs’ or ‘Job IDs’ stored in tamper-resistant registers. By physically gating memory access at the BID memory controllers, the architecture strictly isolates the compute plane (ZSLD)—which may execute untrusted or proprietary user models—from the physical addressing of the HBM. Furthermore, the BID memory controllers may include inline AES-XTS encryption engines that transparently encrypt data entering the storage dies and decrypt data entering the compute dies, ensuring that data residing in the stack remains cryptographically opaque to neighboring stacks or fabric sniffers. When a workload concludes, the BID's security controller triggers a hardware-driven ‘fast scrub’ of the local memory and register files before releasing the lock, thereby preventing data remanence attacks between successive tenants without requiring intervention from the host CPU.

### No New Reticle Stitching

Reticle stitching is a significant design and fabrication problem, and much more difficult than the simple concept would imply. The WSSCB substrate is fabricated using mature 65 nm DUV lithography. TSMC's established multi-reticle stitching techniques, already proven for large silicon interposers (e.g., in CoWoS-S packaging), resolve any wafer-scale patterning challenges.

The small size of the chiplets in the TRIMERA and CPU stacks do not require reticle stitching. No novel stitching processes are required for ZettaLith.

### CASCADE Array Columns and Chip Testing

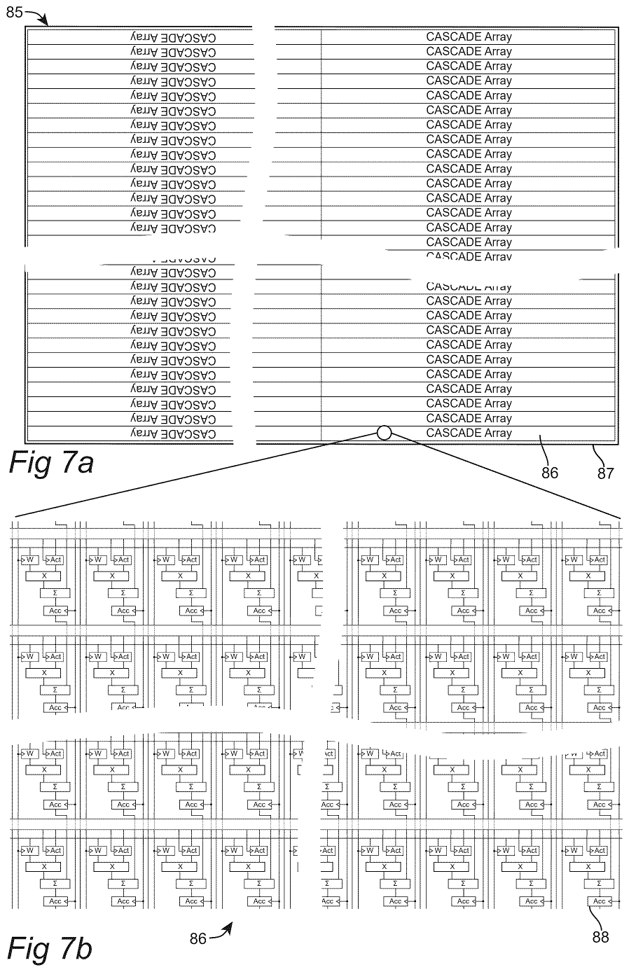

FIG. 7a shows a ZSLD 85 as a grid of CASCADE arrays 86 right to the edge of the ZSLD die 87, minus allowance for saw streets and seal rings. There are no probe pads and self-test circuits on the ZSLD die, so the ZSLD chips are not tested before wafer bonding. Bonded TRIMERA stack yield relies upon the extremely high yield of ZSLD die due to the extensive fault tolerance, able to 100% correct ZLSD die even in the presence of uncommercial levels of random point defects.

Wafer level process checks are done using test regions at the wafer edge and in the center of the wafer.

Both the ZSLD and the HILT dies are highly fault tolerant. The BID is in a mainstream process, so is expected to have high yield through conventional design.

Once TRIMERA stacks are hybrid bonded, the ZSLD and HILT can be tested by probing the microbumps on the frontside of the BID, connected by back-to back hybrid bonding of TSVs to the HILT, and from there by front-to-front hybrid bonding to the ZSLD. The extensive BIST and JTAG circuitry is in the BID.

FIG. 7b shows part of a CASCADE array 86 showing the FP4 W4A8 PEs 88.

### CASCADE Array HILT Support in a TRIMERA

The HILT die contains HILT data arrays to feed the CASCADE arrays with activations, collect calculated sums from the output, and provide the CREST comparison logic. The weights are stored directly in the CASCADE array in the ZSLD.

Table 6 shows the support logic, HILT arrays, and FIFOs feeding the CASCADE arrays with activations and weights and collecting output sums. The activation HILTs feed into the centers of the broadcast latch trees of the CASCADE rows and are positioned in the centers of CASCADE arrays to minimize 15 GHz wire lengths.

The output sums HILTs are connected to the final CASCADE array and are large enough to need to be distributed across the chip. The clock frequency of the output sum hilts can readily be reduced with negligible effect on system performance by increasing write parallelism from 128 to 256 bits.

### Structure of CASCADE Arrays

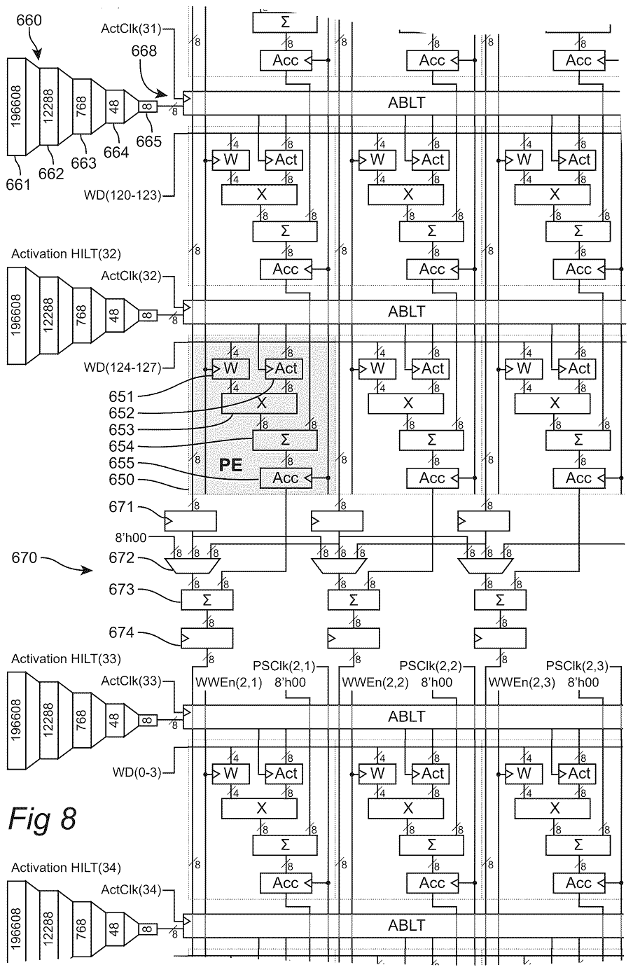

FIG. 8 shows a block diagram of parts of two adjacent CASCADE arrays of FP4 PEs.

The block diagram shows an array of FP4 processing elements (PEs) 650, each comprising:
an FP4 weight latch 651;
an FP8 activation latch 652, which is the final stage of the activation latch tree;
an FP4×FP8 multiplier 653, with FP8 approximated result;
an FP8 plus FP8 saturating adder 654; and
an FP8 accumulator 655.

### Activation HILTs

There is one activations HILT memory 660 for each of the 18,944 rows of the CASCADE arrays on the TRIMERA stacks. The HILT memory takes the place of SRAM, but has far higher bandwidth, smaller bit-cell size, and far lower power. However, the it is not operated as a random access memory, but more akin to a large FIFO, but without all the latches toggling as in a FIFO. The activations HILT memory comprises:
activations HILT stage 1 661 with 196,608 tri-state latches, each storing one bit of the B×L 8-bit activations. The tri-state latches have 8 transistors each and are approximately comparable to an SRAM bit cell. The tri-state outputs are transmission gates implementing a 16:1 multiplexer;
activations HILT stage 2 662 with 12,288 latches with tri-state outputs forming 16:1 multiplexers;
activations HILT stage 3 663 with 768 latches with tri-state outputs forming 16:1 multiplexers;
activations HILT stage 4 664 with 48 latches with tri-state outputs forming 6:1 multiplexers; and
activations HILT stage 5 665 with 8 latches interfacing with the activations broadcast latch tree on the ZSLD.

### Activation Broadcast Latch Tree (ABLT)

The activation broadcast latch tree 668 takes the FP8 output of the activations HILT stage 5 latches and replicates the one activation to be provided simultaneously to all 8,208 columns (including spare/CREST columns) of the cascade array. In the array, this activation is multiplied by 8,192 specific weights and accumulated into 8,192 partial sums.

The ABLT is the functional equivalent of a parallel connection bus, except that a bus with a 1000+ node fanout would be far too slow for 15 GHz operation. Instead, the fanout is kept under 4 with a tree of latch stages.

The stages of the activations HILT and broadcast latch tree are shown in Table 13.

### The PE Array

In the PE array, this activation is multiplied by 8,192 specific weights and accumulated into 8,192 partial sums. The partial sums flow down the CASCADE arrays until each of 18,944 activations from successive activation HILTs and ABLTs has been multiplied by its appropriate weight and accumulated as 8,192 output sums and stored in their appropriate output sum HILTs.

CASCADE Inter-Array Mechanism with CREST

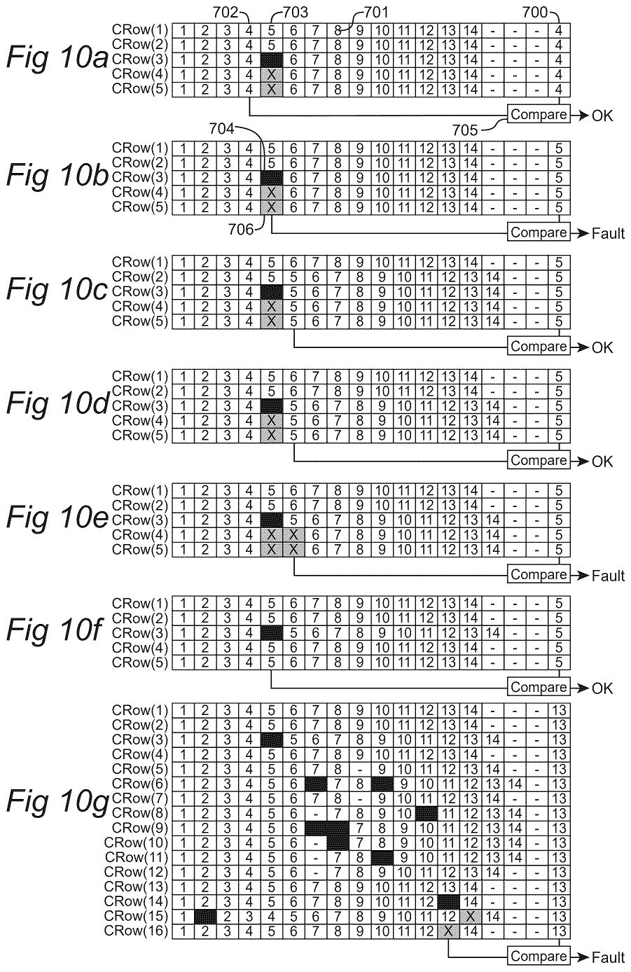

The CASCADE inter-array mechanism 670 is shown in FIG. 8 between the first and second CASCADE array of the TRIMERA stack. Such a mechanism occurs between each of sequential pairs of the 592 CASCADE arrays in the chip stack. The CASCADE inter-array mechanism 670 comprises 8,208 copies of each of:
a previous array column segment latch 671;
a CREST multiplexer 672. Under CREST software control, this selects either the previous column to the left, the previous direct column, or the previous column to the right to be added to the output of the current direct column. The operation of the CREST mechanism is shown in FIG. 10a to FIG. 10g;
a CASCADE array adder 673, which adds the previous array (after CREST selection) to the current array; and
a current array column segment latch 674. This directly feeds the previous array column segment latch 671 of the next array, resulting in only the wire delay the length of 32 PE's (the number of rows in a column) between the latch 674 and the latch 671, which should enable timing closure at 15 GHz. If not, the rows in a CASCADE array can be reduced with a consequent increase in number of CASCADE arrays with little consequence.

### Partial Sum Accumulation

The CASCADE array takes FP4 weights and FP8 activations and accumulates sums in FP8. Accumulating sums in INT8 is an alternative, but INT8 provides a smaller dynamic range, so it makes it more difficult for the quantized transformer to maintain accuracy.

The ZettaLith FP8 arithmetic is not IEEE 754 compliant, as this is not required for transformer inference, and ZettaLith is not a general purpose GPU.

### Alternative Embodiment: Ternary Weight (BitNet b1.58) Processing Element

In an alternative embodiment of the ZettaLith architecture, the Processing Elements (PEs) within the ZSLD are configured to execute ternary-quantized inference, such as the “BitNet b1.58” format, rather than floating-point operations.

In this configuration, the architecture retains the HILT vertical stacking, the broadcast of activations via the activation-distribution dies, and the on-stack accumulation, but replaces the FP4 Fused Multiply-Accumulate (FMA) units with ternary addition logic to further reduce power consumption and transistor count.

In this embodiment, the model weights are constrained to ternary values {−1, 0, +1}, requiring only 2 bits of local storage per weight (e.g., using a 2-bit latch). The input activations are provided as signed 8-bit integers (INT8).

Unlike the standard embodiment which employs a floating-point multiplier, the ternary PE utilizes a multiplexer-based selection mechanism. For a given weight W and an input activation A, the arithmetic unit selects the output X such that: if W=+1, X=A; if W=−1, X=−A (computed via 2's complement inversion); and if W=0, X=0.

This selected value X is then passed to an adder stage where it is added to the running partial sum residing in the accumulator. Crucially, because the multiplication of an INT8 activation by a ternary weight is functionally equivalent to a conditional addition or subtraction, the PE eliminates the need for a wide combinational multiplier circuit. This reduction allows the PE density to increase significantly compared to the FP4 embodiment. To address timing closure constraints inherent in wide integer addition at high clock frequencies (e.g., >10 GHz), the adder stage of the PE may be implemented using a Carry-Save Adder (CSA) topology or a pipelined Carry-Lookahead Adder (CLA).

In a preferred high-frequency configuration, the partial sum accumulation is split into segments or maintained in a redundant carry-save format within the PE loop, and only resolved to a standard binary integer at the completion of the dot-product sequence or when transferring the sum to the Distribution-Storage HILT Die.

This ternary embodiment leverages the high-bandwidth activation broadcast of the ZettaLith stack. Since ternary weights are stored locally and consume minimal area, the weight memory bandwidth bottleneck is effectively eliminated. The INT8 activations are broadcast vertically through the HILT-ZSLD hybrid bonded connections as described in the FP4 preferred embodiment, and the ternary logic selects the additive term to update the local partial sum.

This configuration is particularly advantageous for Transformer architectures where the reduction in weight precision does not degrade model performance, allowing for extreme throughput per watt, and more than doubling the weight storage capacity of the HBMs.

### HILT—Hierarchical Integrated Latch Tree Memories

HILTs appear on the HILT die, face-to-face hybrid bonded to the ZSLD die in the TRIMERA stack.

The HILT die contains HILT data arrays to feed the CASCADE arrays with activations, collect calculated sums from the output.

HILTs are a sequential-access memory structure composed of pipelined latch arrays multiplexed via transmission gates in a hierarchical tree topology. It replaces traditional SRAM in ultra-high-bandwidth applications such as AI inference but is not a general SRAM substitute. The HILT memory takes the place of SRAM, but has far higher bandwidth, smaller bit-cell size, and far lower power. However, the HILT is not a random-access memory, but more akin to a large FIFO, but with a tiny fraction of the latches toggling as opposed to a FIFO, where all the latches toggle.

### Weights are not in HILTs

The FP4 weights are stored directly in the CASCADE array in the ZSLD.

### Common Values for HILTs

Table 6 shows the general characteristics of the HILT memories on the HILT die. These characteristics are common to both the activation HILTs and the output sum HILTs.

TABLE 6
HILTs supporting the CASCADE Arrays

| Values in Common | Value | Unit |
|---|---|---|
| Batch size × input token length in HILT | 24,576 | B × L |
| Active CASCADE array columns | 8,192 | columns |
| Spare CASCADE columns for CREST | 16 | columns |
| Columns per CASCADE array | 8,208 | columns |
| Rows per CASCADE array | 32 | rows |
| CASCADE array size | 262,656 | PEs |
| CASCADE arrays in a TRIMERA | 592 | arrays |
| Total CASCADE rows in a TRIMERA | 18,944 | rows |
| PEs in a TRIMERA | 155,492,352 | PEs |
| TRIMERA total spare columns for CREST | 9,472 | columns |
| CASCADE array clock in ZSLD chip | 15 | GHz |
| Clocks to output delay without CASCADE | 18,984 | clocks |
| Clocks to output delay with CASCADE | 664 | clocks |
| HILT and BID chips clock speeds | 2 | GHz |
| HILT unit cell (D latch plus transmission | 8 | Tr |
| gate) | | |
| Full custom HILT bit cell in TSMC N2 | 0.013 | μm² |
| HILT overhead (decoders, clock buffers) | 16% | |

Weights are stored directly in the CASCADE arrays

### Input Activations HILTs

Table 7 shows the HILT arrays feeding the activation broadcast latch trees (ABLTs) of the CASCADE array with FP8 activations. The activation HILTs feed into the centers of the broadcast latch trees of the CASCADE rows and are positioned in HILT die to positions matching the centers of CASCADE arrays to minimize 15 GHz wire lengths.

There is one activations HILT memory for each of the 18,944 rows of the CASCADE arrays on the TRIMERA stacks. The activations HILT memory comprises:
activations HILT stage 1 with 196,608 tri-state latches, each storing one bit of the B×L 8-bit activations. The tri-state latches have 8 transistors each and are approximately comparable to an SRAM bit cell. The tri-state outputs are transmission gates implementing a 16:1 multiplexer;
activations HILT stage 2 with 12,288 latches with tri-state outputs forming 16:1 multiplexers;
activations HILT stage 3 with 768 latches with tri-state outputs forming 16:1 multiplexers;
activations HILT stage 4 with 48 latches with tri-state outputs forming 4:1 multiplexers; and
activations HILT stage 5 with 8 latches interfacing with the activations broadcast latch tree on the ZSLD.

TABLE 7

| Input Activations HILTs | Value | Unit |
|---|---|---|
| Activation HILT storage tristate latches | 196,608 | bits |
| Activation HILT stage 2 tri-state latches | 12,288 | bits |
| Activation HILT stage 3 tri-state latches | 768 | bits |
| Activation HILT stage 4 tri-state latches | 48 | bits |
| Activation HILT output bit width (1 row) | 8 | bits |
| Activation HILT total tri-state latches | 209,720 | bits |
| CASCADE array activation HILT bits | 6,291,456 | bits |
| CASCADE activation HILT bitcells area | 80,402 | μm² |
| CASCADE activation HILT total area | 95,717 | μm² |
| TRIMERA bits of all activation HILTs | 3,724,541,952 | bits |
| Total TRIMERA activation HILT area | 57 | mm² |

### Output Sum HILTs

Table 8 shows the output sum HILTs. There is one output sum HILT memory for each of the 8,208 (8,192 plus 16 spares) columns of the CASCADE arrays on the TRIMERA stacks. Each output sum HILT memory comprises:
output sum HILT stage 1 with 196,608 tri-state latches, each storing one bit of the B×L 8-bit output sum;
output sum HILT stage 2 with 12,288 latches with tri-state outputs forming 16:1 multiplexers;
output sum HILT stage 3 with 768 latches with tri-state outputs forming 16:1 multiplexers;
output sum HILT stage 4 with 48 latches with tri-state outputs forming 8:1 multiplexers; and
output sum HILT stage 5 with 8 latches interfacing with the recirculating sum mechanism on the ZSLD.

TABLE 8

| Output sum HILTs | Value | Unit |
|---|---|---|
| Output sums HILT storage tristate latches | 196,608 | bits |
| Output sums HILT stage 2 tri-state latches | 12,288 | bits |
| Output sums HILT stage 3 tri-state latches | 768 | bits |
| Output sums HILT stage 4 tri-state latches | 48 | bits |
| Output sums HILT output bit width (1 column) | 8 | bits |
| Output sums HILT total tri-state latches | 209,720 | bits |
| CASCADE output sums HILT bits | 1,613,758,464 | bits |
| CASCADE output sums HILT bitcells area | 20,623,111 | μm² |
| CASCADE output sums HILT total area | 24,551,323 | μm² |
| Total TRIMERA output sums HILT area | 25 | mm² |
| Output sums SIPO FIFO | 8 | :128 |

The output sums HILTs are connected to the final CASCADE array and are large enough to need to be distributed across the chip. The clock frequency of the output sum HILTs can readily be reduced with negligible effect on system performance by increasing write parallelism from 128 to 256 bits.

### Total HILTs in a TRIMERA

Table 9 shows the total memory storage of the HILTs on a HILT die, and the area of the die that it consumes.

TABLE 9

| Total HILT for TRIMERA | Value | Unit |
|---|---|---|
| TRIMERA activation HILT data | 444 | MBytes |
| TRIMERA output sums HILT data | 192 | MBytes |
| TRIMERA total HILT data | 636 | MBytes |
| Total CASCADE memory HILT area | 81 | mm² |
| HILT die area | 143 | mm² |
| CASCADE Array HILT % of area | 57% | |
| Time to transfer HILT memory over ZettaLink | 16.32 | μs |

### Full-Custom PE Density Advantage

ZettaLith's Processing Element (PE) is implemented as a replicated, full-custom hard macro rather than a standard-cell block. Because the PE microarchitecture is highly regular, bit-slice-structured, and dominated by arithmetic datapaths with predictable routing patterns, it benefits strongly from transistor-level optimization. A dedicated physical-design team can fold adders, compressors, and alignment logic into tightly packed custom tiles, share diffusion and poly across adjacent slices, size devices with finer granularity than permitted by standard-cell libraries, and use lower-metal routing layers that are normally inaccessible to automated tools. Across modern logic processes, such structured full-custom datapaths consistently achieve approximately 1.8×-2.3× the transistor packing density of an equivalent standard-cell implementation, with aggressive optimization enabling up to ~2.5× where local regularity is especially strong. SHAPE enables ALL of the chiplet area to be PEs, with no analog, bond pads, PLLSs, etc. In combination, CREST enables extremely high yield even with otherwise unworkable defect densities, due to multiple levels of fine-grained fault tolerance.

Because the ZettaLith PE is instantiated millions of times per chiplet, this density improvement compounds to a significant increase in performance and power efficiency relative to a standard-cell approach, while preserving margin at high clock frequencies on advanced nodes.

### W4A8 Multiply-Accumulate Arithmetic

This section defines the internal numerical format used by every Processing Element (PE) in the ZSLD of ZettaLith.

ZettaLith adopts W4A8 arithmetic:
Weights: FP4 with E2M1 (2-bit exponent, 1-bit mantissa)
Activations: FP8 with E3M4 (3-bit exponent, 4-bit mantissa)
Products: Re-quantized FP8 E3M4 (rounded, saturated)
Accumulation: FP8 E3M4 (rounded) using fused add pipeline

The goal is to achieve inference-only numerical stability without QAT, maintain 15 GHz operation, and preserve the CREST+SHAPE advantage of early, extremely high-defect-density nodes.

W4A8 is aggressively low-precision relative to FP16/FP8 baselines, but the ZettaLith PE is designed for deterministic statistical behaviour, unbiased rounding, and scale alignment that together make W4A8 suitable for trillion-parameter LLM inference.

### Exact Multiply Expression

Before quantization, the exact product is:

$$\begin{matrix}{p}_{exact} & = w \cdot a \\ & = [ {s}_{w} \cdot {2}^{{e}_{W} - {B}_{2}} \cdot ( 1 + \frac{{m}_{w}}{2} ) ] \cdot [ {s}_{a} \cdot {2}^{{e}_{a} - {B}_{3}} \cdot ( 1 + \frac{{m}_{a}}{16} ) ] \\ & = {s}_{w} {s}_{a} \cdot {2}^{( {e}_{W} - {B}_{2} ) + ( {e}_{a} - {B}_{3} )} \cdot ( 1 + \frac{{m}_{w}}{2} ) ( 1 + \frac{{m}_{a}}{16} )\end{matrix} .$$

Let:

$${s}_{p} = sign ( {p}_{exact} ) ,$$

$$y = \vert {p}_{exact} \vert .$$

### Exponent Alignment (Critical for Stability)

To prevent saturation and maintain an unbiased product distribution, ZettaLith uses weight-downshifted alignment:

$$𝔼 [ {e}_{w} - {B}_{2} ] = 𝔼 [ {e}_{a} - {B}_{3} ] - 1.$$

This shifts typical weight magnitudes down by one exponent interval, ensuring:
the product exponent (e_{w}−B₂)+(eₐ−B₃) remains centred in the FP8 exponent range,
the probability of FP8 overflow is minimized,
no QAT is required,
CREST can safely assume fixed quantization behaviour regardless of defect patterns.

This alignment is applied per-channel during model import.

### Normalization to FP8(E3M4)

A normalized FP8 product requires:

### Unbiased Exponent

$$E = ⌊ {log}_{2} y ⌋ .$$

### Clamped FP8 Exponent Field

$${e}_{p} = clip ( E + {B}_{3} , {e}_{min} , {e}_{max} ) .$$

### Normalized Magnitude

$$z = \frac{y}{{2}^{{e}_{p} - {B}_{3}}} , z ∈ [ 1 , 2 ) .$$

### Mantissa Pre-Quantization Term

$$t = z - 1.$$

### Rounding (Required) vs Truncation (Not Recommended)

### Truncation

$${m}_{p}^{trunc} = clip ( ⌊ 16 t ⌋ , 0 , 15 ) .$$

Truncation introduces a systematic negative bias of approximately −0.5/16 on the mantissa. Across hundreds of transformer layers, this bias accumulates and materially affects model stability.

### Round-to-Nearest (Chosen for ZettaLith)

$${m}_{p}^{round} = ( ⌊ 16 t + \frac{1}{2} ⌋ , 0 , 15 ) .$$

### Final Quantized Product

$$Q ( {p}_{exact} ) = {s}_{p} \cdot {2}^{{e}_{p} - {B}_{3}} \cdot ( 1 + \frac{{m}_{p}^{round}}{16} ) .$$

### Round-to-Nearest Yields:

unbiased product distributions,
better layer-to-layer stability,
improved robustness for post-training quantized models,
no need for QAT.

This simple, single-cycle mantissa rounding also fits within the ZettaLith 15 GHz PE pipeline.

### FP8 Accumulation Strategy

The PE uses a fused FP8(E3M4) adder:

$${S}_{k + 1} = Q ( {S}_{k} + {p}_{k} ) .$$

Accumulation is rounded in the same manner as the product. A single internal guard bit is used to prevent catastrophic cancellation from small FP8 additions.

No conversion to integer formats occurs inside the PE, avoiding large carry-lookahead adders and preserving the speed/frequency target.

### Why W4A8 is Suitable for ZettaLith

CREST masks logic defects at rates far beyond what any GPU architecture can tolerate. W4A8's small multiplier and adder footprints further reduce the probability that any single fault knocks out an entire PE. A first embodiment ZettaLith could target TSMC A10, but this pre-production node is not assumed. The tables in this document assume TSMC A14.

SHAPE removes all analog/PLL/pad-driver constraints, allowing full-custom digital-only PE logic using libraries that are not yet production-qualified. W4A8 arithmetic keeps that logic dense, regular, and hand-tunable.

The exponent alignment and rounding rule give stable behaviour even when quantizing FP16/FP32 models. This removes an entire training pass from customers.

A W4A8 tensor uses 33% less bandwidth than FP8×FP8 and over 5× less than FP16×FP16. This matches ZettaLith's memory-to-compute ratio.

### PE Circuit-Level Microarchitecture

### W4A8 Multiply-Accumulate Engine at 15 GHz Target

This section describes the circuit-level organization of the ZettaLith Processing Element (PE) implementing the W4A8 arithmetic defined in Section 24. The PE is designed as an ultra-compact, highly regular, defect-tolerant, full-custom block that maintains timing closure at 15 GHz on SHAPE-configured early-node silicon.

Each PE executes the fused operation:

$${S}_{k + 1} = Q ( {S}_{k} + Q ( {w}_{k} \times {a}_{k} ) )$$

with both quantization steps performed in the FP8(E3M4) format described previously.

### Overview of Signal Flow

The PE datapath consists of the following stages:

### Input Decode (W4 and A8)

Extract sign/exponent/mantissa fields.
Bias-correct exponents.
Form small-format mantissas in fixed-point.

### Exponent Path (Aligned Addition)

Compute Eₚ=(e_{w}−B₂)+(eₐ−B₃).
Downshift weights by fixed alignment constant.
Forward exponent with saturation prediction flags.

### Mantissa Multiply Path

Multiply (1+m_w/2)×(1+m_a/16) using 5×6-bit fixed-point multiplier.
Normalize via LZD (leading-zero detector).

### FP8 Product Normalization+Rounding

Select exponent eₚ.
Generate normalized mantissa (5 bits internal).
Round-to-nearest-even to 4 bits (E3M4).
Saturate if exponent out of range.

### Accumulator Add Path (FP8 Adder)

Align exponents.
Sum mantissas with 1 guard bit.
Normalize, round, and saturate to FP8(E3M4).

### Pipeline Register

Single latch stage enables 15 GHz closure.

### Pipeline Structure and 15 GHz Timing

ZettaLith PE uses one internal pipeline register between “mantissa multiply” and “FP8 rounder/accumulator”. Stages:

$$Decode + Exponent Add + Mantissa Multiply$$

target <60 ps
multiplier is the slowest element
uses skew-balanced clock tree

$$Normalize + FP 8 Round + Accumulate$$

target <60 ps
requires careful retiming of saturate logic

Total: ~120 ps of logic for a 2-stage pipe, yielding 16.6 GHz headroom with typical conditions.

### Leakage Mitigation:

power collapse domains per CASCADE columns of 32 PEs
full custom transistor sizing
adaptive body bias optional on advanced nodes

Table 10 shows the transistor count of each block of the PE, both in full CMOS implementations, and an optimized hybrid pass transistor implementation used for ZettaLith.

TABLE 10
FP4 PE transistor count (W4A8, FP8 partial sums)

| | CMOS style | |
|---|---|---|
| | Full CMOS | Hybrid Pass |
| Item | Transistors | Transistors |

Latches

| | | |
|---|---|---|
| 4-bit weight latch | 48 | 24 |
| 8-bit activation latch | 96 | 48 |
| PE “share” of ABLT | 96 | 48 |
| 8-bit partial sum accumulator | 96 | 48 |
| 8-bit pipeline latch | 96 | 48 |

Multiply (FP4 weights × FP8 Activations)

| | | |
|---|---|---|
| XOR gate (for sign) | 6 | 4 |
| Exponent path (2b × 3b + bias/normalize) | 36 | 24 |
| Mantissa processing and partial product | 20 | 14 |
| Zero/special-case detect; flush-to-zero | 12 | 8 |
| Rounding (GRS) | 30 | 20 |
| Saturation/clamp | 24 | 16 |
| Result selection MUX | 24 | 16 |

Adder (FP8 + FP8)

| | | |
|---|---|---|
| Sign extraction and comparison | 12 | 8 |
| Optimized exponent handling | 50 | 36 |
| Mantissa alignment shifter | 56 | 36 |
| Mantissa addition/subtraction | 88 | 58 |
| Normalization | 78 | 50 |
| Rounding (GRS) | 40 | 28 |
| Exponent adjust and overflow | 76 | 52 |
| Saturation circuit | 70 | 46 |
| Final result encoding | 52 | 36 |

Buffers

| | | |
|---|---|---|
| Weight clock inverter-buffer | 2 | 2 |
| Activation clock inverter-buffer | 2 | 2 |
| Accumulator clock inverter-buffer | 2 | 2 |
| Pipeline clock inverter-buffer | 2 | 2 |
| Total transistors in a PE | 1114 | 676 |
| CASCADE and CREST mechanism | 1216 | 668 |
| Shared by 32 rows in a CASCADE array | 38 | 21 |
| Total transistors apportioned to a PE | 1152 | 697 |

### PE Optimizations

The architectural optimizations and trade-offs include:

The full adders used are CLRCL, used for its 10T design, high speed and suitability for GAAFET process nodes. CLRCL directly uses pass-transistor structures to convey signals, often resulting in fewer intermediate nodes storing charge. Hence, CLRCL can achieve higher speed, provided the pass-transistor network is optimally sized, and threshold drops are mitigated. This requires careful transistor scaling to ensure clean output levels. Alternative well-known 10T alternative designs include 13A and SERF. Newer full adder circuits specifically designed for GAAFET may emerge, and these should also be considered.

There is no direct reset of the accumulator. Reset should not be required for normal operation, but if it is required for testing a zero condition can be flowed down the CASCADE column.

The Activation clock and Accumulation clock are separate, allowing them to be carefully phased to present the multiply result and the partial sum input to the adder simultaneously, almost doubling the effective cycle time.

The accumulator is a D latch. Timing closure would likely be easier if it were an edge triggered flip flop. However, this would add another 48 transistors to the PE, and therefore reduce performance of ZettaLith, so it should be avoided by extensive optimization of the PE.

The circuit is specifically designed for 15 GHz operation, instead of “as fast as possible”. If timing closure can't be achieved at 15 GHz, the operating frequency can be reduced, or additional pipeline registers can be added to the PE. These decisions should be made after optimization, layout and SPICE simulation of the PE, using the PDK appropriate to the node chosen.

Power and ground are directly and independently provided to each CASCADE column of 32 PEs (32,2198 transistors) via a hybrid bond pair and metal stack from the power and ground metal planes of the chip, which have on-chip decoupling capacitance. This is to reduce pattern-sensitive ground-bounce. It is also to make the simulation of a single PE highly representative of every PE. This actually improves the simulated timing of the SPICE simulation, as without this extreme power supply regularity, the SPICE simulation results would need to be derated to accommodate differing power and ground IR droop and inductance variations. With independent power and ground stacks, the SPICE simulation of a CASCADE column hard macro can be used without derating it according to its position in the array.

Connections within PEs are on-chip connections in metal 1 (M1) or metal 2 (M2), typically around 100 nm long. Connections between PEs within an on-chip CASCADE array are also around 100 nm, typically in M1 or M2.

Each transistor in the PE should be optimally sized for PPA.

GAAFET (Gate all around FETs) are assumed. This analysis should be derated if FinFET is used.

A dataflow architecture with wave pipelining is not used due to simulation complexity and noise sensitivity but can be used to improve clock frequency and power consumption at the expense of more difficult design.

### Relevance of a Tiny PE

This PE is very simple and small and is replicated 155 million times on the TRIMERA ZSLD chip. It is worthwhile to extensively optimize this small PE for the latest SOTA process for each technology the CASCADE arrays may be ported to.

As the PE and inter-array CASCADE and CREST mechanism are practical to implement as a hand-tuned full-custom designs, the ZSLD can be implemented very early in the availability of a new SOTA process. It can predate the availability of standard cells, I/O, SRAM, mixed signal SIP as well as through-silicon vias (TSV).

As explained elsewhere, all the hard-to port and complex elements reside in the HILT and BID die. The ZSLD is therefore simple, comprising millions of PEs, ABLTs and inter-array mechanisms and nothing else. Hybrid bonding provides the large number of connections that connect the data storage circuits of the HILT with the calculation arrays of the ZSLD.

TABLE 11
FP4 (W4A8) PE silicon area

| Aspect | Value | Unit |
|---|---|---|
| TSMC N2 standard cell (SC) density | 313 | MTr/mm² |
| Projected TSMC A14 SC density | 379 | MTr/mm² |
| Transistors in a PE | 697 | Tr |
| Minimum SC area | 1.84 | μm² |
| Full custom density improvement over SC | 2.0 | x |
| Optimized full custom area | 0.92 | μm² |
| Total number of PEs in a CASCADE array | 262,656 | PEs |
| Area of a 15 GHz clock domain | 0.242 | mm² |

The silicon area of single PE and an entire CASCADE array is estimated in Table 11. The transistor density that TSMC gives for a process is for high density standard cell. Optimized full custom of a small repeating cell can achieve substantially higher transistor densities.

### Clock Frequency

To run a clock at 15 GHz across an entire wafer is impractical. But this is not what ZettaLith does. The maximum size of a synchronous clock domain in the ZSLD is 0.242 mm², the size of a single CASCADE array. Data transferred between columns of CASCADE arrays is resynchronized using inter-array CASCADE circuits, and the HILT and ABLT circuits. The remainder of the CASCADE array support system runs at 1.875 GHz (one-eighth the CASCADE clock) but can readily be adapted for lower or higher clock rates.

Synchronization between ZSLD chips in TRIMERA stacks is via UCIe 2.0, where each UCIe link has its own clock domain and is also synchronized using FIFOs.

Therefore, 0.242 mm² is the maximum area that the 15 GHz clock skew and jitter is relevant to. This should be readily achieved in the 16 Å node or 14 Å nodes, but this must be determined by post-layout simulation achieving acceptable jitter and skew using the PDK from the chosen foundry and node, e.g. the TSMC A14 PDK.

The phase of the 15 GHz clock can be minutely different for each CASCADE column, to average out the 15 GHz current consumption and essentially eliminate ripple at the clock frequency. With as many as 8,192 independent phases per chip (one per active column) the ripple can be dramatically reduced both locally at the mm scale, and globally across the whole chip. Conveniently, the clock phases can be simply produced by differential gate delays in the ABLTs.

The high clock frequency of the ZettaLith CASCADE arrays is made possible because the FP4 PE is very small, has no branching logic, is not programmable, is in a CASCADE array, is heavily optimized, and has a tiny synchronous clock domain. Around 155 million PEs can be incorporated into the CASCADE arrays of the 143 mm² ZSLD at 15 GHz.

### 15 GHz Clock Feasibility

While 15 GHz may appear ambitious compared to conventional CPUs or GPUs that operate at 3-5 GHz, it's important to note fundamental differences in circuit complexity. Modern CPU cores typically contain 100 million to 500 million transistors with complex control paths and branch prediction. In contrast, CASCADE PEs are tiny, with around a millionth the number of transistors, and execute a fixed multiply-accumulate operation with no branching.

Precedents for operating PEs at or above 15 GHz include:
32-bit adders operating at 16 GHz (Agah et al, 2007), and carry-lookahead adders reaching 16 GHz, both in 65 nm CMOS technology. The 16 GHz carry-lookahead adder utilized low-voltage-swing pass-transistor logic, a specialized circuit technique aimed at minimizing delay that is potentially applicable to this PE.
Baud-rate SerDes transceivers, such as a 12.5 Gb/s design in 65 nm CMOS (Harwood et al, 2007) employ digital FFE and DFE blocks whose arithmetic units (including adders) operate at the line rate (12.5 GHz). Cadence's 224G SerDes PHY IP, which involves extremely high-speed DSP, is designed for TSMC's 3 nm process node.
Analog Devices AD9986 RF DAC/ADC explicitly features a 48-bit Coarse Digital Up Converter (CDUC) NCO (phase accumulator/adder) with a maximum clock rate of 16 GHz.
DDFS MMICs with 9-bit pipelined accumulators operating at clock frequencies around 11.9 GHz to 12.3 GHz. (Yu et al, 2008).

In research environments, examples of 15 GHz PEs extend as far back as 2007, and in CMOS nodes as large as 0.18 μm. As tiny PEs are insignificant fractions of ASICs in advanced CMOS nodes, they are now rarely mentioned in the literature. It is only because ZettaLith has so many of them and relies upon fast tiny PEs as the primary source of high performance, that they are significant in the ZettaLith architecture.

### Design and Timing Closure

Designing digital circuits for operation at 15 GHz requires a holistic approach that extends far beyond standard logic gate implementations. It involves the judicious selection of appropriate logic structures, the strategic application of architectural parallelism and pipelining, highly customized physical layout to mitigate parasitic effects, and the design of robust, high-performance clocking networks. These specialized techniques are essential to harness the speed potential of advanced semiconductor transistors and to overcome the numerous physical challenges encountered at such high frequencies.

To establish timing closure at such a high clock frequency, it is necessary to design, layout, optimize, and simulate the PE using the PDK for the target process (TSMC A14 in this case, but any process can be targeted with appropriate change in PE PPA). Several iterations and refinements will be required.

The isolated 0.242 mm² synchronous domains ensure that clock skew minimization and jitter control remain manageable engineering challenges rather than fundamental physical limitations.

If, despite this, a 15 GHz clock cannot be achieved, one fallback is to simply reduce the clock frequency. This has the disadvantage of proportionally reducing ZettaLith performance but the advantage of also reducing power consumption.

Another fallback is to use dataflow and wave pipelining. A CASCADE column of FP4 PEs is highly suited to a dataflow architecture using wave pipelining. However, dataflow architectures and wave pipelining are more complex, and simulation tools are not well adapted to them. The entire CASCADE column would need to be simulated at the SPICE level, instead of just a single PE. As a dataflow architecture is unlikely to be required, the preferred embodiment employs synchronous clocking.

### Power Dissipation Limited Clock Frequency

The power dissipation of the ZSLD chip is 1,090 Watts, with a power density of 762 W/cm², requiring JETSTREAM cooling.

Power supply IR variations across the chip are minimized by direct metal stacks to each CASCADE column from the power and ground planes of the chip. All chips are supplied with optimized 2-PIC cooling jets irrespective of where they are on the WSSCB, due to the JETSTREAM manifold.

Chips which don't meet 15 GHz can be binned for use in ZettaLiths that operate at lower clock speeds.

While the PE is initially configured for 15 GHz operation, the system is power dissipation limited and can potentially operate at higher clock speeds as faster transistors become available without increasing power dissipation in subsequent CMOS generations. Higher clock frequencies can also be used with supercritical CO₂ jet (JETSCI) cooling.

### FP4 PE Power Consumption Estimate

The power consumption of a single PE in the CASCADE array is estimated in Table 12. In digital CMOS circuits, power consumption is dominated by dynamic switching power. This is governed by the equation P=αCV²f, where a represents the switching activity factor, C is the node capacitance, V is the supply voltage, and f is the operating frequency.

TABLE 12
FP4 (W4A8) PE Power Consumption

| Aspect | Value | Unit |
|---|---|---|
| Transistors in a PE | 697 | Tr |
| Gate capacitance per transistor (TSMC A14) | 0.06 | fF |
| Total gate capacitance | 42 | fF |
| Parasitic capacitance of 100 nm M1 | 0.02 | fF |
| Total local interconnect | 14 | fF |
| Total capacitance of a PE - standard cell | 56 | fF |
| Full custom optimization factor | 2.2 | x |
| Total capacitance of a PE - full custom | 25 | fF |
| Operating voltage | 0.65 | V |
| Operating frequency | 15 | GHz |
| Baseline activity factor | 0.10 | α |
| Sparsity after Top-K sparsification | 90% | |
| Zero weight activity factor | 0.05 | α |
| Average activity factor | 0.055 | α |
| Peak matrix multiply use | 75% | |
| Power of a PE in TSMC A14 | 6.6 | μW |
| Clock driving overhead | 6% | |
| Total power of a PE in TSMC A14 | 7.0 | μW |

### Sparsity

Sparsity in AI transformers refers to the strategic design of network architectures that selectively activates a subset of parameters or connections during processing, thereby reducing computational and memory demands while maintaining or improving overall model performance. (Fuad et al., 2023) provides a survey on sparsity explorations in transformer-based accelerators.

The percentage zero weights used in Table 12 is the worst case of the typical 90%-95% range of sparsity after Top-K sparsification of quantized transformers. ZettaLith hardware automatically uses the natural arbitrary sparsity of a quantized transformer or Top-K sparsified transformer to reduce power, but not to increase performance. The zero weight calculation takes the same time as any other weight.

Using high level sparsity (e.g. by re-organizing weights and activations to create blocks of zero weights, by MoE and other higher level means of skipping large parts of a transformer calculation) can also be used to effectively increase inference speed and reduce inference power. These optimizations are implemented at the high level configuration of the transformer inference, not at the PE level, and do not affect PE design. The sparse FP4 performance is highly circumstantial. It is estimated as a 2:1 ratio between the sparse FP4 performance and the dense FP4 performance, using the conventional approximation for sparse/dense performance used for SOTA GPUs.

### SUMMARY

### The ZettaLith PE:

Implements full W4A8 arithmetic with unbiased rounding
Is designed for 15 GHz on early-node SHAPE silicon
Maintains extreme defect-tolerance due to CREST
Uses ultra-compact full-custom logic with no analog/PLL components
W4A8 shows predictable inference accuracy for large-scale LLMs without QAT
Fits within a two-stage pipeline with timing margin

This PE microarchitecture is the foundation of the TRIMERA stack.

### SHAPE

### SHAPE: Simple Hybrid Array of Processing Elements

SHAPE represents a novel processing architecture wherein an ultra-dense extremely regular array of PEs operating at a high clock frequencies in a logic die is synchronized, managed, and interfaced via a hybrid bonded memory and control die. While the ZSLD operates at 15 GHz, the HILT operates synchronously at 1.875 GHz (⅛^{th} ZSLD frequency) and the Base Interface Die (BID) operates asynchronously at normal CMOS clock frequencies. The BID is used for all standard circuits including complex logic, I/O, analog, and mixed signal circuits. The BID is configured to be re-usable across designs—e.g. the CPU stacks should be able to use identical BIDs.

The HILT die is produced using a CMOS process optimal for low leakage high density logic, mostly operating at 1.875 GHz. Millions of fine-pitch hybrid bonded interconnects directly couple the ZSLD CASCADE arrays to the HILT die. This enables low-latency delivery of activation data to the CASCADE arrays, and collection of complete output sums data from the arrays. The HILT die also provides essential functions such as clock distribution, signal conditioning, power management, and temperature sensing.

The BID hosts all the peripheral logic and complex control circuitry required to drive the TRIMERA stack arrays. The BID also provides essential functions such as clock distribution, signal conditioning, power management, and high-speed 1/O, offloading all complex digital operations from the ZSLD.

This separation of functions provides multiple benefits beyond pure area efficiency. The mainstream process node of the BID is inherently better suited for analog and mixed-signal circuits, offering superior power efficiency, better noise characteristics and lower leakage for I/O functions. Similarly, cells in mainstream nodes benefit from years of optimization for density and reliability, while avoiding the increasing complexity of SRAM implementation in advanced nodes. Through-silicon vias (TSV) are also confined to the mainstream process BID and the HILT die, where they don't consume valuable ZSLD real estate, and don't complicate or delay the ZSLD manufacturing process.

### SHAPE Enables Early Time-To-Market

The SHAPE system achieves time-to-market advantages through its TRIMERA architecture using hybrid bonding. While conventional integrated circuits—even those using advanced packaging techniques—require extensive qualification of complex components such as PLLs, SRAM arrays, standard cell libraries, EDA toolchains, and I/O and ESD structures, SHAPE strategically eliminates these dependencies to enable design and production of chips in advanced nodes before these are available for regular production.

### Production Before Standard Cell Libraries are Available

Traditional semiconductor designs follow digital design flows that require mature standard cell libraries and associated synthesis capabilities—components typically unavailable until 9-12 months after a new process node is defined. SHAPE circumvents this constraint by employing a radically simplified ZSLD design consisting almost exclusively of highly replicated, minimalist processing elements (PEs). These PEs are deliberately architected to be sufficiently simple for manual design by experienced circuit engineers, eliminating dependencies on automated synthesis and standard cell libraries while still leveraging the performance benefits of cutting-edge process technology.

SHAPE's multi-die architecture provides another critical advantage: the BID and HILT are implemented in in production, well-characterized process nodes with established design tools and IP blocks. This approach allows the BID and HILT development and validation to proceed in parallel with—and be completed ahead of—the ZSLD's availability. When the advanced process node becomes production-ready, only the ZSLD requires fabrication using the new technology, while the fully-validated BID and HILT designs can already be production-ready.

### Production Before IP Blocks are Available

By partitioning functionality between the dies in a stack, SHAPE eliminates the need to implement and qualify complex components in the advanced node: high-precision PLLs, I/O structures, SRAM arrays, analog/mixed-signal circuits, bond pads, and TSVs. These components typically require multiple design iterations and extensive characterization in any new process node, often becoming critical path elements for commercial deployment.

### Reduced Design and Verification Cycles

The simplified ZSLD design dramatically reduces design and verification cycles. Rather than synthesizing and validating millions of unique logic paths across a complex SoC, engineers need only optimize a single PE containing a few hundred transistors, replicate it across the die, and add a small amount of full custom inter-array logic. This focused approach accelerates time-to-silicon compared to conventional flows, with verification complexity reduced by several orders of magnitude.

### Reduced Mask Calculation

Further time savings occur during mask preparation. For leading-edge nodes (such as TSMC A16) employing EUV lithography with double patterning, mask set generation represents one of the most computationally intensive and iterative aspects of tape-out, typically requiring 2-3 months from initial data preparation to production-ready masks. The highly regular, replicated structure of the ZSLD significantly reduces computational complexity for optical proximity correction (OPC), verification, and hotspot detection compared to conventional designs with diverse structures and varying pattern densities across the die.

### Combined TTM Advantage

These combined advantages enable SHAPE designs to commence high-volume production immediately when a new process node reaches initial production capability, providing a time-to-market advantage of 12-18 months compared to conventional design approaches. This acceleration provides substantial competitive advantage in high-performance computing and AI markets, where computational efficiency directly translates to customer value and market leadership.

SHAPE can reduce TTM substantially compared to a SoC. SHAPE allows the use of TSMC A10 for volume production in a first embodiment, even though TSMC A10 is only scheduled for risk production in 2028. SHAPE can potentially utilize TSMC's A10 node a year or two ahead of its volume production schedule.

Compatibility of a Pre-Designed BID with a New ZSLD

The only specific design requirement imposed by SHAPE on the ZSLD die is the external connections of the CASCADE arrays, and the exact (x,y) tiling pitch of the arrays. Provided that the CASCADE array circuit interface and tiling dimensions are maintained, variations in the PEs circuit or layout between the already finalized HILT and a new pre-production SOTA process can be accommodated by the metal wiring within the unit cell of the ZSLD.

In contrast, even a tiny deviation in tiling pitch will accumulate across the array, leading to cumulative wiring skew between ZSLD unit cells that would make the wiring of each cell different, thereby invalidating the SPICE simulation of a unit cell, and invalidate a hard-macro repetition of the cell across the chip.

If the new SOTA process is used to reduce power and increase speed at the same area, then the TRIMERA array can take full advantage of a next generation CMOS process extremely early, without redesigning the HILT die or the BID.

### Multi-Generation Strategic Importance of SHAPE's TTM Advantage

The faster Time-To-Market (TTM) enabled by the SHAPE architecture is a significant practical outcome of the design. In the AI hardware field, performance improvements are rapidly adopted, making the ability to utilize the latest semiconductor process nodes 12-18 months earlier than conventional System-on-Chip (SoC) development cycles highly relevant. Consequently, systems incorporating ZettaLith's architecture can realize the performance-per-watt and performance-per-dollar benefits inherent in a new process technology substantially sooner than would otherwise be possible using standard design methodologies.

### Matrix Multiplication

The concept of systolic arrays was introduced by H. T. Kung and C. E. Leiserson in 1978. Their seminal work (Kung et al., 1978) was the first to describe systolic architectures for VLSI—an array of simple processing elements that rhythmically compute and pass data to neighbors. This laid the foundation for using systolic arrays as a cost-effective high-performance design for specialized computations in hardware.

### Systolic Arrays in AI and Transformer Inference

Decades later, systolic arrays became vital in AI accelerators. A prime example is Google's Tensor Processing Unit (TPU). The first-generation TPU (Jouppi et al., 2017) was built for neural network inference and featured a 256×256 systolic array of 8-bit multipliers (65,536 MACs) as its heart. This matrix-multiply unit achieved ~92 TeraOps/s and demonstrated the advantage of systolic dataflow for deep learning workloads. The TPU's success—providing better latency and energy-efficiency for DNN inference than general CPUs/GPUs—was a seminal deployment of systolic arrays in AI hardware.

Given the rapid development of Transformer-focused hardware, comprehensive reviews have emerged. (Kachris, 2025) provides a recent survey of hardware accelerators for LLM transformers, with an emphasis on systolic-array-based designs and other specialized architectures.

### ZettaLith: Very Large Arrays

ZettaLith extends the performance advantages of systolic arrays through:
Specialization for W4A8;
SHAPE ultra-dense simple PEs;
CASCADE column-oriented architecture;
TRIMERA chip stack optimization;
CREST fault tolerance; and
WSSCB integration.

ZettaLith implements 156 TRIMERA chip-stacks each with 592 CASCADE arrays of 196,608 PEs for a total of 24,209,522,688 simultaneously operating PEs in an all-silicon domain.

### CASCADE

ZettaLith implements CASCADE (Column-Array Systolic Computation with Accumulation During Execution) for matrix multiplication through a large column-oriented array architecture. This approach differs significantly from traditional systolic array implementations, optimizing for on-chip computation without inter-chip partial sum transfers, while enabling the CREST real-time redundancy system.

Though organizationally distinct, the design maintains mathematical equivalence to conventional systolic multiplication while eliminating partial sum transfers and activation fill skew and while offering superior fault tolerance for large arrays.

### Final Summation of CASCADE Arrays

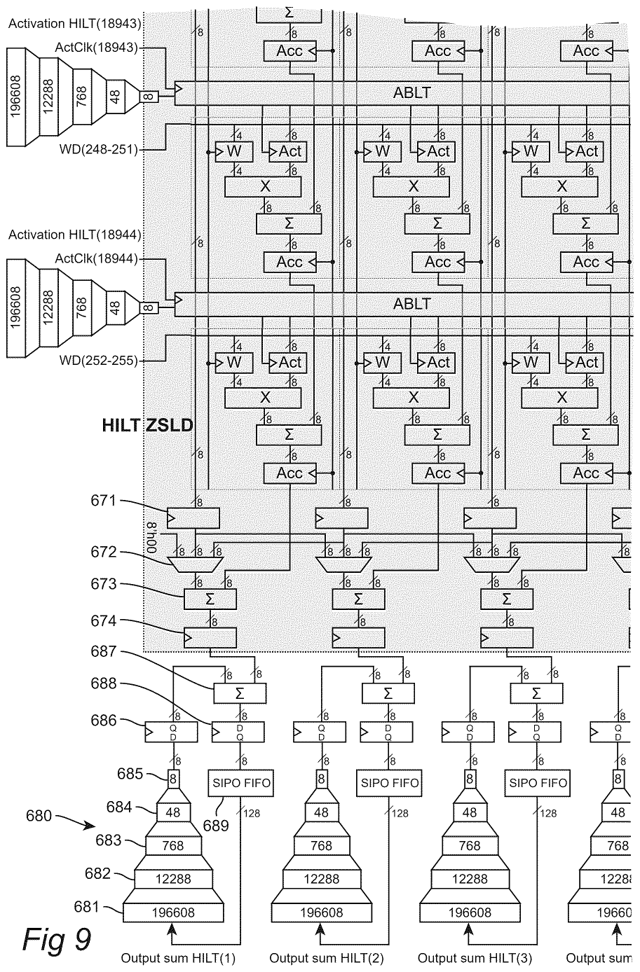

FIG. 9 shows a block diagram of the end of the CASCADE arrays. The last two rows of the 18,944 rows of the CASCADE arrays are shown for context. The previous array column segment latches 671, CREST multiplexers 672, CASCADE array adders 673, and current array column segment latches 674 of the last CASCADE array are also shown.

There is one output sum HILT memory 680 for each of the 8,192 columns of the CASCADE arrays on the TRIMERA stacks. The output sum HILT memory comprises:
output sum HILT stage 1 681 with 196,608 tri-state latches, each storing one bit of the B×L 8-bit output sum;
output sum HILT stage 2 682 with 12,288 latches with tri-state outputs forming 16:1 multiplexers;
output sum HILT stage 3 683 with 768 latches with tri-state outputs forming 16:1 multiplexers;
output sum HILT stage 4 684 with 48 latches with tri-state outputs forming 8:1 multiplexers; and
output sum HILT stage 5 685 with 8 latches interfacing with the recirculating sum mechanism 686, 687, and 688 on the ZSLD.

The final adder stage adds the results of the CASCADE calculations for the columns to the existing contents of the output sum HILT memories. If the CASCADE calculation is the first pass of a transformer matrix multiply involving biases, then the biases for the batches can be loaded into the output sum HILTs and these will be automatically added to the final sum. On subsequent passes, the sums for each batch are accumulated in the output sum HILTs. The output sum accumulation mechanism comprises reading the output sum HILTs as described above, and:
latching the stored value in the output sum read latch 686;
adding the current CASCADE column sum using the output sum recirculating adder 687;
latching the result in output sum write latch 688; and
converting the calculation frequency from the ZSLD frequency to the HILT frequency using the output sum write SIPO FIFO 689.

The recirculating sum mechanism 686, 687, and 688 can be in either the ZSLD or the HILT. For consistency with the remainder of the PE array, the recirculating sum mechanism 686, 687, and 688 are preferably in the HILT instead of the ZSLD. The older process of the HILT should be taken into account, and the speed of the mechanism may need to be reduced with a concomitant increase in parallelism. That is, it may need to be demuxed by a factor of two, with half the clock speed. This is straightforward and a reduction of speed and increase of parallelism has the small advantage of also reducing the final stages of the output sum HILT 680 and the FIFO 689.

### CASCADE Step-by-Step Computational Process

The following are the steps of the calculation of large matrix multiplications using the ZettaLith implementation of CASCADE system on a single TRIMERA chip stack. In this case, 18,944 batches (and/or input tokens) of an array of 24,576 activations×8,192 columns is being calculated in 25,244 clock cycles (1.68 μs). This time is used to read 465,567,744 activations from activation HILT, perform 7,627,861,917,696 FLOPs, and write the sums to the output sums HILT. As 25,244 clock cycles would normally be enough for 7,835,194,753,024 FLOPs, this matrix multiplication operates at 97.35% efficiency. Each of the 18,944 batches (and/or input tokens) in a TRIMERA stack is calculated simultaneously, offset by one clock. Also, each of the 156 TRIMERA stacks in a ZettaLith can perform matrix multiplies of this size simultaneously.

Clock 1: CASCADE array 1 and 2 both start on clock 1, as their sum in the CASCADE inter-array mechanism is aligned. Subsequent CASCADE arrays start on subsequent clocks, i.e. CASCADE array 3 starts on clock 2 through to CASCADE array 3,198 which starts in clock 383. This is because their sums in the CASCADE inter-array mechanism are sequential.

Clocks 1 to 17 are used to load B(1-8) A(1)—activations(1)—from HILT memory. This has a latency of 16 clocks, but a throughput of 16 billion activations per second. That is, B(1)A(1) is available on clock 17, but subsequent batches of A(1) are available on subsequent clocks of the CASCADE array from the activation HILT(1). Simultaneously in overlapping access cycles, B(1)A(2) is available on clock 18 from activation HILT(8), and subsequent batches of A(2) are available on subsequent clocks. Every 8 clocks, the activation HILTs read a new set of 8 batches of activations until all 18,944 batches in HILT are read. (Note: “batches” are actually B×L—a combination of batch size and token length).

Clocks 18 to 24 are used to broadcast (A1) to all 8,192 columns of the CASCADE array using the ABLT (FIG. 8). A(2) is broadcast on the next clock to row 2, and subsequent activations are broadcast on subsequent clocks. The ABLT is a pipeline, so new results are available to each of the 8,192 columns every clock. The total rate of activations for a single TRIMERA ZSLD is 8,192 columns×18,944 rows×15 GHz=2,327,838,720,000,000,000 activations per second.

Clock 25 is the first clock of computation. Row 1 of CASCADE columns 1 to 8,192 multiply A(1) by the weights for each column—W(1,1) to W(1,8192).

Clock 26 is the second clock of computation. Row 2 of CASCADE columns 1 to 8,192 multiply A(2) by the weights for each column—W(2,1) to W(2,8192) and accumulate the result with the results of A(1)W(1,1) to A(1)W(1,8192).

This continues until Clock 88, the last calculation of the first CASCADE array. Row 32 of CASCADE columns 1 to 8,192 multiply A(32) by the weights for each column −W(32,1) to W(32,8192) and accumulate the result with the ongoing sums for column 1: ΣA(1)W(1,1) . . . A(63)W(63,1) through to column 8,192: ΣA(1)W(1,8192) . . . A(63)W(63,8192).

Clock 89 adds the accumulation of one CASCADE array with the next CASCADE array which was being calculated simultaneously. Thus, at clock 89, the calculation wave for batch 1 gives the 8,192 column sums ΣA(1)W(1,1) . . . A(128)W(128,1) through to ΣA(1)W(1,8192) . . . A(128)W(128,8192). The calculation wave for batch 2 is proceeding is one clock behind.

On clock 472 batch 1 is complete, with the 8,192 column sums being: ΣA(1)W(1,1) . . . A(119832)W(24576,1) through to ΣA(1)W(1,8192) . . . A(24576)W(24576,8192). The FP8 results from each column are then added to the accumulated sums in the output sums HILTs (or biases if it is a first pass calculation) and written back to the output sums HILT at a 1 GHz rate, after being expanded to 128 bits wide by a SIPO FIFO.

On clock 473 batch 2 is complete.

On clock 33,240, all 18,944 batches are complete.

By clock 25,244 the last of the 18,944 batches has been written to output sums HILT.

Of course, it is not necessary to calculate all 18,944 batches of 18,944 activations ×8,192 columns each time. Control circuitry is to be included to allow appropriate subsets of the maximum calculation.

### Parallel Adder Tree Alternative

The partial sums from each CASCADE array are added sequentially. If they were added in parallel using an adder tree, the entire computation would be complete in 24,662 clock cycles, resulting in 99.65% efficiency. However, this would complicate chip layout, with each successive pair of additions being over greater physical distances. Pattern dependent ground bounce would also be exacerbated. At 15 GHz clock frequency, such complications could lead to significant difficulties. Therefore, CASCADE uses sequential additions, at the expense of 2.3% efficiency.

### Summary of CASCADE Technique

The CASCADE mechanism occurs across two chips in the TRIMERA stack—the ZSLD for computation and storage of weights, and the HILT die for storage of batches of activations and output sums. Some characteristics include:

Column Oriented: Each column of the output is calculated independently, with no cross-column calculation except for CREST nearest neighbor multiplexing every 32 rows.

Weight-Stationary Design: The entire weight matrix of 155,189,248 FP4 weights is preloaded into the array before computation begins and remains unchanged during the calculation of a batch.

Direct Weight Loading: Weight loading occurs asynchronously directly from HBM without requiring intermediate cache storage.

Parallel Partial Sum Propagation: After multiplication with stored weights, partial sums propagate vertically down each column independently.

For arrays up to 18,944 rows (activations), or batches less than 18,944 the partial sums do not need to be transferred from chip to chip, only the completed sums from the 8,192 columns.

Broadcast Activation Flow: Unlike conventional horizontal activation pipeline flow, a single FP8 activation value enters simultaneously at the PEs of all 8,208 (8,192 plus 16 spares) columns. While this is a little more complex in hardware than “systolically pumping” the activations from left to right through the array, it is worth the extra hardware complexity to avoid the delay in activation availability, and the complexity of skewed data.

The activation broadcast is accomplished via a 8-level fan-out tree of latches, distributing one activation value across all columns each clock cycle. The 18,944 batches of 18,944 activations are entered into all columns simultaneously at the 15 GHz CASCADE array clock frequency, using 18,944 activation HILTs and 18,944 ABLTs. The broadcast latch tree, shown in Table 13, is used instead of a bus, even though the simpler bus structure would be functionally equivalent. A bus would result in significant (and insurmountable, in TSMC A14) propagation delay, IR drop, fan-out and ground bounce difficulties operating at the ZSLD's 15 GHz clock frequency.

TABLE 13
Activations HILT and Activation Broadcast Latch Tree (ABLT)

| | | | | | | Clock |
|---|---|---|---|---|---|---|
| Clock | Phase | Activations | Spare | Bits | Fanout | gen. |
| 1-3 | Read MUX | 24,576 | 1 | 196,608 | 0.0625 | 1 |
| 4-7 | Read MUX | 1,536 | 1 | 12,288 | 0.0625 | 1 |
| 8-11 | Read MUX | 96 | 1 | 768 | 0.0625 | 1 |
| 12-15 | Read MUX | 6 | 1 | 48 | 0.1667 | 1 |
| 16 | HILT to | 1 | 1 | 8 | 1.00 | 1 |
| | ZSLD | | | | | |
| 17 | Broadcast | 2 | 1 | 8 | 2.00 | 2 |
| 18 | Broadcast | 4 | 1 | 16 | 2.25 | 4 |
| 19 | Broadcast | 8 | 1 | 36 | 3.67 | 9 |
| 20 | Broadcast | 32 | 1 | 132 | 3.91 | 33 |
| 21 | Broadcast | 128 | 1 | 516 | 3.98 | 129 |
| 22 | Broadcast | 512 | 1 | 2,052 | 4.00 | 513 |
| 23 | Broadcast | 2,048 | 4 | 8,208 | 4.00 | 2,052 |
| 24 | PE | 8,192 | 16 | 32,832 | Within | 8,208 |
| | | | | | PEs | |

### Advantages of CASCADE

This full-array column-oriented approach offers critical advantages:

Simplified Accumulation: Final results accumulate automatically without complex sharding of submatrices and stitching accumulation processes.

Minimized Inter-Chip Communication: In most circumstances, no partial sums need to be transferred between chips during computation. This dramatically reduces chip-to-chip bandwidth requirements compared to traditional architectures.

Reduced Output Bandwidth: With only complete sums output after 25,244 cycles, the output data rate is vastly lower than systems that must transfer partial sums.

Memory Efficiency: Weights reside directly within the CASCADE array, eliminating the need for duplicate weight storage in cache SRAMs. Weights are loaded into the CASCADE arrays asynchronously using the HBM4 data paths or transferred between TRIMERA stacks at 39 TB/s.

Superior Fault Tolerance: With no cross-column communication, the CREST redundancy system can independently validate and substitute spare CASCADE columns for any detected faults, maintaining computational throughput despite silicon defects.

### CASCADE Rows, Columns and Arrays Tradeoff

The number of active PEs on a TRIMERA stack is the product of the 32 rows in a CASCADE array, the 8,192 active columns in a CASCADE array, and the 592 CASCADE arrays in a TRIMERA ZSLD. There is a significant degree of flexibility in choosing these numbers.

The number of rows in a CASCADE array stack primarily affects the ZSLD chip layout and the effectiveness of the CREST mechanism. Increasing the number of rows in a CASCADE array reduces the number of CASCADE inter-array mechanisms but reduces the level of fault-tolerance provided by CREST and makes the ZSLD physical layout more sensitive to chip dimensions.

Increasing the number of active CASCADE columns proportionally reduces the number of CASCADE rows, given a constant number of PEs available on the ZSLD. It also proportionally increases the number of output sum HILT memories and reduces the number of activation HILT memories.

Increasing the number of CASCADE arrays on the chip requires either a decrease in the number of rows or the number of columns in each array, with appropriate changes in the number of activation HILTs and output sum HILTS.

There is a broad fitness peak for these three values, so they can be optimized together with relatively little consequence.

### ZettaLith Aggregation of TRIMERA Stacks

While a single TRIMERA stack is optimized for 8,192 columns, there are 156 TRIMERA stacks in a ZettaLith, allowing for up to 1,277,952 columns to be calculated simultaneously, without requiring transfer of partial sums. The entire ZettaLith enables batches of 18,944 activations×24,576 rows×8,192 columns×156 TRIMERAs (594,973,229,580,288 FLOPs) to be calculated in 25,244 clock cycles (HILT to HILT) at 97.35% efficiency.

### CPUs (Control/Host)

The role of CPUs in ZettaLith is primarily supportive. In a first-generation system, the CASCADE arrays deliver orders of magnitude higher compute performance than any feasible CPU implementation. As a result, CPUs are not configured to provide high FLOPs but instead to handle orchestration, control logic, and tasks that cannot be parallelized. The required performance level is therefore “adequate” rather than maximized.

### Two Classes of CPU

Two classes of CPUs are foreseen. The first are integrated CPU stacks mounted directly on the WSSCB. Each of these stacks provides data fabric connectivity up to 39 TB/s into TRIMERA stacks, with a combined bandwidth of 624 TB/s across 16 CPUs. This level of coupling ensures that CPU instructions, DMA scheduling, graph control, and runtime orchestration can be executed with minimal latency. The second class are external CPUs, connected via PCIe 6.0 (2 TB/s aggregate). These provide additional flexibility for system management, networking, and external storage access, but with much lower effective bandwidth to the accelerator fabric. External CPUs will often be the choice of the system integrator, companies such as Dell, HPE, Supermicro, Lenovo, Gigabyte, ASUS, Lenovo, IBM, QCT, Inspur, Cisco and Fujitsu. This section therefore concentrates on the CPU stacks within the ZettaLith single silicon domain.

### ZettaLith CPU Stacks

For CPU implementation, ZettaLith can accommodate standard ARM cores, RISC-V cores, or OEM-specific architectures. CPUs may be fabricated as single dies or as multi-chip stacks. A stacked configuration using the TRIMERA BID as a base offers a practical path, as the BID already integrates HBM4 interfaces and UCIe links. This approach reduces design time and preserves compatibility with the data fabric. In such a configuration, cache SRAM can be provided either on a dedicated die bonded to the BID or integrated directly into the CPU die itself. In the latter case, TSVs and back-to-back bonding would be required in the CPU chiplet.

### ARM Neoverse

ARM Neoverse V3 is identified as a strong candidate for ZettaLith's CPUs. V3 provides higher IPC, an improved branch and memory subsystem, and extensions such as SVE2 and SME-2, which align with preprocessing and graph management workloads. The expected availability of V3 within an 18-24-month horizon matches the feasible earliest ZettaLith tape-out timeline. While ARM cores entail licensing costs, their mature ecosystem, software stack support, and strong foundry links (notably with TSMC and Samsung) outweigh the cost disadvantages. RISC-V remains a plausible alternative, particularly for OEMs with in-house design teams or higher sensitivity to unit cost, but would require greater software investment.

### Workload

In workload terms, the 16 CPUs are responsible for orchestration of 156 TRIMERA AI stacks per “GPU” domain equivalent. This includes preprocessing, postprocessing, runtime graph scheduling, DMA control, and housekeeping. These are latency-sensitive but not FLOP-intensive workloads, making ARM Neoverse cores suitable. Ensuring readiness is critical: CPUs should not become the rate-determining component in system deployment.

Additional design considerations include coherency and DMA policies optimized for accelerator traffic, RAS (Reliability, Availability, Serviceability) features such as ECC and error containment, and PCIe/CXL support for future memory pooling. In ZettaLith configurations, CPUs are provisioned with maximum-height HBM4 stacks. This memory is used for KV caches, extended reasoning contexts, parameters for small and mid-size inactive models, large user documents, and hosting frequently accessed Model Context Protocol (MCP) servers. By co-locating MCP services such as Wikipedia mirrors, company databases, or symbolic math engines directly within CPU memory, ZettaLith reduces latency for context retrieval and external data access.

In summary, CPUs in ZettaLith are not configured as primary compute engines but as orchestration and system management units. The integration of high-bandwidth WSSCB CPUs, complemented by external CPUs for storage and networking, ensures balanced functionality. The ARM Neoverse V3 platform currently represents the most practical implementation path, balancing time-to-market, ecosystem support, and performance against cost.

### CPU HBM

In the recommended ZettaLith configuration, the TRIMERA stacks use minimum height HBM4 stacks, but the CPU stacks use maximum height HBM4 stacks. There are many applications for the larger memory of the CPU stacks:
KV caches;
Reasoning model contexts;
Parameters of transformers that are not in current use, but may be needed faster than they can be loaded from SSD;
Video and images being generated by ZettaLith;
Large user documents and query histories—for example, code bases, PDFs, image and video inputs, etc.; and
Space for running relatively large user-requested programs (such as simulations) locally.

### Model Context Protocol (MCP)

MCP provides a common way to expose external tools and data to agentic software. For ZettaLith deployments, MCP servers are appropriate for frequently accessed corpora and services whose interfaces benefit from a stable, typed contract—for example: a local, frequently refreshed Wikipedia snapshot without full edit histories; organization-specific databases; 3D graphics pipelines (e.g., Blender); symbolic mathematics (e.g., Mathematica); and engineering solvers (e.g., ANSYS-class). Frequently used MCP servers may be hosted directly “in-rack” on ZettaLith to minimize latency and maximize bandwidth between compute and tool endpoints.

However, MCP integration strategy materially affects efficiency and accuracy. Direct TOOL CALL patterns that preload many server tool definitions into the model's context and shuttle each intermediate result through the LLM can dramatically increase token consumption, latency, and error risk at scale. Anthropic's engineering guidance (Jones et al, 2025) emphasizes that tool definitions and intermediate results can overload context windows as MCP usage scales, and recommends treating MCP servers as code APIs the agent calls from a secure execution environment. In their side-by-side analysis, loading only the definitions needed for the current task and operating on intermediate data outside the context window reduced token usage from ~150,000 to ~2,000 tokens (~98.7% savings), with corresponding improvements in cost and responsiveness.

Accordingly, ZettaLith positions MCP as a discovery and transport layer, with agents interacting through code execution rather than direct TOOL CALL. Concretely:
Progressive disclosure of tool contracts—Agents enumerate MCP servers and read only the minimal metadata or specific function files required for the task, instead of preloading entire catalogs into context.
Context-efficient results handling—Bulk data (transcripts, spreadsheets, meshes, simulation fields) is filtered, transformed, and joined within the execution environment; only succinct summaries or required fields are returned to the model.
Robust control flow in code—Iteration, conditionals, retries, batching, and error handling execute in the sandbox, reducing “token-loop” orchestration overhead and time-to-first-token.
Privacy and governance—Sensitive fields can be tokenized or redacted within the harness so raw PII flows between MCP tools without entering model context, enabling deterministic data-flow policies.
State and skills—Agents persist intermediate artifacts and reusable routines (“skills”) on a filesystem, compounding efficiency across sessions.

ZettaLith deployment guidance therefore adopts “MCP via code execution” as the default pattern. Direct TOOL CALL remains cost effective for small toolsets and interactive diagnostics, but is discouraged for production agent paths involving large catalogs or high-volume intermediates.

### PCIe 6.0 Links

The 16 CPU chips in ZettaLith provide 16 PCIe 6.0 links from the CPUs to SSD storage, external servers, and the Internet. Each PCIe 6.0 link has 16 lanes of 8 GB/s for a total bandwidth of 2 TB/s (16 Tb/s). These PCIe 6.0 links are provided by UCIe 2.0 to PCIe 6.0 conversion chiplets on boards connected to the underside of the WSSCB at the array vertical (Y axis) edges.

During typical transformer inference, this bandwidth is unused. High bandwidth is required to load parameters when rapidly switching to transformers which are not loaded into HBM, and to load large user contexts which are not stored on ZettaLith. Since ZettaLith has enough HBM for 20 trillion parameters (5 trillion in low cost system), it can hold multiple different trillion parameter LLMs in memory simultaneously, thereby not normally requiring any PCIe 6.0 bandwidth to switch between transformers.

### CPU Cache SRAM Die

The Cache SRAM die may be implemented as a conventional SRAM cache chiplet co-designed with the CPU die using face-to-face hybrid bonding.

Alternatively, it may employ a new architecture—Sea of SRAM, analogous in concept to the Sea of Gates used in early semi-custom integrated circuits.

### Sea of SRAM

Sea of SRAM is a two-die construct in which a dedicated SRAM die provides a dense array of small, high-speed SRAM blocks (for example, 32 word×32 bit tiles), while the face-to-face bonded CPU die supplies configuration, power delivery, and signal routing through its upper metal layers.

Each SRAM tile exports uncommitted data, address, control, and power terminals to hybrid-bond pads at sub-10 μm pitch.

During integration, the CPU die's top metal permanently links selected terminals to form higher-order structures—such as wide or deep SRAM macros, multi-ported banks, FIFOs, lookup tables, working memory, microcode stores, or program memory—without any configuration circuitry on the SRAM die itself.

### Physical Structure and Interconnect

Each SRAM tile includes local periphery sized for its native word/bit dimensions, with dedicated terminals for word-line and bit-line drivers, sense amplifiers, control, and optional error-check pins.

A typical direct tile-to-tile signal path:
ascends the Sea-of-SRAM die metal stack from a node of the first SRAM tile,
crosses to the CPU die through hybrid bonds,
traverses a few microns in the CPU die's top metal,
returns to the Sea-of-SRAM die through hybrid bonds, and
descends the Sea-of-SRAM die metal stack to a node of the second SRAM tile.

With appropriate drive sizing and optional repeaters or buffers on the CPU side, the incremental RC delay of these short hops keeps end-to-end propagation within the sub-nanosecond regime for typical macro sizes.

Higher speed and lower power than monolithic SRAMs are achieved by enabling only the tile required for each access and multiplexing its output.

### Active Interconnect

To combine small tiles into larger SRAM structures, address decoders, buffers, and related logic are implemented on the CPU die.

In this case, signals from the SRAM tile outputs:
ascend the Sea-of-SRAM die metal stack,
cross to the CPU die through hybrid bonds, and
traverse the CPU metal stack to the SRAM peripheral logic or buffers on the CPU die.
The outputs from the CPU-side peripheral logic or buffers then:
traverse the CPU metal stack to the destination pad,
cross from the CPU die to the Sea-of-SRAM die through hybrid bonds, and
descend the Sea-of-SRAM die metal stack to the SRAM tile inputs.

This “active interconnect” approach allows the CPU die to define address decoding, bank selection, and output-mux structures dynamically at design time. By contrast, the Sea-of-SRAM die is not modified during the CPU stack design. It is an extremely simple standardized array and may be a standard product or a fixed design from a previous generation.

### Why Small Tiles

Conventional large SRAM macros incur power and latency penalties from millimeter-scale word lines and bit lines.

In the Sea-of-SRAM architecture, 32-word-deep tiles shorten internal lines by over an order of magnitude relative to monolithic arrays, reducing line capacitance and switching energy for the dominant read/write operations.

When stitched into larger logical macros via short top-metal runs, the total switched capacitance remains well below that of a single-die array of equal capacity, enabling lower dynamic power at comparable or higher frequency.

The trade-off is a modest area increase due to replicated local periphery (address logic and sense amplifiers) and inclusion of multiplexers on the CPU die in place of long bit lines.

However, multiple tiles may be passively connected into larger arrays before periphery circuits are added, minimizing overhead while retaining flexibility.

### Power Delivery and Leakage Control

Power is provisioned per tile through CPU-top-metal VDD/VSS links.

Unused tiles omit these connections and remain completely unpowered, reducing leakage in unallocated regions to zero.

Active regions employ a gridded power topology in the CPU metal, local decoupling on the CPU die, and disciplined current-return routing to manage IR drop and mitigate supply bounce during burst activity.

### Clocking and Timing Closure

Stitched macros may be synchronous or quasi-asynchronous.

For synchronous operation, the CPU die distributes a low-skew clock to stitched regions with optional local deskew or re-timing elements.

For wider stitched structures, the CPU side may insert pipeline registers or bit-slice repeaters at predetermined stitch lengths to maintain cycle time.

Macro-generation rules should constrain maximum stitch span, fan-out per tile output, and mux depth to guarantee deterministic timing closure.

### Error Control, Test, and Repair

Tiles include ECC or parity option pins.

Logical macros may aggregate these for per-line ECC (SECDED) or stronger protection.

A scan/MBIST access ring on the CPU die sequences through tiles, enabling March tests, disturb and retention checks without adding logic to the SRAM die.

Spare tiles and redundancy logic on the CPU die can be invoked at package test to remap around defective tiles, improving effective yield.

### Capacity, Bandwidth, and Porting

Because configuration resides on the CPU die, designers can instantiate macros with unconventional aspect ratios (for example, extremely wide and shallow memories), interleave banks for higher concurrency, or create multi-ported logical memories through time-multiplexing and banked topologies.

For transformer-class or similar workloads, this enables large, low-latency key-value caches and activation buffers located adjacent to compute, with bandwidth bounded mainly by the number of stitched banks and CPU-side connection width.

### Thermal and Floor Planning

Stacking increases thermal density. In ZettaLith systems, this effect is minor: JETSTREAM or JETSCI cooling is already scaled for the much higher power density of TRIMERA stacks. ZettaLith CPU stacks operate at substantially lower power and are therefore effectively over-cooled, leaving sufficient margin that hot CPU cores over hot Sea-of-SRAM tiles will be effectively cooled.

### Use in ZettaLith and Other Applications

Within ZettaLith, Sea-of-SRAM can implement L1.5/L2-class caches, model KV stores, routing tables, and microcode storage optimized for the selected CPU cores and targeted model architectures.

Beyond ZettaLith, the same fabric applies to network processors (deep buffers), GPU-class pipelines (tile caches and descriptor stores), and FPGA-style fabrics (BRAM-like resources with higher density and lower dynamic power).

### Performance and Efficiency Expectations

Relative to equivalently sized monolithic SRAM blocks, stitched macros built from small tiles reduce active switching energy by lowering word-line and bit-line capacitance while adding only modest top-metal and bond-path overhead.

In representative configurations with stitch distances of tens of micrometers and controlled fan-out, access latency remains competitive with single-die macros at equivalent clock targets while providing superior leakage control and SKU-specific macro shaping.

The small tiles of the Sea-of-SRAM allow bit lines and word lines as short as 32 unit cells when sense amplifiers are repeated and outputs are multiplexed, instead of being extended passively through long lines.

This yields extremely fast operation (from short lines) and very low power (only one 32×32 tile accessed per operation).

As more tiles are passively connected, total access delay rises while CPU-die area consumption falls, allowing an adjustable speed-versus-area trade-off determined by the die bonded to the standardized Sea-of-SRAM die.

For example, 64 of the 32×32 tiles may be passively connected to form a 2 K×32 SRAM with a single set of address logic, sense amplifiers, and output buffers—a balanced configuration between the fastest, lowest-power but highest-area fully multiplexed 32×32 tiles, and the slower, higher-power, more area-efficient larger passive arrays.

### Summary of Sea-of-SRAM

Sea-of-SRAM decouples memory density from configuration complexity.

Its fine-grain tiling, passive composition through CPU-side metal, and selective activation of tiles combine the speed of local SRAM with the configurability of semi-custom logic, enabling per-product optimization of latency, power, and area while maintaining a single, manufacturable SRAM die for all ZettaLith variants.

### Data Fabric

### ZettaLink—ZettaLith Data Fabric

ZettaLink is the ultra-dense, short-range electrical interconnect fabric used within the Wafer-Scale Silicon Circuit Board (WSSCB) and the Panel-Scale Glass Circuit Board (PSGCB) configurations of ZettaLith.

It forms the primary intra-board data-fabric layer, linking the base interface dies (BIDs) of all TRIMERA compute stacks across the wafer or panel.

ZettaLink is a purely electrical, ultra-short-reach, multi-plane copper interconnect implemented in the redistribution layers of the WSSCB or PSGCB. It operates at millimeter scale, using UCIe-class differential channels, and provides aggregate bandwidth and energy efficiency far exceeding what is achievable with optical methods at this range.

### Physical Structure

RDL Stack: ZettaLink uses approximately five stacked RDL planes, three signal planes and two ground planes between them. Each signal plane carries parallel copper conductors with a wire pitch of 1 wire/μm for a total of 3 wires/μm.

Length: Individual ZettaLink channels are typically <2 mm long—far shorter than the optical break-even distance.

Channel Count: The number of electrical connections is extremely high—9,750 of UCIe 2.0-class channels per stack pair—yielding chip-to-chip bandwidth of 320,000 GT/sec (39 TB/s) per adjacent TRIMERA pair.

Signal Format: Differential low-swing electrical signaling compatible with UCIe 2.0 and sub-picojoule-per-bit energy operation.

### ZettaLink Specifics

Table 14 shows the number of lanes and bandwidth of ZettaLith TRIMERA data fabric links.

The ZettaLith data fabric is a 2D asymmetric mesh with 39 TB/s chip-to-chip bandwidth in the vertical direction, and 6 TB/s chip-to-chip bandwidth in the horizontal direction, As ZettaLith is not a general purpose machine, there is no attempt to generalize the data fabric to an any-to-any configuration that maximizes flexibility. Instead, the data fabric is configured for the maximum usefulness for transformer inference within the constraints of the WSSCB, the TRIMERA chips, and UCIe 2.0 connections.

The vertical connections between TRIMERA chips is chosen to be the higher bandwidth connection because the horizontal connections are interrupted by the HBM4 links, and these horizontal data fabric connections need to be routed around the TRIMERA-HBM4 links in the WSSCB. The vertical connections are not interrupted by the HBM interface. For simplicity, they are identical parallel 1.4 mm USR wires.

TABLE 14
ZettaLink bandwidth and power

| | Value | Units |
|---|---|---|
| ZettaLink common characteristics | | |
| UCIe 2.0 bandwidth per lane | 32 | GT/s/lane |
| Microbump pitch | 20 | μm |
| Microbumps per lane | 4 | μbumps |
| Energy per bit transferred | 0.3 | pJ/bit |
| Power per UCIe 2.0 lane | 9.6 | mW |
| Vertical ZettaLinks | | |
| Rows of microbumps | 60 | μbumps |
| Width of rows of UCIe 2.0 bumps | 1.2 | mm |
| Horizontal (x) chip width | 13 | mm |
| Microbumps per vertical UCIe 2.0 link | 39,000 | μbumps |
| Wire density | 3 | wires/μm |
| Length of wires (all parallel, same length) | 1.4 | mm |
| Lanes per vertical (y) link | 9,750 | lanes |
| Total vertical ZettaLink power per BID | 94 | Watts |
| Bandwidth per vertical link | 312,000 | GT/s |
| Bandwidth per vertical link in TB/s | 39 | TB/s |
| Horizontal ZettaLinks | | |
| Vertical chip width allocated to ZettaLink | 2.2 | mm |
| Columns of microbumps | 50 | μbumps |
| Total microbumps per horizontal (x) ZettaLink | 5,500 | μbumps |
| Lanes per horizontal link | 1,375 | lanes |
| Length of wires | 13 | mm |
| Total horizontal ZettaLink power per BID | 13 | Watts |
| Bandwidth per horizontal link | 44,000 | GT/s |
| Bandwidth per horizontal link in TB/s | 6 | TB/s |
| ZettaLith totals | | |
| Number of vertical (y) links in a ZettaLith | 196 | links |
| Total ZettaLink vertical bandwidth | 7,644 | TB/s |
| Number of horizontal (x) links in a ZettaLith | 154 | links |
| Total ZettaLink horizontal bandwidth | 847 | TB/s |
| Peak ZettaLink power consumption | 20.4 | kW |
| Total ZettaLink bandwidth | 8,491 | TB/s |

UCIE 2.0 has a data transfer rate of 32 GT/s/lane. To achieve the 39 TB/s chip-to-chip bandwidth, 9,750 lanes are required. As each lane requires 4 wires, there are 39,000 wires between vertically adjacent TRIMERA stacks. As the TRIMERA stacks are 13 mm wide, the wire density of the vertical fabric links is 3 wires per m. The number of RDL layers required in the WSSCB depends on the WSSCB wiring pitch. For example, if the pitch is 1 m, then a minimum of 5 RDL layers are required (3 for wiring, 2 for ground planes). WSSCB processing is based on TSMC CoWoS-S, where this wiring pitch is readily achievable. The 4 μm pitch commonly associated with CoWoS is for CoWoS-R.

The wiring between vertically adjacent TRIMERA chips is extremely simple: 39,000 parallel wires each 1.4 mm long between matching pairs of bumps in the BIDs of adjacent TRIMERAs. Only a few lanes of wires need to be routed and simulated, then those few wires can be replicated along the top and bottom edges of the BID footprints in the WSSCB.

The highest bandwidth requirement is the transfer of activations and output sums between adjacent TRIMERAs when calculating arrays larger than 18,944 activations in ×8,192 activations out. In this case, vertically adjacent TRIMERA stacks should be used for calculating adjacent sections of the large matrix, so the data transfers can be done simultaneously at 39 TB/s per TRIMERA stack pair.

The UCIe 2.0 interfaces are in the BID, nominally implemented using the TSMC N7 node or equivalent. UCIe 2.0 Intellectual Property (IP) blocks are available for the TSMC N7 node, eliminating the need for custom interface design.

### Inter-ZettaLith Connections

In a connected design, ZettaLith can provide 32 channels of 800 gigabit Ethernet (GbE) connection to the outside world, with a total bandwidth of 25.6 Tb/s (3.2 TB/s). This is provided by converting mesh links at the left and right edges of the WSSCB array from the UCIe 2.0 to 800 GbE.

None of this Ethernet bandwidth is used in the transformer calculations described here: these are optional connections if transformer systems of more than 20 trillion parameters are to be inferenced. A ZettaLith can operate at the specifications described here in stand-alone configuration with no GbE connections. In comparison, GPUs may provide substantial GbE bandwidth, but the majority of this is used internally by the GPU cluster to transfer partial sums, so it is not available for external connectivity.

For applications where more inter-ZettaLith data bandwidth than can be provided by 800 GbE is required, optical communications can be used, for example the TeraPHY™ 8 Tb/s optical I/O chiplets and SuperNova™ multi-wavelength laser modules recently announced by Ayar labs. These optical modules connect by UCIe, so the ZettaLith data fabric is already suited for the TeraPHY system. However, 78 of the 1 TB/s TeraPHY chiplets would be required to extend each of the 39 TB/s vertical data fabric links from intra-ZettaLith to inter-ZettaLith while maintaining the full bandwidth. This would require 1,560 TeraPHY optical chiplets per ZettaLith. This illustrates how fast the TRIMERA chip-to-chip data fabric on the WSSCB is.

If it is certain that ZettaLiths will not be connected together at high bandwidth, all these Ethernet connections can be eliminated from the ZettaLith design to save manufacturing cost, design time, and complexity. Any external connectivity can then be provided by the PCIe 6.0 interfaces.

A first generation ZettaLith may omit the 800 GbE interfaces to reduce TTM. This document assumes that ZettaLith has no 800 GbE connections.

### Hybrid Bond Manufacturability

The ZSLD-HILT interface includes around two million hybrid bonds, as shown in Table 15. The hybrid bond pitch of 7.1 μm is above TSMC's projected minimum of 3.0 μm for the A16 and later nodes.

To achieve a very even power and ground distribution over the entire ZSLD chip, 787,968 of the hybrid bonds are power and ground. This minimizes the differences between PEs resulting from their position on the die, reducing the IR droop and ground bounce margins required and simplifying simulation.

Although backside power distribution will be available for the A16 and A16 nodes, it is not used for the ZSLD chip as the backside of the die has DRIE silicon heat-sink fines etched into it.

TABLE 15
Hybrid bonds

| | Value | Notes |
|---|---|---|
| General | | |
| CASCADE Array rows | 32 | Rows |
| CASCADE Array columns | 8,208 | Columns (including spares) |
| PEs in a CASCADE Array | 262,656 | PEs |
| Weight bits | 4 | FP4 |
| Activation and Partial sum bits | 8 | FP8 |
| Hybrid bonds per CASCADE array | | |
| Weights write data bus | 128 | Weight data bus to PEs |
| Weight write enables | 2,052 | Decoder is in HILT |
| Activations in | 256 | Broadcast activations input |
| CREST multiplexers write data bus | 32 | Control of the CREST multiplexers |
| CREST multiplexers address decoder | 11 | CREST address decoder and write enable |
| Weight, activation, sum clocks | 6 | High frequency clock distribution |
| Ground | 1,026 | Ground return paths |
| Power | 1,026 | Power delivery to CASCADE arrays |

Total hybrid bonds between the ZSLD and HILT chips

| | | |
|---|---|---|
| Total bonds for a CASCADE array | 4,537 | For a single CASCADE array |
| CASCADE Arrays | 592 | Arrays |
| Total bonds for all CASCADE arrays | 2,685,904 | Hybrid bonds for all arrays |
| Column partial sums/biases input | 65,664 | Bias or partial sum inputs for final sum |
| Column sums output | 65,664 | Sum outputs from last CASCADE array |
| Total hybrid bonds per ZSLD-HILT | 2,817,232 | Face to face hybrid bonds |
| TRIMERA bond die areas | 143,000,000 | μm² each |
| Required hybrid bond pitch | 7.1 | μm |
| Minimum hybrid bond pitch for 2027 | 3.0 | μm |
| Status | OK | Hybrid bond pitch is manufacturable |

### Power Supply

### ZettaLith Power Supply Units (PSU)

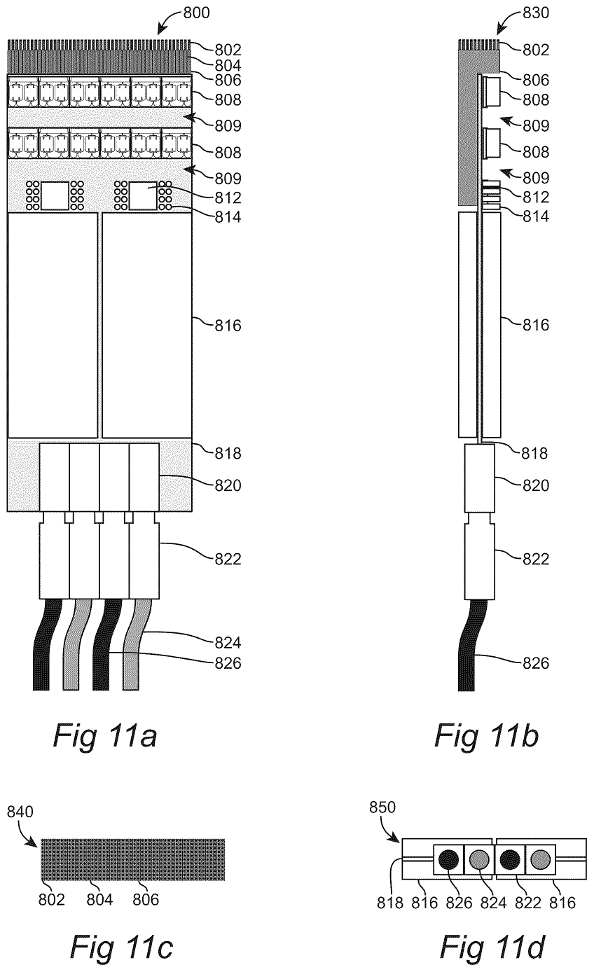

FIG. 11a shows a top view of a ZettaLith PSU PCB 800. The copper wire CGA columns 802 connect the PSU PCB 800 to the WSSCB. The busbars 806 are separated by 50 μm thick polyimide film insulation 804. Each PSU printed circuit board 818 contains 30×TDM2534×T power modules 808, 4×XDPE132G5C multiphase controllers 812, passive components 814, and 4×48 VDC to 6 VDC fixed ratio converters 816. Power is connected by 48 VDC power socket 820 and 48 VDC power plug 822, with the power cables comprising a 48 VDC positive wire 824 and a 48 VDC ground wire 826. Channels 809 allow pumped sCO₂ to flow between rows of power modules.

FIG. 11b shows a side view of a ZettaLith PSU PCB 830 showing the same components as the top view.

FIG. 11c shows an end view of a ZettaLith PSU PCB 840 from the WSSCB end. The copper wire CGA columns 802 connect the PSU PCB to the WSSCB. The power and ground busbars 806 are separated by 50 μm thick polyimide film insulation 804.

FIG. 11d shows an end view of a ZettaLith PSU PCB 850. From this view, the 48 VDC to 6 VDC fixed ratio converters 816 are visible, as is the PSU printed circuit board 818. The 48 VDC power plug 822 shows the 48 VDC positive wires 824 and the 48 VDC ground wires 826.

### Busbars and Lack of High Current Connectors

The power and ground busbars, and the various power busbars, are insulated from each other by 50 μm thick polyimide film. The ground busbars are 0.945 mm thick copper sheets accurately cut (wire EDM is recommended) into “L” shapes as shown in FIG. 11b. Copper sheet which is accurately rolled to 0.945 mm thick is used so that when stacked with 50 μm polyimide film, the thickness equals the 1 mm spacing of the CGA columns, allowing 5 μm for adhesive.

The inside long edge of the L shape is chamfered to around 0.5 mm before it is reflow-soldered to the PSU PCBs so that there is no short circuit between the power and ground busbars. The power busbars are like the ground busbars, except the power busbars may be divided into multiple sub-busbars, each separated by 0.95 mm wide polyimide strips.

A custom busbar and connection system is required, as there are no commercially available solutions able to handle the high current and low-stress connections to a silicon wafer that are required. The PSU CGA pillars are soldered directly to the WSSB.

There is no plug and socket used, so the PSUs are not field replaceable. The reason that they are soldered to the WSSCB is that a standard connector able to handle the required current is far bulkier than the space available, and a connector designed to fit the space available would be a major source of failure.

### Characteristics of the ZettaLith PSUs

Table 16 shows the basic characteristics of the precision power supply units (PSU) powering the ZettaLith and directly attached to the WSSCB. There are 86 PSUs each supplying 2 TRIMERAs. Each PSU supplies 2,307 Watts, in various power domains. Most of the power is for the 24,210 million active FP4 PEs, at 0.65 Volts. 1.1 Volts is used for much of the I/O such as UCIe 2.0 and the HBM4 interface, as well as for the HBM4 stacks themselves.

TABLE 16
ZettaLith power supply units (PSU)

| Aspect | Value | Unit |
|---|---|---|
| ZettaLith TRIMERAs supplied | 2 | TRIMERAs |
| Number of PSUs | 86 | PSUs |
| Active ZettaLith power per PSU | 2,307 | Watts |
| Max design current per PSU | 3,846 | Amps |
| Interface width | 48 | mm |
| Interface height | 11 | mm |
| Interface area | 528 | mm² |
| CGA spacing | 1 | mm |
| CGA columns | 528 | columns |
| CGA Ground columns | 264 | columns |
| CGA Power columns | 260 | columns |
| CGA Signal columns | 4 | columns |
| XDPE132G5C Multiphase controllers | 4 | chips |
| Multiphase controller phases | 16 | phases |
| Min. TDM2534xT power modules | 25 | modules |
| Actual TDM2534xT power modules | 30 | modules |
| Power modules in a ZettaLith | 2,580 | modules |
| Max Distance of TDM2534xT to ZSLD | 38 | mm |
| Current of power modules | 160 | Amps |
| Rows of power modules | 5 | rows |
| Length of power modules | 6 | mm |
| Length of power module section of PCB | 30 | mm |
| Input voltage | 48 | Volts |
| Input current | 48 | Amps |
| Intermediate voltage | 6 | Volts |
| Intermediate current | 385 | Amps |
| HSC-IBC 8:1 converter power | 750 | Watts |
| HSC-IBC 8:1 converter modules | 4 | modules |
| PSU efficiency | 89% | |
| 48 VDC input power of PSU | 2,809 | Watts |
| TRIMERA decoupling capacitance | 158 | μF |
| ZSLD decoupling capacitance | 57 | pF |

This example PSU uses the Infineon XDPE132G5C multiphase controller, and the Infineon TLVR TDM2534×T power modules for extremely fast transient response. There is a total of 2,580 TDM2534×T power modules, in the 86 PSUs connected to the WSSCB. Each of the 2,580 regulator modules are less than 38 mm from the active silicon that it powers. That distance is mostly through solid copper busbars.

The PSU is controlled by using the Power Management Bus (PMBus).

### Power IR Losses

Table 17 shows Voltage drop and parasitic power losses of the ZSLD power supply power connections to the CMOS load on the ZSLD, and back again to the PSU PCB ground. This is the flow of positive holes—the electrons flow the other way.

Most of the voltage drop and power dissipation is in the PSU power and ground rails, as these are much longer than any other part of the interface.

TABLE 17
Parasitic power losses of a TRIMERA stack between PSU power and ground

| | Structure | | | | | | |
|---|---|---|---|---|---|---|---|
| | | | | | | | Current |
| | Quantity | Current | Resistance | Voltage | Power | Total | Density |
| | Units | | | | | | |
| | | mA | mΩ | mV | μW | W | A/cm² |
| PSU rails solder | 60 | 32,051 | 0.001 | 0.028 | 904 | 0.054 | 2,137 |
| PSU rails | 60 | 32,051 | 0.35 | 11.316 | 362,692 | 21.761 | 2,131 |
| CGA wires | 28,210 | 68.17 | 10.56 | 0.720 | 49.1 | 1.385 | 1,356 |
| CGA solder | 130 | 14,793 | 0.001 | 0.012 | 180 | 0.023 | 4,598 |
| WSSCB TSVs | 130 | 14,793 | 0.04 | 0.578 | 8,548 | 1.111 | 4,598 |
| WSSCB RDL | 13,000 | 147.93 | 3.15 | 0.465 | 69 | 0.895 | 65,746 |
| μbump solder | 264,000 | 7.28 | 0.35 | 0.003 | 0.019 | 0.005 | 6,441 |
| μbump CU pillar | 264,000 | 7.28 | 2.25 | 0.016 | 0.12 | 0.032 | 9,275 |
| BID metal stack | 264,000 | 7.28 | 12.48 | 0.091 | 0.7 | 0.175 | 45,527 |
| BID TSVs | 88,000 | 21.85 | 90.15 | 1.970 | 43.0 | 3.788 | 111,297 |
| HILT TSVs | 88,000 | 21.85 | 90.15 | 1.970 | 43.0 | 3.788 | 111,297 |
| HILT m. stack | 607,392 | 3.17 | 199.66 | 0.632 | 2.00 | 1.216 | 316,612 |
| ZSLD RDL | 607,392 | 3.17 | 44.25 | 0.140 | 0.444 | 0.269 | 7,915 |
| ZSLD metal stack | 607,392 | 3.17 | 199.66 | 0.632 | 2.00 | 1.216 | 316,612 |

▴ Power connection chain
▮ Active load of CASCADE arrays in TRIMERA ZSLD
▾ Ground connection chain (reverse of power connection chain, but wider)

| | | | | | | | |
|---|---|---|---|---|---|---|---|
| ZSLD metal stack | 607,392 | 3.17 | 199.66 | 0.632 | 2.001 | 1.216 | 316,612 |
| ZSLD RDL | 607,392 | 3.17 | 44.25 | 0.140 | 0.4436 | 0.269 | 7,915 |
| HILT m. stack | 607,392 | 3.17 | 199.66 | 0.632 | 2.001 | 1.216 | 316,612 |
| HILT TSVs | 176,000 | 10.93 | 90.15 | 0.985 | 10.8 | 1.894 | 55,649 |
| BID TSVs | 176,000 | 10.93 | 90.15 | 0.985 | 10.8 | 1.894 | 55,649 |
| BID metal stack | 528,000 | 3.64 | 12.48 | 0.045 | 0.17 | 0.087 | 22,764 |
| μbump CU pillar | 528,000 | 3.64 | 2.25 | 0.008 | 0.03 | 0.016 | 4,637 |
| μbump solder | 528,000 | 3.64 | 0.35 | 0.001 | 0.005 | 0.002 | 3,220 |
| WSSCB RDL | 13,200 | 145.69 | 3.15 | 0.458 | 66.8 | 0.882 | 64,750 |
| WSSCB TSVs | 132 | 14,569 | 0.04 | 0.569 | 8,291 | 1.094 | 4,529 |
| CGA solder | 132 | 14,569 | 0.00 | 0.012 | 174 | 0.023 | 4,529 |
| CGA wires | 28,644 | 67.14 | 10.56 | 0.709 | 47.6 | 1.364 | 1,336 |
| PSU rails | 12 | 160,256 | 0.12 | 18.860 | 3,022,430 | 36.269 | 3,552 |
| PSU rails solder | 12 | 160,256 | 0.000 | 0.014 | 2,260 | 0.027 | 1,068 |

| | | |
|---|---|---|
| TRIMERA Total | 43 mV | 82.0 Watts |
| ZettaLith Total | 43 mV | 14.1 kW |

The columns of this table are:
Structure: this is the type of structure that the current flows through at this point in the connection chain.
Quantity: this is the number of those structures that the current flows through in parallel for each ZSLD.
Current: this is the current through each of those structures in mA.
Resistance: this is the resistance of the structure, in mΩ, considering the resistivity of the material and the length and area of the structure.
Voltage: this is the voltage drop across the structure, in mV.
Power: this is the parasitic power loss of the structure, in μW.
Total: this is the total parasitic power loss of all the structures of this type in a single ZSLD, in Watts.
Current Density: This is the current density in the structure, in A/cm². It is relevant for checking current density for potential electromigration problems.

The structures through which the current flows on the path from the PSU positive voltage to ground are:
PSU rails solder: this is the soldered interface between the PCB and the solid copper rails carrying power to the WSSCB.
PSU rails: these are the solid copper rails carrying power to the WSSCB.
CGA wires: these each of the 217 copper wires forming a wire bundle that comprises the CGA columns.
CGA solder: this is the solder interface between the CGA columns and plating on top of the TSVs in the WSSCB.
SCB TSVs: these are the TSVs in the WSSCB. The WSSCB is nearly full thickness silicon, and the TSVs are thick copper columns through the silicon matching the 1 mm pitch of the CGA columns.
SCB RDL: these are the metallization columns through the RDL of the WSSCB.
μbump solder: this is the thin solder layer joining the copper pillars of the microbumps to the landing pads on the front surface of the WSSCB.
μbump CU pillar: These are the copper pillars of the microbumps. They are formed on the undersurface of the BID, with one Cu pillar per WSSCB TSV.
BID metal stack: this is the conventional metal stack of the mainstream CMOS BID wafer. Many metal columns are formed in the metal stack for each TSV, allowing routing between the columns.
BID TSVs: these are the short and thin standard TSVs of the Base Interface die. As this is an active CMOS chip, TSVs consume area otherwise used for logic, so the total area % of TSVs is constrained.
HILT TSVs: these are the short and thin standard TSVs of the HILT die. The BID and HILT wafers are back-to-back hybrid bonded, so a compliant redistribution layer (RDL) will be needed over the TSVs to prevent the thermal expansion of the entire copper TSV columns from interrupting the hybrid bonding process. Due to the RDLs, the TSVs of the HILT and BID wafers do not need to match (and may be required to anti-match, depending on the compliance of the RDLs).
HILT metal stack: this is the normal metallization stack for power from HILT TSVs to the top level metallization of the HILT wafer which is hybrid bonded to the ZSLD wafer.
ZSLD RDL: this is the redistribution layer of the ZSLD. TSMC a16 process has a thick RDL as the standard top layers. These RDLs also include decoupling capacitance.
ZSLD metal stack: this is the normal metallization stack for power from the redistribution layer to the CMOS of the ZSLD. To maintain exact hard macro configuration for small groups of PEs, there are separate identical a power and ground stacks leading from the power and ground planes of the metallization down to those small groups of PEs.

The power then reaches the CMOS transistors of the CASCADE arrays in the TRIMERA ZSLD, the active load where the power is to be delivered. The power dissipated by the CASCADE arrays is not a parasitic power loss, so it is not included in the total.

Power then returns to the ground of the PSU via the ground connection chain, which is essentially the reverse of the power connection chain. The number of ground connections is often greater than the number of power connections to reduce ground bounce.

Most of the voltage drop and power dissipation is in the PSU power and ground rails, as these are much longer than any other part of the interface.

A parasitic power loss of 14.1 kW in power distribution may seem excessive, but this is only 7.1% of the total ZettaLith power of 198 kW. Most of the power loss is in the busbars of the PSUs, and this may be reduced without changing the ZettaLith WSSCB or any attached chip stacks.

### Electromigration

The Current Density column of Table 17 shows the current density through each structure in A/cm². All the structures are made of copper except those identified as solder. The maximum current density for copper before electromigration is generally considered to be a problem is 10⁶ to 10⁷ A/cm². All the copper structures have current densities of less than 10⁶ A/cm², so are below the threshold for the onset of electromigration.

Solder has an electromigration threshold of only around 10⁴ A/cm². The various solder connections are below this threshold.

Electromigration for the entire ZSLD die is easy to calculate due to its SHAPE architecture. All CASCADE array columns are identical.

### ZettaLith Extreme Current Density and PSU PCB Attachment

A fundamental challenge for ZettaLith implementation is delivering around 287,000 Amps of precisely regulated fast response power to the computational elements.

### CGA Columns

Conventional CGA columns made of solder represent a critical failure point that would render the entire system non-functional, as they could catastrophically fail (melt) under ZettaLith's extreme current densities. This power delivery bottleneck represented a potential “showstopper” that could have invalidated the entire ZettaLith architecture.

The solution is a novel CGA column design comprising 217 fine copper wires in a hex-close pack configuration. Each 80 μm diameter wire contributes to a robust 640 μm copper column that simultaneously provides:
low resistance and low voltage drop of 0.25 mV;
total power loss of all CGA columns of only 0.33 W;
highs current-carrying capacity without electromigration failure;
thermal-mechanical compliance to accommodate differential expansion;
elimination of elastoplastic deformation common in solder columns; and
sufficient structural integrity for reliable system assembly.

To manufacture these columns, continuous copper wire bundles are induction welded at intervals of approximately 4 mm. These welded sections are then cut through their centers and staked into the busbars. Small holes are drilled in the edge of the busbars where the CGA columns are to go. These holes are plastically enlarged by forcing hardened steel spikes into them, displacing the copper sideways. The CGA column is placed into the expanded copper hole, and the displaced copper is compressed back into place, trapping the CGA columns and forming a conductive path.

The CGA columns are precision-trimmed in a dedicated fixture to ensure accurate length and coplanarity. A high-temperature elastomer applied between the welded sections wicks between the 217 individual wires of a CGA column, preventing solder from later infiltrating the bundle during reflow to the WSSCB—thus preserving the critical wire flexibility required for reliable long-term operation. Basic characteristics of the CGA columns are shown in Table 18.

TABLE 18
CGA column structure

| | Value | Units |
|---|---|---|
| Aspect | | |
| Diameter of CGA column | 640 | μm |
| Copper wire diameter | 80 | μm |
| Hex close pack configuration | | |
| Number of complete rings | 8 | rings |
| Number of copper wires | 217 | wires |

### PSU PCB Attach Process

Each PCB undergoes final inspection and final electrical verification testing of voltage regulation and control systems. Verified PCBs are loaded into a precision-aligned mounting jig that maintains their positions without constraining the CGA columns. The jig assembly is dipped approximately 1 mm into a low-temperature tin-lead solder bath (Sn63/Pb37, melting point 183° C.), applying a controlled amount of solder to all CGA column tips simultaneously. Alternatively, they may be printed with solder paste.

After WSSCB plasma cleaning, the complete PCB array is aligned to the WSSCB, forming all CGA connections simultaneously through low-temperature reflow that protects the attached chips and underfill materials. The 34° C. melting point difference between SAC305 solder used for the PSU PCB assembly and SCB microbumps and the 183° C. tin-lead solders enables reliable attachment with adequate temperature margin. The total amount of lead used is extremely small compared to the entire system, so a RoHS exemption should be readily available.

This assembly sequence reduces populated WSSCB handling, enables PCB inspection and repair before WSSCB attachment, eliminates high-temperature processes, controls solder volume, forms all CGA connections simultaneously, and reduces risk to the high value WSSCB assembly.

The multi-PCB architecture provides distributed power delivery near the point of load, independent voltage regulation zones for WSSCB regions, PCB-level maintenance, redundant power paths through parallel CGA connections, and thermal management through the PCB attachment structure.

### Cooling

### Cooling Requirements

As is typical with modern electronic systems, power supply and the resultant necessary heat dissipation are limiting factors on system performance and size. The ZettaLith system has a very high power density, and the waste heat must be efficiently removed.

ZettaLith's dense integration of computational elements creates significant thermal management challenges, with each ZSLD consuming approximately 1,090 Watts, resulting in a total power dissipation of around 198 kW in an extremely compact volume. The ZSLD TDP of 1,090 Watts is not particularly excessive, as some GPUs and advanced CPUs are already around 1,200 Watts. It is the high power density of 762 W/cm² and wafer-scale arrangement of power dissipating compute stacks that presents the problem.

The extreme heat dissipation is only from the ZSLD dies, which are face-down hybrid bonded at the top of the TRIMERA stacks. Deep heatsink fins are etched into the back of each ZSLD die within 25 microns of the active CMOS. High flow rates of coolant are individually jetted into the heatsink fins of each ZSLD die.

### Cooling Alternatives

ZettaLith systems can be built with a variety of cooling systems with varying levels of performance. From most performant to least performant, cooling options include:

Very high performance systems with power densities between 780 W/cm² and 1,000 W/cm² cooled by Jet Enhanced Thermoregulation using Supercritical CO₂ (sCO₂) immersion jets (JETSCI). This version requires development of the JETSCI system and must reside in sCO₂ pressure vessels. This version is discussed in this document as a high-end alternative to the main “JETSTREAM” version of ZettaLith.

High performance systems with power densities below 780 W/cm² cooled by Two-Phase Immersion Cooling (2-PIC). 2-PIC is already used in data centers. 2-PIC coolant (such as Chemours Opteon 2P50) is jetted at each logic chip stack using JET Surface Thermal Regulation via Evaporative Array Manifold (JETSTREAM). This is the main ZettaLith system described here, largely compatible with the JETSCI version.

Liquid cooled—pumped single phase liquid (usually water). The power density of the TRIMERA ZSLDs is too high, and they are packed too densely, to be water cooled. A water cooled ZettaLith would be limited to a fraction of the performance of the JETSTREAM version. The power supply system would need radical redesign, but since the current would be substantially lower than the JETSTREAM version, this should be feasible. It would also be very difficult to make the WSSCB water cooled, since water is electrically conductive even with a small ionic content. The complex surfaces of the WSSCB would need to be reliably electrically sealed while creating a minimum thermal barrier. A water cooled ZettaLith is not discussed further in this document.

Forced air cooling. With forced air cooling, the all-silicon domain of the WSSCB cannot be used at any significant power density. A forced air cooled system can be created from several hundred ExaLith cards, but this would not retain the WSSCB advantage of an “all-silicon domain” computing. It would require the typical heterogenous hierarchy of Chips-Boards-Backplanes-Servers-Racks-Pods, with high hardware and software complexity, and a large portion of the power and efficiency would be consumed by data transfer over multiple systems.

Traditional cooling solutions such as forced air, direct liquid cooling, or two-phase immersion cooling are inadequate for managing the high thermal density of 762 W/cm² at the TRIMERA stack interfaces. This thermal challenge represents a major limitation in scaling transformer inference capabilities, as conventional cooling approaches cannot maintain acceptable junction temperatures at these power densities. The ability to operate at such high power densities is important for maximizing the ZettaLith performance. To maintain the advantage of all computation being in a single all-silicon domain, the entire 198 kW power required for ZettaLith computation is concentrated in a volume of only around 200 mm×260 mm×2 mm.

### Cooling Systems—JETSTREAM and JETSCI

ZettaLith employs either of two closely related wafer-scale cooling systems: JETSTREAM, which uses a two-phase dielectric liquid (2-PIC), and JETSCI, which uses supercritical carbon dioxide (sCO₂). Both systems use parallel jet-impingement cooling delivered by a precision additively manufactured metal manifold aligned to the wafer-scale compute assembly. These systems maintain nearly uniform thermal conditions across hundreds of high-power semiconductor stacks while minimizing mechanical complexity and eliminating localized overheating.

### 3D-Printed Metal Manifold

The cooling manifold is a single additively manufactured metallic component, typically titanium for maximum chemical stability, stiffness, and long-term reliability. Anodized aluminum or stainless steel alloys may also be suitable, but titanium remains preferred due to inertness to both 2-PIC and sCO₂ coolants, chemical simplicity, and high stiffness.

The manifold is not attached to the wafer-scale assembly but rests with a precisely machined mating surface against the top of the WSSCB holder. When the cooling vessel is closed, the manifold is lightly spring-loaded downward to maintain the nominal nozzle-to-die standoff distance of approximately 1 mm (±0.3 mm). This avoids any mechanical contact with the chips while ensuring repeatable alignment.

The manifold contains two inlet ports located on opposite sides of the structure. The 172 nozzles all face down, jetting coolant onto the chip stacks. The heated coolant (2-PIC vapor or hot sCO₂ respectively) rises from the chip stacks through open gaps in the manifold to the printed circuit heat exchanger (PCHE).

Each nozzle tube incorporates a passive flow-equalization baffle network calculated to achieve uniform flow rate across all 172 nozzles regardless of proximity to the inlet ports. The calculations are simple enough to be performed analytically and verified by CFD.

Each nozzle is aligned to a single semiconductor stack—either a compute TRIMERA stack or CPU stack—so that cooling is performed in strict parallel across the wafer. The nozzle also supplies the HBM stack with coolant, this being a relatively minor extra amount compared to the compute stack power dissipation.

### Die-Level Heat Sink Structure

The backside of each ZSLD compute die includes a deep etched heat-sink array formed by a through-silicon DRIE (Bosch) process. This structure produces a dense array of fins or posts that extend nearly the full wafer thickness—from the original wafer backside to within approximately 25 μm of the active transistor layer. This geometry increases the effective surface area by an order of magnitude and minimizes the thermal path length from the coolant to the active CMOS layer, reducing temperature gradients and enhancing local heat flux capacity. The fins also provide flow stabilization for impinging jets, ensuring uniform wetting and consistent bubble detachment during boiling in JETSTREAM and high turbulence in JETSCI.

### System Performance

Each ZettaLith wafer dissipates around 200 kW of heat from a compute volume of approximately 104,000 mm³, corresponding to a power density of around 2 W/mm³. The parallel jet configuration maintains tight thermal uniformity across all 172 stacks. Both 2-PIC and sCO₂ systems operate passively within the tank without active flow control or moving internal components, relying solely on the manifold's static geometry, the pumps, and gravity-assisted convection. The result is a robust, contamination-resistant, long-lived cooling system with minimal maintenance requirements and no mechanical interfaces to the active silicon.

### 2-PIC JETSTREAM Cooling

JET Surface Thermal Regulation via Evaporative Array Manifold (JETSTREAM) uses two-phase immersion cooling (2-PIC) with individual tuned submerged jets of liquid coolant directed to each logic chip stack on the ZettaLith WSSCB.

In the JETSTREAM system, a dielectric coolant (e.g. Chemours Opteon 2P50) circulates in a non-pressurized closed tank that contains both liquid and vapor phases. The liquid coolant level lies above the jet nozzles but below the printed-circuit heat exchanger (PCHE) positioned near the top of the tank. During operation, each high-velocity jet impinges directly on the backside of a ZSLD die, where it boils upon contact with micro-machined fin arrays. The generated vapor rises through open channels between the stacks and through the manifold's inter-nozzle gaps toward the PCHE. Within the PCHE, the vapor condenses and falls as droplets back into the liquid pool below. The colder, denser liquid descends by natural convection to the tank bottom.

A coolant output port at the base of the tank connects to a triply redundant pump assembly. Each pump possesses at least half of the total required flow capacity. The pumps draw the cooled 2-PIC liquid and return it to the manifold's two inlet ports. Because the system is not pressurized, defective pumps can be hot-swapped without halting ZettaLith operation. The architecture ensures continuous flow even if a single pump fails.

The two-phase regime leverages the enthalpy of vaporization to achieve extremely high heat-flux removal. The local boiling process maintains chip junction temperatures within a narrow tolerance despite high power flux densities across the active wafer area.

TABLE 19
JETSTREAM cooling system

| Aspect | Value | Units |
|---|---|---|
| 2-PIC coolant (Opteon 2P50) pressure | 100 | kPa |
| 2-PIC coolant density (ρ) | 1,456 | kg/m³ |
| 2-PIC coolant specific heat capacity (cp) | 1,090 | J/kg · K |
| 2-PIC coolant thermal conductivity (κ) | 0.07 | W/(m · K) |
| 2-PIC coolant viscosity (μ) | 0.00062 | Pa · s |
| 2-PIC coolant surface tension (γ) | 0.011 | N/m |
| Heat to be removed (Q) | 241,573 | Watts |
| Incoming 2-PIC coolant temperature | 30 | ° C. |
| Outgoing 2-PIC coolant temperature | 49 | ° C. |
| Temperature difference (ΔT) | 19 | ° C. |
| Mass flow rate (\dot{m} = Q/(cp · ΔT)) | 11.66 | kg/s |
| Volume flow rate (\dot{V} = Q/(ρ · cp · ΔT)) | 0.0080 | m³/s |
| Volume flow rate in litres/minute | 481 | litres/min |
| Nozzle width | 11 | mm |
| Nozzle height | 0.5 | mm |
| Nozzle area | 5.5 | mm² |
| Total area of all nozzles (A) | 946 | mm² |
| Nozzle 2-PIC coolant velocity | 8.5 | m/s |
| Discharge coefficient (Cd) | 0.9 | |
| Pressure difference | 64.46 | kPa |
| (ΔP = \dot{m}²/(2ρ · Cd² · A²)) | | |
| 2-PIC coolant cycle time | 10 | seconds |
| 2-PIC coolant required to circulate | 117 | kg |
| 2-PIC coolant in chamber | 133 | kg |
| Pump redundancy | 3 | pumps |
| Pump motor power (each) | 2 | kW |

### Heat Transfer

Table 19 shows various aspects of the ZettaLith JETSTREAM cooling system.

The back-side of the SOTA wafer is patterned with an array of deep channels defining heat-sink fins in silicon. The fins are etched to within approximately 25 m of the CMOS layer to minimize temperature difference through the silicon.

### JETSTREAM Manifold

To achieve the required mass flow rate evenly to each ZSLD or CPU, ZettaLith employs a separate 2-PIC coolant jet interfacing with the silicon heatsink fins etched into the back side of each TRIMERA stack. This enables effective heat removal at the required power densities while maintaining acceptable junction temperatures across the entire WSSCB and its attached chip stacks.

To address potential local temperature non-uniformities across the WSSCB, the system includes a 3D-printed JETSTREAM manifold made of titanium powder fused via laser melting. This manifold is specifically designed to incorporate individually optimized nozzles to jet 2-PIC coolant evenly to each TRIMERA stack.

By jetting a carefully metered flow of 2-PIC coolant to each chip location, the JETSTREAM manifold ensures effectively identical coolant velocities and pressure drops to each TRIMERA stack, irrespective of their position on the WSSCB. As a result, heat removal remains consistent from die to die, avoiding the common problem of some chips receiving less coolant flow, or chips located at trailing edges of coolant flows receiving coolant already heated by chips closer to the coolant inlet, or of some chips being in thermal hot spots.

The uniform distribution of 2-PIC coolant by jets tuned by individual static 3D printed baffles bolsters the ability to operate each ZSLD at the high power densities described in this disclosure, without compromising reliability or performance due to uneven cooling.

Table 20 shows various characteristics of the PCHE.

TABLE 20
2-PIC PCHE heat exchanger

| Aspect | Value | Units |
|---|---|---|
| ZettaLith heat to be removed | 198,411 | Watts |
| PSU heat to be removed | 24,523 | Watts |
| Total heat to be removed (Q) | 222,933 | Watts |
| Condensation heat transfer | 50,000 | W/(m² · K) |
| coefficient (h) | | |
| Opteon 2P50 boiling point | 49 | ° C. |
| Average condenser temperature | 30 | ° C. |
| Opteon temperature difference (ΔT) | 19 | ° C. |
| 2-PIC heat exchange area | 0.2 | m² |
| (A = Q/(h · ΔT)) | | |
| Water inlet temperature | 25 | ° C. |
| Water outlet temperature | 35 | ° C. |
| Water temperature difference (ΔT) | 10 | ° C. |
| Water heat transfer coefficient (U) | 2,000 | W/(m² · K) |
| Water heat exchange area | 11.1 | m² |
| (A = Q/(U · ΔT)) | | |
| Maximum of water and Opteon | 11.1 | m² |
| PCHE area | | |
| Channel surface area density | 3,000 | m²/m³ |
| PCHE volume | 0.00372 | m³ |
| Cylindrical PCHE diameter | 430 | mm |
| Cylindrical PCHE minimum height | 26 | mm |

The 2-PIC coolant is individually jetted directly into the heat-sink silicon fin arrays etched into each of the 172 ZSLDs. This provides an optimal and consistent temperature and mass flow for every ZSLD. In comparison, most current systems flow coolant over a larger area, where chips nearer the coolant inlet receive “fresh” coolant, while chips closer to the exit receive coolant already heated by prior chips. This results in hot-spots in the design, which ZettaLith eliminates. The HBM4 stacks generate comparatively little heat and are cooled by minor 2-PIC coolant flow patterns of each nozzle.

A precision 3D-printed JETSTREAM manifold manages the flow of 2-PIC coolant to and from all 172 WSSCB locations for TRIMERA stacks and CPUs. The JETSTREAM manifold is manufactured using additive manufacturing of metal (e.g. laser melting of titanium powder) that has a very high precision and rigidity, and minimum interaction with 2-PIC coolant.

The complex internal geometry of the JETSTREAM manifold incorporates flow distribution channels and 3D printed baffles. These are designed and optimized using computational multiphysics simulation in ANSYS or other suitable engineering simulation software to ensure uniform 2-PIC coolant delivery jetted to each TRIMERA stack.

This optimization process integrates thermal, mechanical, and fluidic simulations to achieve optimal flow distribution across all chip locations, with individually optimized baffle and/or nozzle structures for each ZSLD position on the WSSCB to ensure the appropriate 2-PIC coolant flow. The CPU logic

stacks will consume a different amount of power than the CASCADE arrays, and this difference can be accommodated in the JETSTREAM manifold design.

The JETSTREAM cooling system has redundant pumps circulating 2-PIC coolant through the PCHE and JETSTREAM manifold. The system includes three high-reliability pumps, each able to pump the entire required 2-PIC coolant flow. Thus, any pump can fail without causing a system failure. The faulty pump can then be replaced during regular system maintenance.

If the valves and sealing design can be made sufficiently reliable, then the pumps can be made hot-swappable. However, the current design uses high reliability pumps that are replaced in maintenance cycles, to avoid potential problems with hot-swapability.

### ZettaLith PSU Stack Front View

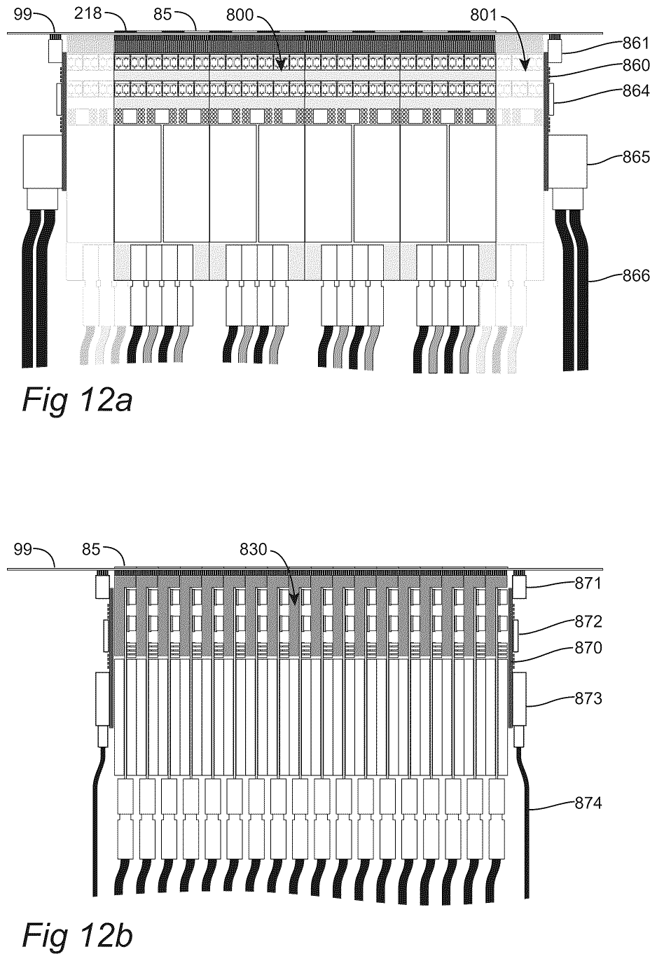

FIG. 12a shows a front view of a ZettaLith power supply array showing a row of PSU PCBs 800 connected to a WSSCB wafer 99, with attached HBM4 stacks 218 and TRIMERA stacks 85. Parts of a second row of PSU PCBs 801 are visible behind the first row as the array is not square, to better fit the circular 300 mm wafer used in WSSCB fabrication. There are a total of 86 PSU PCBs 800 attached to the WSSCB.

FIG. 12a also shows a side view of 800 GbE PCBs 860. These PCBs are connected by CGA connector 861 to the WSSCB 99, through which UCIe 2.0 connections connect 800 GbE controllers 864 to the BID dies on the WSSCB. These UCIe 2.0 connections are programmed for reduced speed compared to the UCIe 2.0 connections on the WSSCB. The PCB 860 is connected by 800 GbE sockets 865 to 800 GbE cables 866 leading to connectors through the coolant immersion vessel walls, and thence to a TOR switch (not shown).

In FIG. 12a, the PCIe 6.0 PCBs 870 are not shown, as these would obscure the view of the PSU PCBs 800.

### ZettaLith PSU Stack Side View

FIG. 12b shows a side view of a ZettaLith power supply array showing a row of side views of PSU PCBs 830 connected to a WSSCB wafer 99, with attached TRIMERA stacks 85. The HBM4 stacks 218 are obscured in this view.

FIG. 12b also shows a side view of PCIe 6.0 PCBs 870. These PCBs are connected by CGA connector 871 to the WSSCB 99, through which UCIe 2.0 connections connect PCIe 6.0 controllers 872 to the CPU dies on the WSSCB. These UCIe 2.0 connections are programmed for reduced speed compared to the UCIe 2.0 connections on the WSSCB. The PCB 870 is connected by PCIe 6.0 sockets 873 to PCIe 6.0 cables 874 leading to connectors through the coolant immersion vessel walls, and thence to SSDs and other PCIe 6.0 equipment as required (not shown).

In FIG. 12b, the 800 GbE PCBs 860 are not shown, as these would obscure the side views of the PSU PCBs 830.

### PSU Stack End View

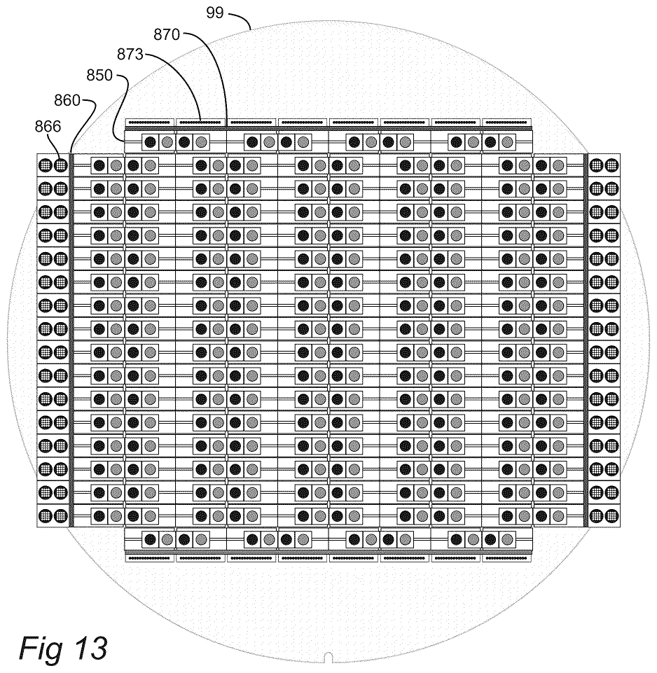

FIG. 13 shows an end view of a ZettaLith PSU PCB array, including an end view of the PSU PCBs 850. The end view of 800 GbE PCBs 860 with 800 GbE cables 866 is shown. Also shown is the end view of PCIe 6.0 PCBs 870 PCIe 6.0 cables 873. The WSSCB wafer 99 appears in the background.

### 2-PIC Fluids

The selection of an appropriate dielectric coolant is critical for 2-PIC efficacy and safety. Historically, the market heavily relied on engineered fluids from 3M™, namely the Novec™ and Fluorinert™ product lines. These fluorinated compounds (including fluorocarbons, hydrofluoroethers, and fluoroketones) offered advantageous properties such as:
Excellent dielectric strength (electrical insulation).
Tailored boiling points suitable for passive heat transfer from typical semiconductor operating temperatures (e.g., ~50-60° C.).
Good material compatibility with data center hardware.
Non-flammability.

### Mechanical Configuration

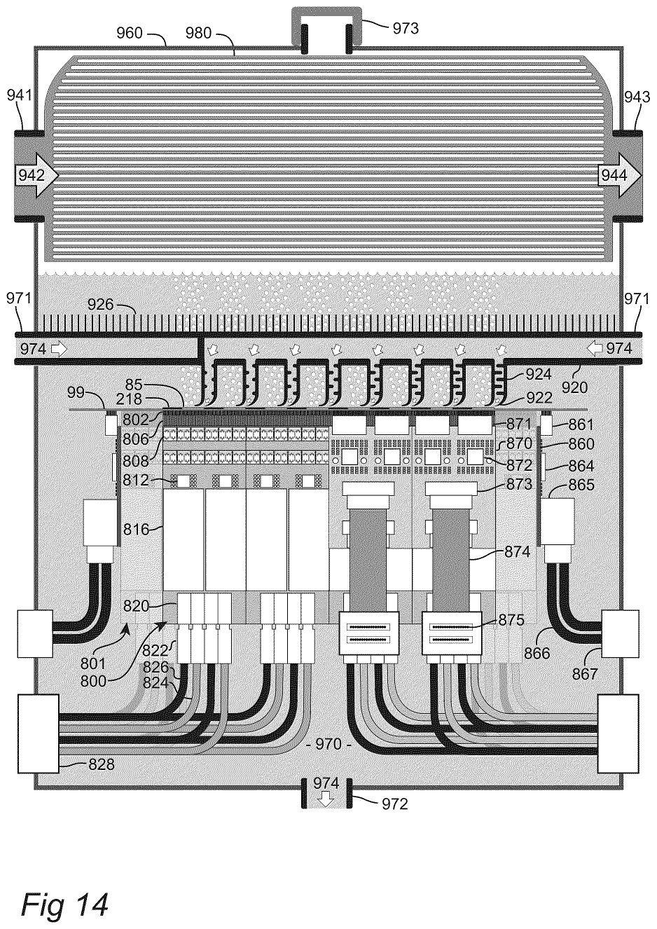

FIG. 14 illustrates the physical configuration of the JETSTREAM version of ZettaLith. The power supplies (PSUs) are shown as same PSUs as used for the JETSCI version. If compatibility is not required, JETSTREAM PSUs can be smaller and cheaper, as they deliver substantially less power.

The ZettaLith computational engine is housed in a coolant immersion vessel, in this case an unpressurized 2-PIC tank 960, which may have glass walls for viewing that the 2-PIC cooling is functioning correctly. This can be seen as a constant stream of small bubbles from significant heat sources, without large bubbles forming that prevent the 2-PIC coolant from contacting the heat sources.

The tank 960 is part-filled with 2-PIC coolant 970.

The coolant distribution manifold 920 is still required, otherwise TRIMERA stacks in the center of the WSSCB 99 will be cooled differently than those at the edge. It is likely that if there were no pumped 2-PIC jetting manifold, the central TRIMERA stacks would be barely cooled at all, as a large gas bubble would form preventing effective access of 2-PIC coolant.

The coolant pumps in this variant pump unpressurized 2-PIC solution, so can be standard liquid pumps instead of specialized sCO₂ pumps.

The 2-PIC—water PCHE 980 may be similar to the sCO₂—water PCHE 940 but is likely to need design changes due to the different operation. The sCO₂ PCHE 940 cools a circulating superfluid, while the 2-PIC PCHE 980 condenses a 2-PIC coolant.

The 2-PIC fill port 973 does not require pressure valves or pressure monitoring systems.

The 2-PIC flow direction is marked by the arrows 974. The pumped 2-PIC cycle is as follows:
Liquid 2-PIC solution enters the container 960 from the 2-PIC pumps at inlets 971 at the required flow rate.
The manifold 920 regulates 2-PIC flow to each TRIMERA stack with the additive manufactured “tuned” baffles 924. The baffles are likely to be different than the JETSCI version, due to the different viscosity of 2-PIC solution than sCO₂
The liquid 2-PIC solution is jetted at each TRIMERA stack by the nozzles 922. These nozzles will be of a different design to accommodate the formation of 2-PIC bubbles.
The heat from the TRIMERA stacks evaporates the 2-PIC solution forming streams of bubbles, which rise through the manifold 920.
The bubbles rise through the manifold stiffener 926, which is shown here in its correct orientation instead of rotated 90 degrees.
The bubbles break the liquid surface of the 2-PIC coolant.
2-PIC vapor rises through the 2-PIC PCHE heat exchanger 980.
The 2-PIC vapor condenses, and drips back into the 2-PIC liquid.
Convection carries the coolest 2-PIC coolant to the bottom of the tank 960, where it exits via the 2-PIC outlet 972 to the pumps which recirculate the 2-PIC solution at the required flow rate to the 2-PIC inlets 971.

### Supercritical CO₂ JETSCI Cooling

As ZettaLith compute is power limited, higher performance at similar cost can be achieved by using a more advanced cooling method such as supercritical CO₂ (sCO₂). The downside of this is higher development risk, and the need to operate ZettaLith in a pressure vessel, which complicates maintenance and introduces some safety and regulatory risks.

### JETSCI—Jet-Enhanced Thermoregulation Using Supercritical CO₂ Immersion

JETSCI employs the same physical manifold and nozzle geometry as JETSTREAM but substitutes supercritical carbon dioxide as the working fluid. The coolant remains above its critical pressure and temperature throughout operation and does not undergo phase change. The sCO₂ enters the manifold through the two inlet ports, passes through the nozzles, and extracts heat by convective transport across the etched fin structures of the dies.

As the fluid absorbs heat, its density decreases and it rises through the inter-stack gaps to the PCHE at the top of the pressure vessel. There, it transfers heat to a secondary loop and cools, increasing in density. The cooler, denser sCO₂ then sinks by natural convection to the tank bottom, where it is collected through a bottom outlet port and recirculated by a triply redundant high-reliability pump set. Each pump has at least half of the required capacity, providing for a pump failure without loss of cooling function. Because the system operates at high pressure, pump hot-swap is impractical; instead, ZettaLith continues operating on the remaining pumps until a maintenance interval is scheduled to depressurize the vessel and replace the failed unit.

### Supercritical CO₂

Studies (Fronk et al., 2016), (Husain et al., 2016), (Zhao et al., 2025) show that when a supercritical CO₂ jet impingement system is optimized through appropriate microchannel design it is capable of handling heat fluxes approaching and potentially exceeding 500 W/cm² of chip area. This high level of power density requires well designed microchannels acting as heatsink fins or posts in the back of the chip to increase effective chip surface area.

Research into sCO₂ cooling is not restricted to high performance computing. Similar technologies are in use for solar towers (Zhuang et al., 2023), nuclear plants, and power electronics, and the final design of the JETSCI manifold should be informed by advances in these areas in addition to HPC applications.

Operating above its critical point (31.1° C., 7.38 MPa), sCO₂ combines liquid-like density and heat capacity with gas-like viscosity and diffusivity. The entire system can be immersed in a pressure vessel containing sCO₂ meaning that there are no differential pressures across the ZettaLith structure. With heat transfer coefficients in the range of 1.5-10 kW/m²K in forced convection near the critical point, combined with surface area enhancement through etched fins or micropins, this approach enables ZettaLith variants operating at higher power densities.

### JETSCI Version of ZettaLith

This configuration for an ultra-high performance JETSCI cooled ZettaLith in a coolant immersion vessel, in this case an sCO₂ pressure chamber. It is therefore somewhat ‘exotic’ for typical data center use. However, it is a highly cost-effective configuration, as it draws more performance from the TRIMERA stacks by running them at a higher clock frequency than could be sustained by prevalent existing cooling systems.

ZettaLith's physical integration into data centers follows two potential paths:
as a specialized appliance within standard data center environments, requiring only facility water connections, 48V DC power, and network connectivity; or
as part of specialized AI facilities designed for advanced cooling systems.

The standard interface approach encapsulates cooling complexity within the ZettaLith unit itself, presenting conventional interfaces to data center infrastructure. For power delivery, existing data centers can support the required current through parallel 48V DC feeds—a configuration already used for high-density GPU deployments, merely requiring appropriate PDU specifications. The self-contained sCO₂ system manages pressure boundaries internally, with external connections limited to standard water cooling interfaces already common in HPC environments.

### Key Differences of the JETSCI ZettaLith

This JETSCI alternative configuration modifies the following key parameters compared to the baseline JETSTREAM-cooled system:
Cooling System: Replaced JETSTREAM Two-Phase Immersion Cooling (2-PIC) with JETSCI supercritical CO₂ (sCO₂) cooling.
ZSLD PE Clock Frequency: Increased from 15 GHz to 20 GHz.
Total System Power (Computational): Increased from ~198 kW to approximately ~350 kW. The power is greater than 20/15, as the V_{core} needs to be increased from 0.65 V to 0.75 V to support the higher switching frequency, and the voltage ratio is squared (Total rack power including conversion overheads would scale similarly).
Peak Performance (Sparse FP4): Increased from 1.506 zettaFLOPS to ~2.008 zettaFLOPS.
HBM4 bandwidth to compute ratio decreases, increasing ZettaLith's reliance on weight reuse to balance memory and computation.

All other core architectural innovations, including the WSSCB, Silicon Springs, TRIMERA stack (ZSLD/HILT/BID), SHAPE methodology, CASCADE arrays, HILT memory, CREST fault tolerance, and high-current power delivery system, remain fundamentally the same, albeit operating under higher thermal and electrical stress.

### Mechanical Configuration

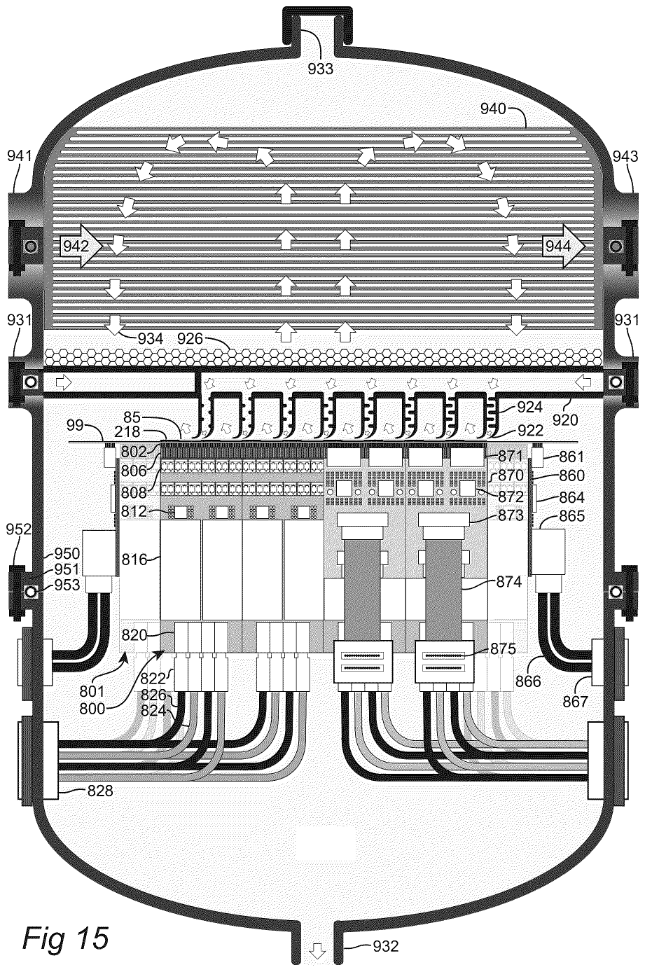

FIG. 15 illustrates the ZettaLith system configuration adapted for sCO₂ JETSCI cooling, highlighting the minimal changes required compared to the JETSTREAM version. The power supplies (PSUs) are shown as same PSUs as used for the JETSTREAM version. In both cases, the power supplies are scaled for the higher power of the JETSCI version.

### Supercritical CO₂ Pressure Vessel

The ZettaLith compute, memory, power supplies, and thermal control systems are all immersed in sCO₂ 930 inside a pressure vessel 950. The flow directions of sCO₂ are shown by the arrows 934. The pressure vessel comes apart at three locations.
At the flanges 951 which are joined by a ring of bolts 952 and sealed by a metal Helicoflex seal 953. The ZettaLith electronics system is installed with this flange joint open.
At the level of the JETSCI manifold 920. This is necessary as the manifold is a single piece of additive manufactured laser melted titanium, with multiple inlet ports 931 and 172×JETSCI nozzles 922. It is highly rigid, stiffened by open stiffening cells 926, so that a small gap of around 0.5 mm is achieved between the JETSCI nozzles and the SLDs 85 to be cooled. This is essential, as the nozzle tips 922 must not contact the SLDs 85 during assembly or operation. The stiffening cells 925 are shown rotated 90 degrees to face the viewer so that the structure can be seen. They actually face upwards, to stiffen the JETSCI manifold in the vertical direction, and allow relatively unimpeded vertical flow of sCO₂ from the hot surfaces to the heat exchanger 940. The JETSCI manifold 920 is installed with the flange joint at the level of the sCO₂ inputs 931 open.
At the level of the PCHE 940 inlet port 941 and outlet port 943. The pressure vessel opens at this level to allow installation of the PCHE.

It is possible to combine the JETSCI manifold with the PCHE into a single structure, allowing both to be installed at the same pressure vessel separation point. However, this is a relatively minor optimization which may reduce costs somewhat but requires the JETSCI manifold and PCHE to be co-designed. This may extend TTM and increase schedule risk if one or the other subsystem requires redesign. This optimization is more appropriate for a second generation ZettaLith.

### JETSCI Nozzles

The sCO₂ jets from the 172×JETSCI nozzles 922 cool the primary heat sources, the SLDs 85, connected to the WSSCB 99 along with the HBM stacks 218. The sCO₂ flow is adjusted by 3D printed baffles 924 to achieve equal flow rates to the 156×SLDs with CASCADE arrays of FP4 PEs, and the appropriate flow rates to the 16×CPU SLDs. The baffles 924 compensate for the difference in position of the nozzles 922 in relation to the sCO₂ inputs 931 from the pumps.

### Printed Circuit Heat Exchanger (PCHE)

The sCO₂ is cooled by a printed circuit heat exchanger (PCHE) 940. The PCHE is preferably made of pure titanium to ensure that none of the PCHE material dissolves in the sCO₂ and contaminates the ZettaLith logic or power supplies. The PCHE is water cooled using standard equipment likely to already be present in the datacenter that the ZettaLith is installed in. Sufficient cool water to remove 350 kW of total heat flow is pumped into the water inlet 941, with heated water received from the water outlet 943. Water flow direction through the PCHE is shown by the arrows 942 and 944.

FIG. 14 shows a cross section of a ZettaLith system. The ZettaLith system is contained within a ZettaLith pressure vessel 890 which may be made of titanium, and is approximately 400 mm in diameter, 800 mm high, with a volume of around 100 liters.

The external connections to the ZettaLith are:
48 VDC high current high pressure power inlet sockets 828.
PCIe 6.0 connections 875.
800 gigabit Ethernet connections 867.
Water inlet 941 and outlet 943.
Pressurized sCO₂ inlets from external sCO₂ pumps 931.
Pressurized sCO₂ outlet to external sCO₂ pumps 932.
sCO₂ filling inlet with pressure monitoring and release valve 933.

### Architectural Compatibility and Parallel Development Path

Crucially, the fundamental ZettaLith hardware components—including the WSSCB substrate, TRIMERA ZSLDs, HBM stacks, HILT die, and BID, and coolant jet manifolds—are designed to be compatible with either cooling approach. This allows for parallel development and evaluation of both JETSTREAM and JETSCI solutions. This inherent compatibility might permit offering ZettaLith systems configured with either cooling technology, potentially catering to different customer requirements or deployment environments.

### ExaLith: ZettaLith Chips for Desktop, Robot, and Server Scale

While the full ZettaLith architecture targets the extreme scale and performance demands of hyperscale data centers, there is applications for smaller systems using most of the ZettaLith technology.

Potential users include small-to-medium businesses (SMBs), research institutions, AI developers, and creative professionals who require substantial local AI inference capabilities but lack the budget and infrastructure for multi-rack GPU clusters or dedicated data center solutions.

ExaLith is conceived as a direct application of the core ZettaLith chips and technologies to this market, delivering exascale-class FP4 (W4A8) inference performance within the familiar form factor and power envelope of a high-end workstation or desktop PC component.

There are several feasible formats using ZettaLith silicon in desktop, workstation, robot, or departmental environments:
PCIe card: for integration into standard workstations and servers.
AI Workstation: a complete, pre-integrated desktop/tower system built around one or more ExaLith accelerators.
Network Attached AT Accelerator (NAA): a standalone, network-accessible box containing a single ExaLith accelerator.
Multi-Accelerator Appliance: a dedicated chassis housing multiple (e.g., 2-8) ExaLith accelerators for shared, high-throughput network access.
Server Blade/Module: Integrating the ExaLith accelerator onto a standard blade form factor for denser rack deployments. This format is particularly suited for private clouds which don't require full ZettaLith performance.
ExaDrive: Drive computer for advanced cars with full-scale on-board LLM intelligence
ExaBot: Humanoid or other robot “brain” with full-scale local LLM intelligence

The power consumption of a ZettaLith TRIMERA stack is too high to be used in a notebook computer. For this application, new silicon would be required, and the PetaLith concept is more appropriate.

### ZettaLith Scalable Architecture

ExaLith demonstrates the ZettaLith architecture's inherent scalability. It shows that the core innovations—the efficiency of CASCADE compute arrays within TRIMERA stacks, the SHAPE methodology enabling rapid deployment on advanced nodes, the HILT memory hierarchy, and CREST fault tolerance—are not confined to the data center.

By adapting the integration substrate (using an SCB module on a high-performance PCB instead of a WSSCB) and tailoring the memory subsystem (HBM+HBF), the fundamental compute advantages can be effectively translated to different cost, power, and form factor constraints. This allows ExaLith to leverage the core silicon developed for ZettaLith data center systems, benefiting from manufacturing costs that do not need to recoup the initial NRE investment.

The ExaLith series use a two-module SCB portion of a WSSCB. One module contains a TRIMERA stack and HBF stack, and the other module contains a CPU stack and a HBM4 stack. There is no custom silicon required other than that already required for ZettaLith, as extra chips required are commercially available. Standard ExaLith units are in a minimum cost configuration (16 GByte HBM4, 128 GByte HBF) while ExaLith Max systems use the maximum memory (64 GByte HBM4, 512 GByte HBF). In all cases, the two-module SCB is mounted by copper wire CGA pillars to a PCB that contains the power supply components, and any I/O processors or other SoCs and their associated memory and other components. ExaLith systems assume that no new chips are required beyond those developed for ZettaLith—all of the SoCs, memory, and other devices are commercially available from other suppliers. ExaLith systems provide ample advantage that they do not need to be cost optimized with further custom chips until the market fit is proven for high volume production.

### ExaLith PCIe Card

The core concept of ExaLith is to leverage the modularity and efficiency of the ZettaLith architecture, specifically utilizing the chips to be developed for ZettaLith (the ZSLD, HILT, BID, CACHE, and CPU, dies as defined previously) and most of the software stack, integrated onto a single PCIe board.

This approach crucially avoids the need for fundamentally new silicon development for the core compute elements, instead focusing on innovative integration and memory configuration at the board level.

A key factor enabling ExaLith's unique price-performance profile is its hybrid memory architecture. The ExaLith comprises a high-performance PCIe printed circuit board (PCB) which serves as a carrier for a compact Silicon Circuit Board (SCB) module. This SCB module, fabricated using ZettaLith's WSSCB process but on a smaller scale, integrates the core compute and memory elements. A typical configuration places the following components onto this SCB module:

A CPU stack, paired with high-bandwidth memory (HBM4) to run a subset of the transformer inference code developed for ZettaLith, and to store KV caches, intermediate activations, and frequently accessed data, mirroring a portion of the full ZettaLith configuration.

a TRIMERA stack is coupled with emerging High-Bandwidth Flash (HBF) memory technology (such as that announced by SanDisk). This HBF stack serves as a large, cost-effective, and non-volatile repository primarily for storing the vast parameter sets of trillion-parameter-scale transformer models.

This HBM+HBF combination allows ExaLith to inference transformer models up to 1 trillion FP4 parameters locally achieving a target inference performance of around 1.6 exaFLOPS (dense FP4, approximately 3.1 exaFLOPS sparse)—performance comparable to multiple racks of current-generation AI accelerators—within a single PCIe card footprint.

Performance projections, memory configurations, power breakdowns, and cost estimates for an ExaLith PCIe card are provided in Table 21.

TABLE 21
ExaLith PCIe card characteristics

| Aspect | Value | Units |
|---|---|---|
| TRIMERA stack on SCB | 1 | TRIMERA stack |
| CPU stack on SCB | 1 | CPU stack |
| Operational clock frequency | 5 | GHz |
| Total active PEs in ExaLith | 155 | million PEs |
| Performance of 1 PE (1 MAC = 2 Ops) | 10 | GFLOPS |
| ExaLith performance (sparse) | 3.1 | exaFLOPS |
| ExaLith performance (dense) | 1.55 | exaFLOPS |
| FP4 parameters in memory (HBF) | 1 | TP |
| Minimum latency for 1 TP LLM | 0.5 | seconds |
| TRIMERA-CPU data link (UCIe on SCB) | 39 | TB/s |
| HBM4 memory | 16 | GB |
| HBM4 bandwidth | 1.64 | TB/s |
| HBF memory | 512 | GB |
| HBF bandwidth | 1 | TB/s |
| PCIe 6.0 bandwidth | 128 | GB/sec |
| TRIMERA ZSLD power density | 254 | W/cm² |
| ExaLith CASCADE array power | 363 | W |
| Power limited CPU stack power | 120 | W |
| HBM power | 30 | W |
| HBF power | 30 | W |
| ExaLith total compute power | 543 | W |
| Multiphase buck converter efficiency | 92% | |
| Total PCIe card power | 591 | W |

Extreme Bandwidth within ExaLith

The SCB module facilitates an extremely high-bandwidth connection, nominally 39 TB/s using UCIe 2.0 over dense RDL wiring, directly between the Base Interface Dies (BIDs) of the CPU stack and the TRIMERA stack, enabling rapid data exchange. This bandwidth is far higher than the combined HBM and HBF bandwidths, effectively making them directly part of the TRIMERA stack high speed memory environment. The TRIMERA stack can also communicate with CPU cache SRAM at this speed.

### Power Consumption

Achieving this level of performance within a PCIe card necessitates careful thermal and power management. Calculated ExaLith total board power is 591 W, under the 600 W limit for PCIe cards. Cooling is envisioned using advanced air-cooling solutions incorporating phase-change heat pipe technology and high-efficiency fans, like those employed in flagship consumer and workstation GPU cards. While demanding, this remains within the established capabilities of desktop/workstation thermal design, avoiding the 2-PIC JETSTREAM cooling requirements of the full ZettaLith system.

12V power delivery utilizes the 16-pin 12 VHPWR connector from a ATX 3.0 compliant PSU. The 12V input is regulated to the TRIMERA, CPU, HBM, and HBF requirements by an on-board multiphase controller (such as the Infineon XDPE192C4C programable digital multi-phase controller) with 12 interleaved phases driving power stages such as the Infineon TDA21590, Monolithic Power MP86956, or Renesas RAA220105.

Multiphase buck converters are selected for their high efficiency and cost-effectiveness at PCIe power levels, compared to the TLVRs chosen for ZettaLith's extreme current regulation needs.

### ExaLith PCIe Card Block Diagram

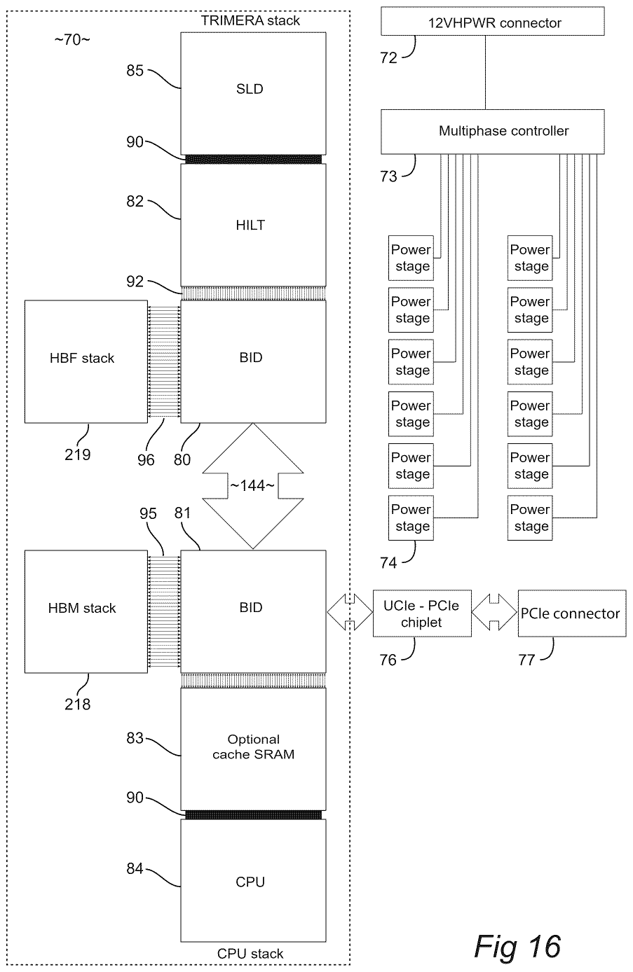

FIG. 16 is a high-level block diagram of an ExaLith PCIe card integration. A Silicon Circuit Board (SCB) 70 essentially comprising two modules of ZettaLith WSSCB contains four chip stacks:
A TRIMERA stack comprising a BID 80, a HILT die 82 and an ZSLD 85 with FP4 CASCADE PEs.
A HBF stack 219 connected to the TRIMERA stack BID 80 by HBF channels 96.
A CPU stack comprising a BID 81 (identical to the TRIMERA BID), an optional SRAM cache die 83, and a CPU die 84. If an SRAM cache die 83 is not used, a smaller amount of SRAM cache would be implemented directly on the CPU die, and the CPU die takes the place of the cache SRAM die.
A HBM stack 218 connected to the CPU stack BID 81 by HBM channels 95.

The TRIMERA BID 80 and CPU BID 81 are connected by the vertical UCIe connections between two BIDs 144. This provides a 39 TB/s BID-BID data link, as it uses same ultra-high bandwidth UCIe 2.0 data fabric connection used in ZettaLith. 39 TB/s is far higher than the sum of the HBM and HBF bandwidths, and this enables the TRIMERA stack to utilize the CPU cache SRAM at very high bandwidth.

The ExaLith PCB contains a UCIe to PCIe conversion chiplet 76, which is used to connect the ExaLith computational engine on the SCB 70 to the PCIe connector 77. The UCIe to PCIe conversion chiplet is preferably the same as used for ZettaLith.

Power supply is standard for a 600 W PCIE card. 12 V DC Power is provided from the system PSU via 12 VHPWR connector 72. A multiphase controller 73 drives a number of power stages 74 in multiple phases.

### ExaDrive

ExaDrive is an ExaLith module on a PCB configured for use as a drive computer.

ExaDrive represents a fundamental shift in automotive electronics: the integration of datacenter-class AI inference into a vehicle-scale module that is ruggedized, serviceable, and future-proof By providing ~1 exaFLOPS sustained FP4 compute with secure on-vehicle storage of trillion-parameter models, it enables vehicles to function as:
Autonomous platforms with extreme safety margins—running multiple redundant perception and planning models in parallel.
Personal AGI hubs—hosting GPT-5-class assistants directly in the car, accessible via phone or wearable, without dependence on external cloud services.
Secure digital vaults—keeping personal data local, immune to centralized hacks, advertising models, or forced subscriptions.
Fleet-scale compute nodes—allowing logistics, robotaxi, defense, and public transit operators to consolidate AI infrastructure at the vehicle edge.

### Intermediate Systems Between ExaLith and ZettaLith

Intermediate systems between a WSSCB ZettaLith implementation with 156 TRIMERA stacks, and a PCIe card with a single TRIMERA stack, can be implemented. Also, various combinations of HBM and HBF may be optimal for future AI inferencing, along the spectrum between ExaLith and ZettaLith.

PetaLith: Edge Devices with Partial ZettaLith Architecture

The exponential growth of generative AI has created enormous demand for high-performance inference engines in edge devices—autonomous cars, humanoid robots, medical systems, smart PCs, factory automation, and augmented reality platforms. While data-center solutions like ZettaLith leverage 156 HBM stacks and 15 GHz CASCADE compute arrays to deliver zettaFLOPS-scale performance, edge devices face strict power, thermal, and cost constraints.

The PetaLith IP block adapts some of ZettaLith's core innovations—CASCADE, SHAPE, HILT, and CREST—together with SanDisk's HBF into a compact, edge-optimized IP block that enables AGI-scale transformer inference for next-generation edge AI applications.

Configured to start with next generation SoCs using TSMC's N2 CMOS process, PetaLith integrates CASCADE arrays with a total of 524,288 active PEs clocked at 12 GHz achieving 12,583 dense TFLOPS (FP4, W4A8) at under 4 W.

Table 22 shows various characteristics of an example PetaLith IP block.

TABLE 22
PetaLith IP blocks in Edge SoCs

| Aspect | Value | Units |
|---|---|---|
| Performance (dense, FP4, W4A8) | 12,583 | TFLOPS |
| Target CMOS process | TSMC N2 | node |
| Logic density | 313 | MTr/mm² |
| Weights and activations format: FP4 | 4 | bits |
| Primary PetaLith clock | 1.5 | GHz |
| Processing Element (PE) area | 1.11 | μm² |
| HILT unit cell area | 0.013 | μm² |
| HILT area overhead (including latch tree) | 22% | |
| CASCADE local clock speed | 12 | GHz |
| Rest of PetaLith IP block clock speed | 1.5 | GHz |
| Batch size × input token length in HILT | 4,096 | B × L |
| Active CASCADE array columns | 512 | columns |
| Spare CASCADE columns for CREST | 8 | columns |
| Columns per CASCADE array | 520 | columns |
| Rows per CASCADE array | 64 | rows |
| CASCADE arrays in PetaLith IP block | 16 | arrays |
| Total CASCADE rows PetaLith IP block | 1,024 | rows |
| PEs in PetaLith IP block | 532,480 | PEs |
| Active PEs in PetaLith IP block | 524,288 | PEs |
| Weight bits in CASCADE PEs | 2,097,152 | bits |
| Activations HILT bits | 16,777,216 | bits |
| Output sums HILT bits | 16,777,216 | bits |
| Number of SanDisk HBF NAND Flash | 1 | stack |
| stacks | | |
| Capacity of HBF stacks | 512.0 | GBytes |
| Likely bandwidth of HBF stacks | 1.2 | TB/s |
| CASCADE array chip area | 0.59 | mm² |
| Activations HILT chip area | 0.26 | mm² |
| Output sums HILT chip area | 0.26 | mm² |
| Total chip area for PetaLith IP block | 1.12 | mm² |
| Total PetaLith IP block memory | 4.46 | MBytes |
| CASCADE system power consumption | 3.53 | Watts |
| Example transformer inferenced | DeepSeek V3/R1 | |
| Typical weights activated per MoE | 37 | billion |
| inference | | |
| Input token sequence | 2,048 | tokens |
| CASCADE limited transformer inference | 9.0 | ms |
| time | | |
| HBF limited transformer inference time | 17.0 | ms |
| Max inference rate, limited by HBF | 59 | tokens/sec |

### High Bandwidth Flash

PetaLith uses a SanDisk High Bandwidth Flash (HBF) stack providing 512 GB of parameter storage at around 14.1 TB/s. This enables real-time inference of 1 trillion FP4 weights worth of a mix of LLMs, multimodal transformers, and reasoning AIs at a HBF-bandwidth limited rate of 59 tokens/second—performance rivaling rack-scale GPUs in a mobile edge device.

### Source of Advantage

PetaLith's capability lies in its FP4-optimized pipelines and ZettaLith-derived HILT memory. Unlike SRAM-based edge AI accelerators, HILT's latch-tree topology is designed to achieve extreme bandwidth at very low power, with a footprint smaller than SRAM.

SanDisk's recently announced HBF combines the low cost/TByte and non-volatility of Flash with HBM scale bandwidth. Combining CASCADE's efficient large arrays of fast tiny PEs, PetaLith fits alongside CPUs/GPUs and I/O in edge SoCs, making it well suited for latency-critical applications like robotic motion planning, real-time AI generated video and VR, and self-driving cars.

### Efficient Silicon

By replacing HBM with cost-efficient HBF flash and scaling ZettaLith's CASCADE arrays into the next generation of SoC designs, PetaLith can deliver GPU level AI inference in a form factor that can take up less than 2 mm² of SoC area. With the ability to inference 2,048-token prompts of an AI with DeepSeek intelligence in 9 ms, people will be able to have intelligent conversations with their personal humanoid robots—without their private information ever traversing the internet. Sophisticated transformer models for real-time speech recognition and synthesis can be run concurrently, so people can converse naturally with the device at full speed and without cloud connectivity. Vision models and movement can also be run simultaneously, where appropriate.

PetaLith could make AI assistants such as Siri, Google assistant, Alexa, Quark, Yuanbao, Doubao, and Cortana truly useful. PetaLith illustrates that ZettaLith technology is scalable from zettaFLOPS data centers to handheld edge devices.

### Avoiding Hotspots

CASCADE columns have a very high power density, if they are run at 15 GHz for high performance. If the PetaLith IP were to be provided as a single hard macro around 1.2 mm², power would be highly concentrated, and an extreme hot-spot would be created.

Fortunately, the CASCADE architecture allows it to be efficiently divided into 18 blocks, which can be spread over the SoC die to minimize hotspots, using the silicon substrate as a heat spreader. These 18 blocks can be provided as a set of 16 identical hard macros for the CASCADE arrays, and different hard macro for the output HILTs and a control CPU, with minimal wiring required between them. This minimizes localized hotspots while maintaining efficient high frequency operation.

### High Level Abstraction of PetaLith Interface

The control CPU embeds the low-level operation of the CASCADE arrays and CREST operation, so that the whole PetaLith is presented with a high-level interface abstracting the low level operation. This dramatically simplifies integration with the SoC, as PetaLith control operations (which may have significant complex timing requirements) do not need to be ported to different SoC processors every time the PetaLith IP block is used.

### WSSCB Manufacturing

### Prior Art Silicon Interposers

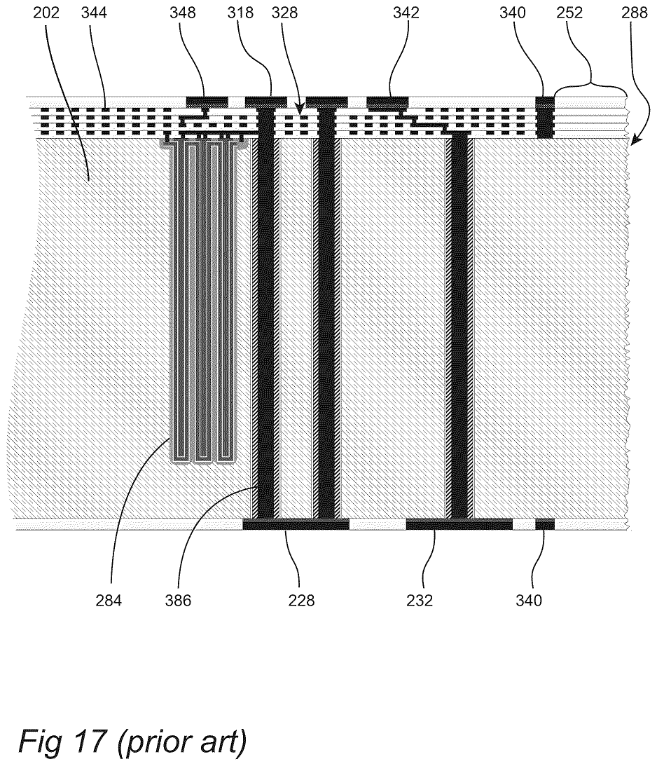

FIG. 17 shows a cross section of a prior art conventional silicon interposer in a silicon wafer thinned to 100 μm. Thinning to 100 μm enables practical TSV aspect ratios while minimizing signal propagation delays and parasitic capacitance through the TSVs. The interposer silicon 202 includes integrated decoupling capacitors 284 and TSVs 386 for power and signal distribution. An RDL 328 contains signal lines 344 for chip-to-chip communication. The structure includes both signal microbump landing pads 348 and power or ground microbump landing pads 318 on its top surface for chip attachment. The bottom surface features C4 power landing pads 228 and C4 signal landing pads 232 for connection to a package substrate. Signal landing pads 342 connect directly to TSVs for vertical signal transmission. A seal ring 340 protects the RDL edges from moisture ingress and ionic contamination, which can diffuse through the SiO₂ dielectric and cause copper corrosion or reliability issues. There is an edge keepout zone 252 maintained between the seal ring and the interposer edge 288.

### WSSCB Process

The manufacturing process for a WSSCB with stress relief builds upon mature CMOS wafer fabrication and silicon interposer manufacturing processes. A Silicon Circuit Board (SCB) is a subset of a WSSCB, where individual modules are singulated from the wafer. The SCB manufacturing process is the same as the WSSCB manufacturing process, except that chip singulation etches are performed with the same etch as the silicon spring etch, and chips are subsequently picked from the wafer. The term SCB is used for this process flow, except where WSSCB is specifically indicated.

### Starting Wafer and General Considerations

Start with a standard 300 mm CZ Si wafer (nominal thickness 775 μm) and target a finished thickness of ≈710 μm after frontside/backside processing and edge conditioning.

The wafer resistivity is chosen to be in the range of 1-10 Ω-cm, which provides a suitable substrate for the subsequent formation of deep trench capacitors while maintaining good mechanical properties for the SCB structure.

For this process flow, the wafer is the standard 775 μm thick, but the process flow can readily be adapted for other wafer thicknesses. The SCB remains thick to ensure board-level rigidity and crack resistance. Do not back-grind to interposer-class thicknesses.

Specify low-defect, DSP (double-side polished) wafers with total thickness variation (TTV)≤10 μm to maintain spring uniformity and flatness through RDL deposition (e.g. Silicon Valley Microelectronics, 2020).

The integrated silicon springs provide out-of-plane compliance, isolate thermal and mechanical stresses to cm-scale regions, decouple CTE mismatches to daughter cards, and act as crack-arrest features. They are fabricated by deep reactive ion etching (DRIE) with filleted roots to reduce stress concentration. (Shubin et al., 2010; Wang et al., 2024).

Minimum spring beam width and corner radii shall be set by fracture mechanics of single-crystal Si with KIC~1 MPa\sqrt{m}. Avoid sharp notches. Include proof-test deflection to screen subcritical flaws (Ritchie, 2003; Tada et al., 2004).

Silicon springs round the edge of the SCB array can decouple a crack propagated from the edge of the wafer from affecting the active SCB array. In a similar manner, silicon springs distributed through the blank wafer regions surrounding the array can prevent cracks caused by handling stress from propagating past the springs.

### Integrated Decoupling Capacitor Formation

The initial etching process starts with deposition of a plasma-enhanced chemical vapor deposition (PECVD) oxide hardmask approximately 500 nm thick. The hardmask can be SiO₂ for simplicity, or Al₂O₃ for extreme selectivity (Drost et al, 2022). After photolithography using positive resist to define the capacitor regions, a dry etch process utilizing CF₄/O₂ chemistry creates recessed regions approximately 1 μm deep. These recessed regions are sized larger than the eventual capacitor array to accommodate subsequent contact formation.

A second resist is applied. Within each recessed region photolithography defines the capacitors within each recessed region. An array of deep holes are formed with deep reactive ion etching (DRIE) using the Bosch process, alternating between SF₆ etch and C₄F₈ passivation steps, which creates high aspect ratio holes with nearly vertical sidewalls. The process temperature is maintained between −20° C. and 20° C. to ensure proper sidewall passivation and etching characteristics.

A critical doping step follows, where BBr₃ gas is used as a diffusion source at temperatures between 1000-1100° C. for around 5 minutes. This high-temperature process ensures uniform p++ doping of all exposed silicon surfaces, including the sidewalls of the deep holes. This heavily doped region forms the outer negative plate of the capacitor structure, while forming a reverse biased diode with the n-wafer substrate.

The first dielectric layer is formed through dry thermal oxidation at 900-950° C. in an O₂ atmosphere. This carefully controlled oxidation produces a high-quality thermal oxide layer 5-10 nm thick, with minimal defects and pinholes. The thermal oxide serves as the primary capacitor dielectric. This is performed after BBr₃ doping, but before the first polysilicon layer.

The first polysilicon layer is deposited using low-pressure chemical vapor deposition (LPCVD) at 580-620° C. using silane (SiH₄) gas. This conformal deposition creates a polysilicon layer 100-200 nm thick on the sidewalls of the holes, forming the positive plate of the capacitor.

A second thermal oxidation step, performed under the same conditions as the first oxidation, creates another high-quality dielectric layer on the first polysilicon layer. The BBr₃ doped silicon is not further oxidized, as it is covered by the first polysilicon layer. This second oxide layer provides additional capacitance to the inner plate, nearly doubling the capacitance with no extra lithography steps.

The holes are then filled with a second LPCVD polysilicon deposition, performed at 580-620° C. with in-situ phosphorus doping. This layer is deposited conformal plus overfill. While complete void-free filling is desired, small voids in the center of the filled holes are acceptable as they do not significantly impact the capacitor performance.

The wafer surface is then planarized using chemical-mechanical planarization (CMP), with the original oxide hard mask serving as a polish stop layer. A thorough post-CMP clean removes any residual slurry particles and contaminants.

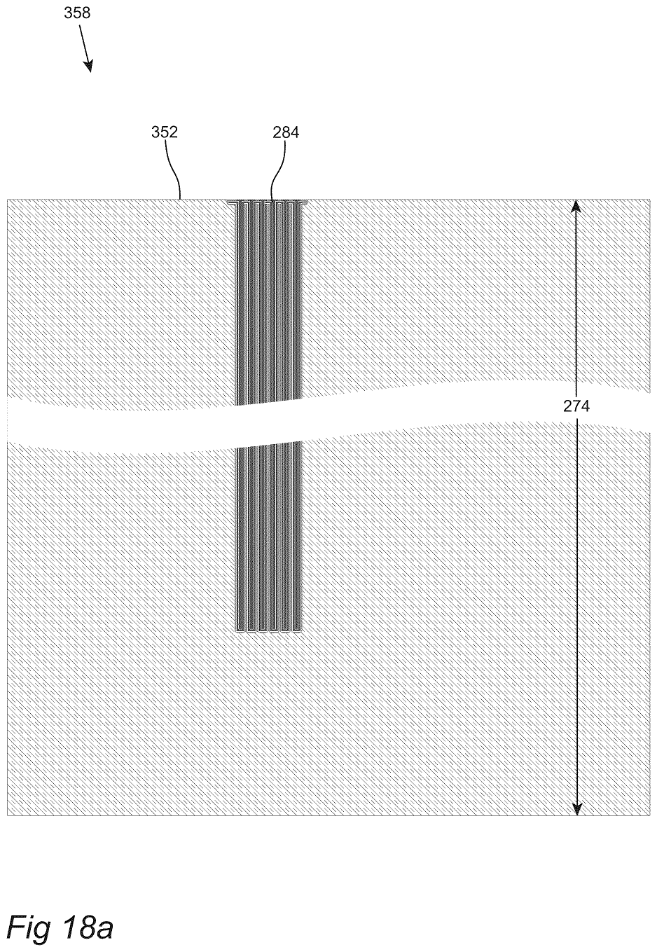

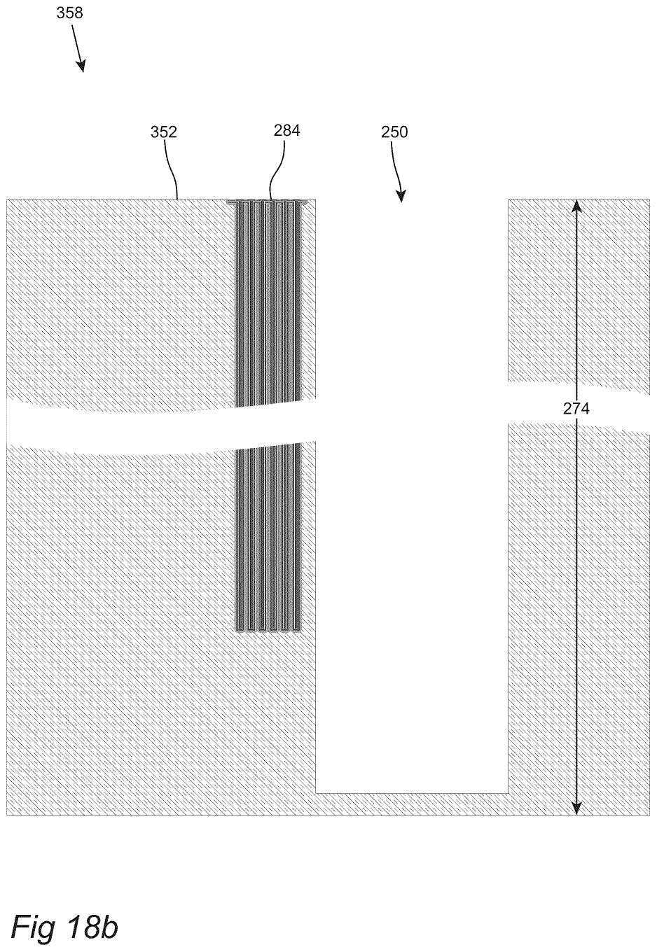

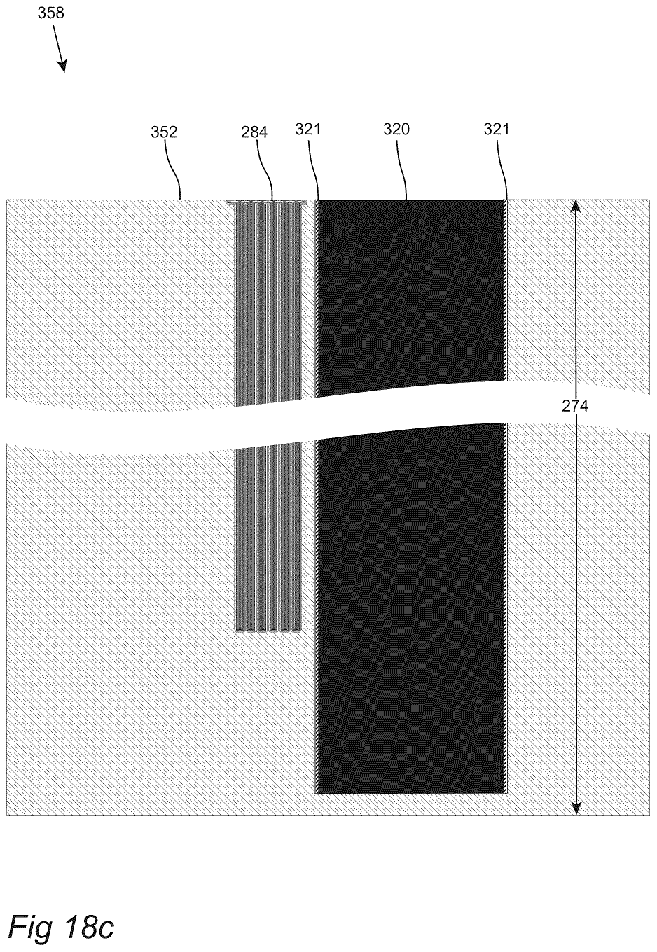

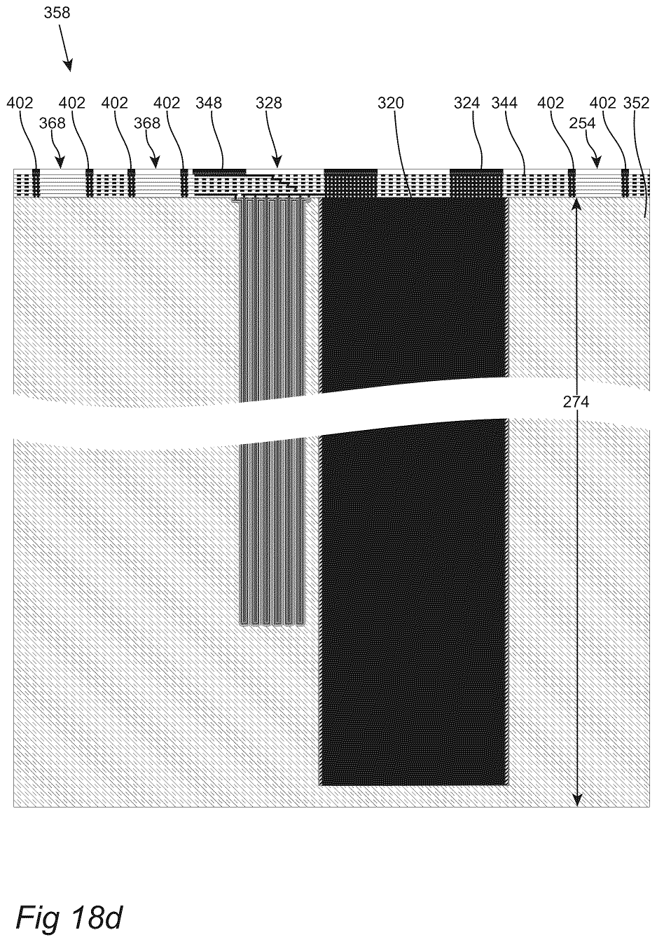

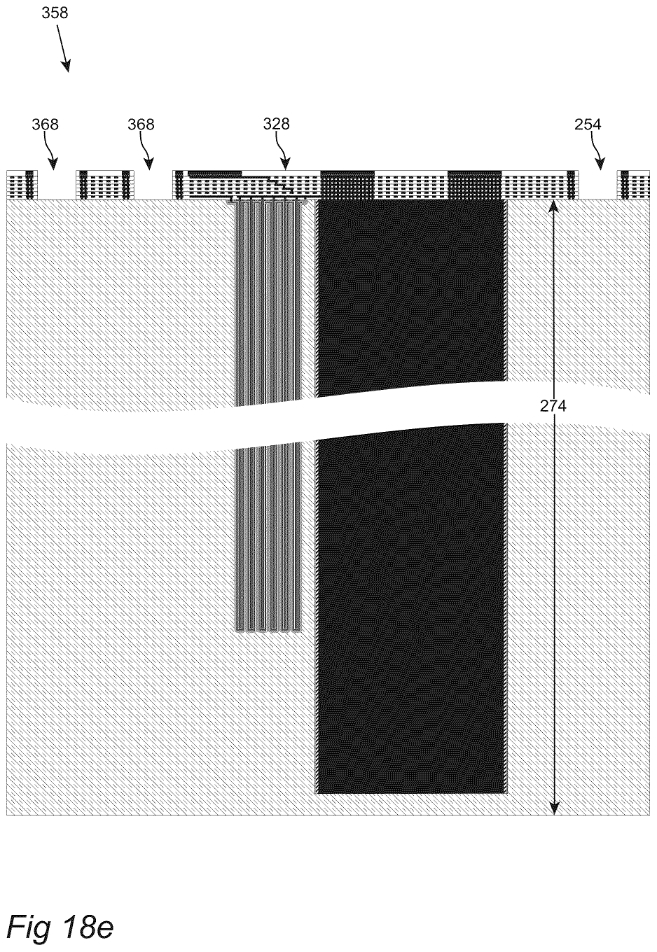

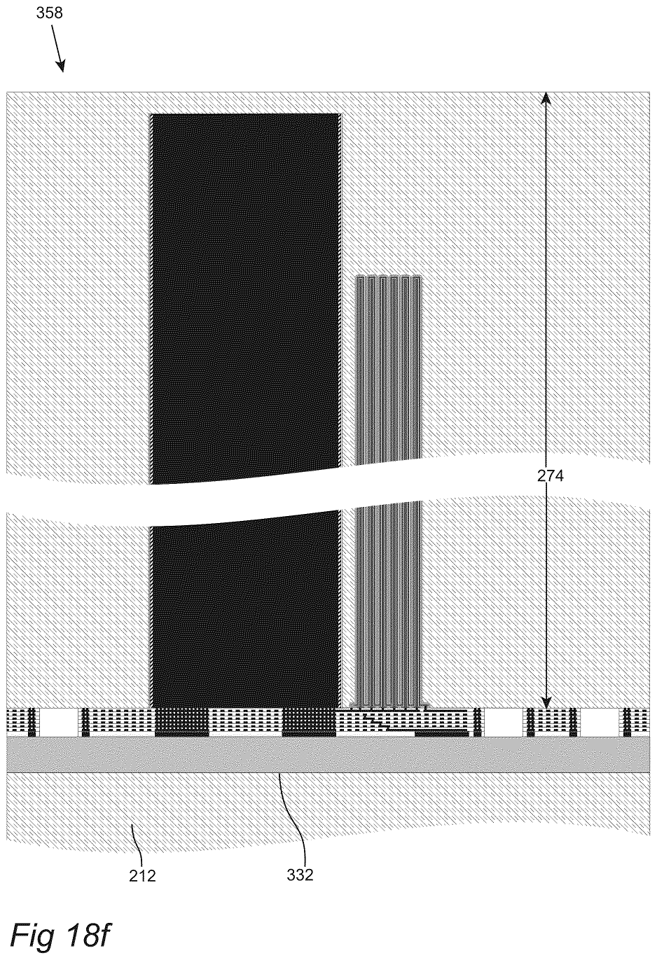

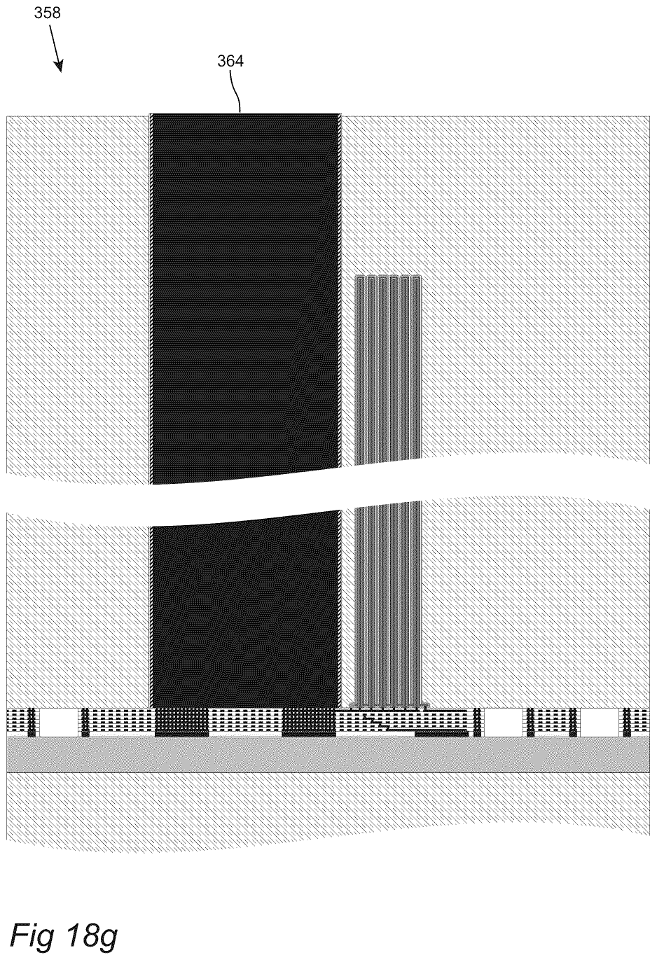

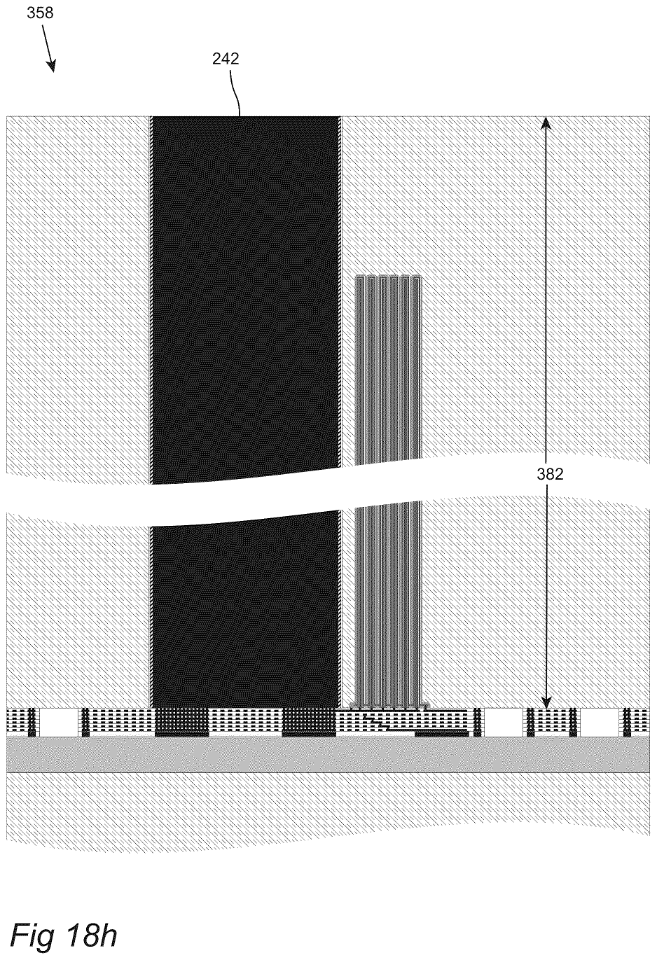

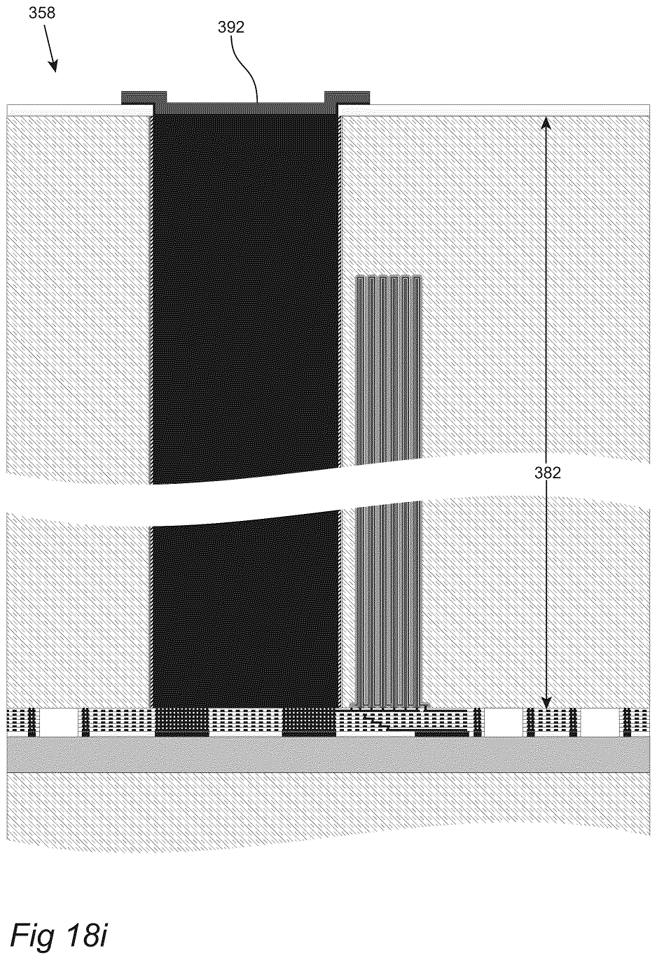

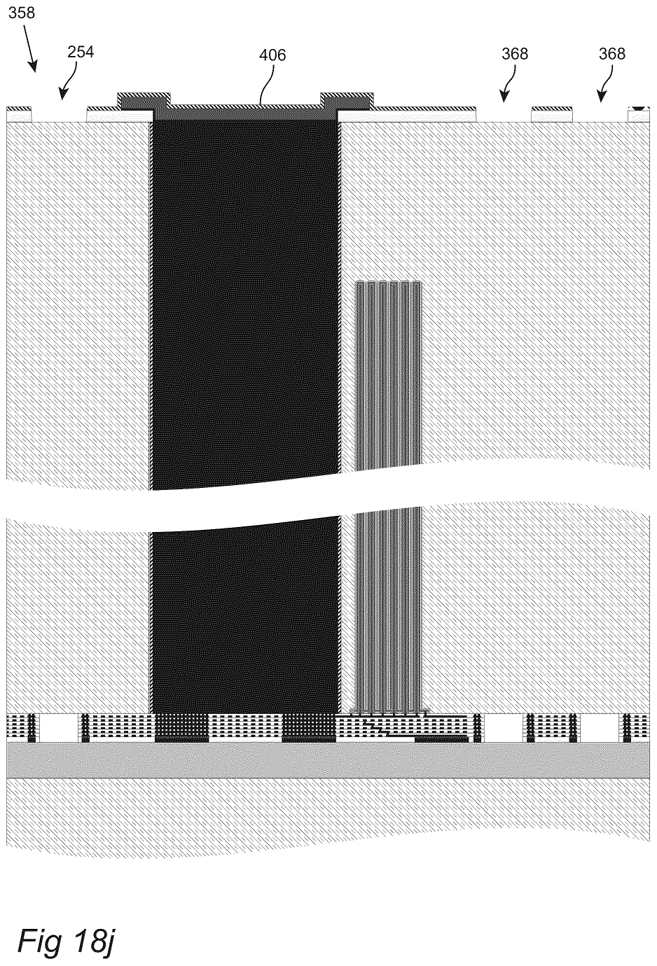

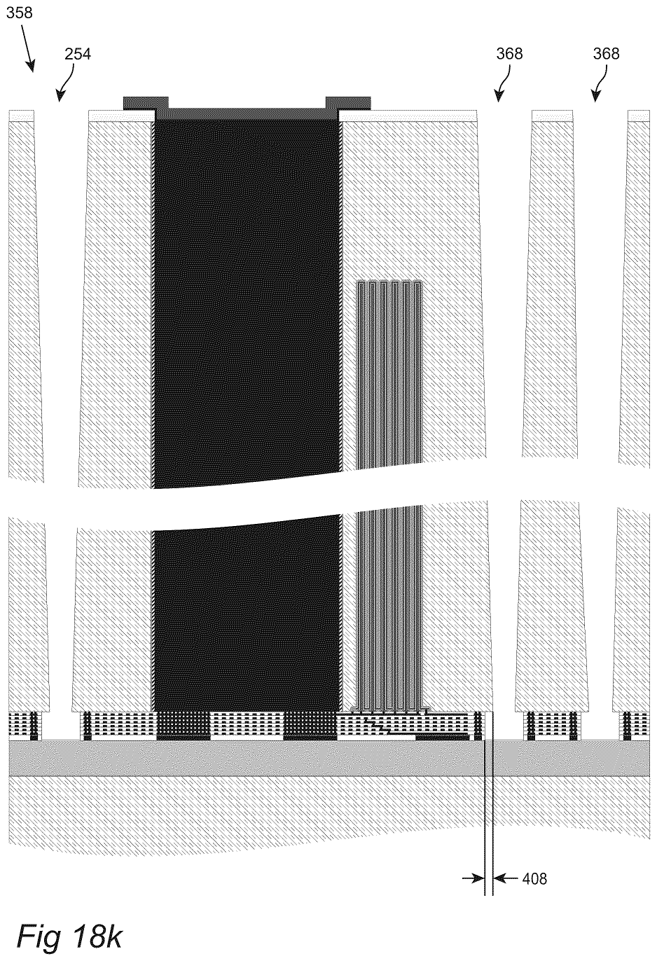

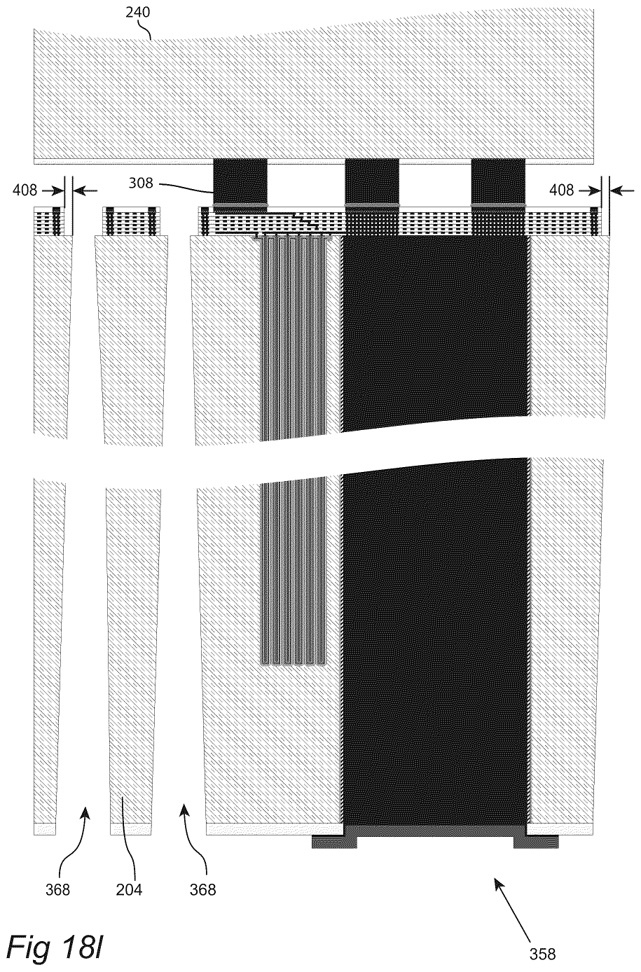

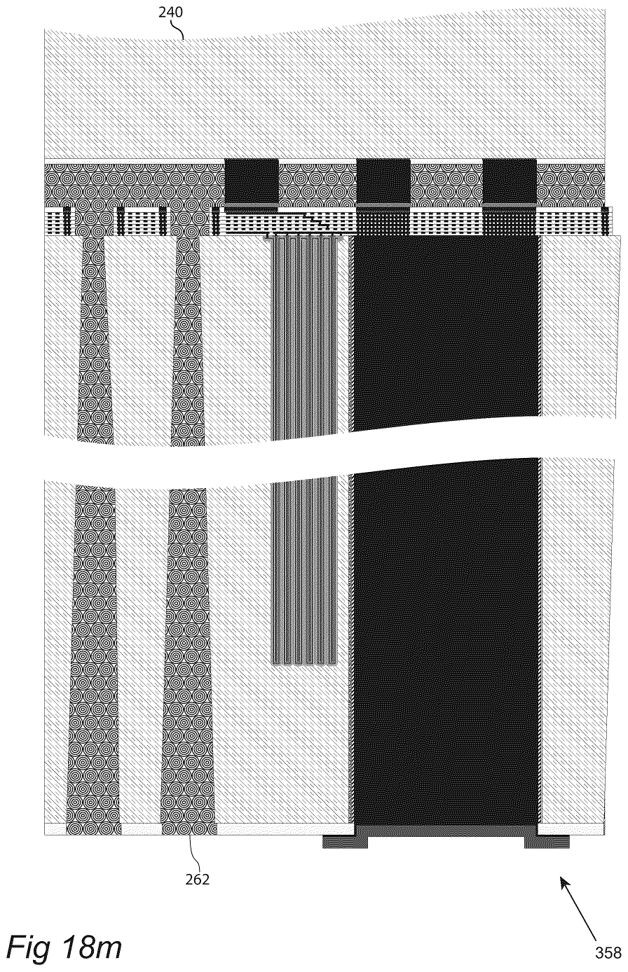

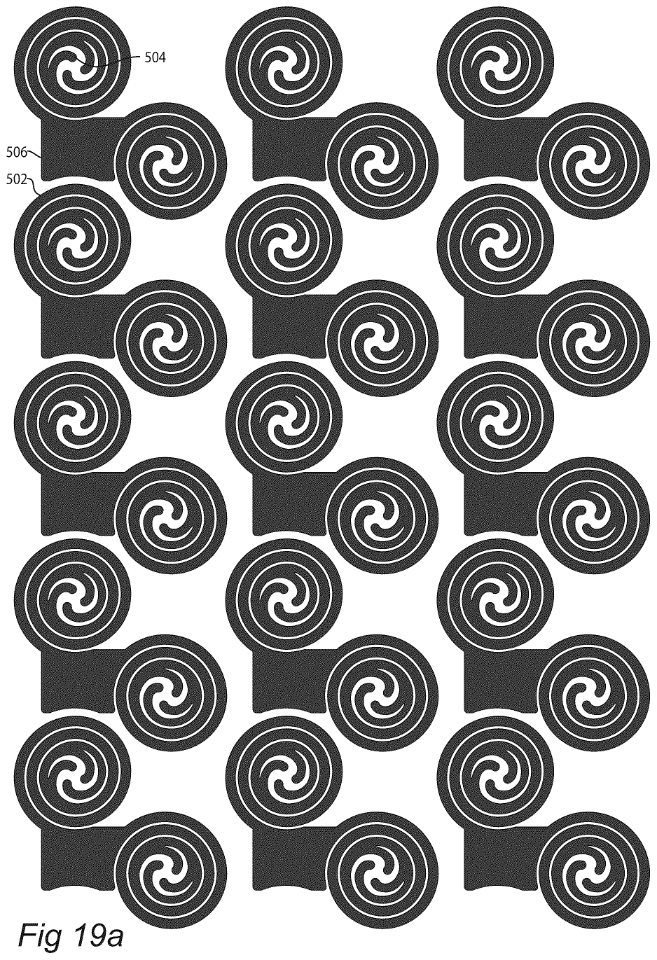

FIG. 18a shows an SCB cross section 358 after formation of the integrated DTC decoupling capacitors 284 in the wafer silicon 352. In practice, all areas of the wafer not used by other structures would be filled with decoupling capacitors 284 to obtain maximum capacitance with minimum parasitic inductance.

The formation of DTCs for power supply decoupling is a prior art process, available at TSMC (Taiwan Semiconductor Manufacturing Company, the world's largest semiconductor foundry) under the trademark iCAP. The process flow described above an estimate of TSMC's process flow and may not exactly match the actual process TSMC uses for iCAP.

The process for SCB decoupling capacitors varies from the TSMC iCAP process in that the capacitors may be nearly as deep as the full wafer thickness, which is typically 775 μm. This compares to less than 100 μm for iCAP DTCs in TSMC's trademarked chip-on-wafer-on-substrate (CoWoS-S) process, as CoWoS-S interposers are thinned to 100 μm, and wafer thinning must not reach the bottom of the blind holes etched for the capacitors. The extra potential depth of the decoupling capacitors can result in approximately 8 times the potential capacitance of iCAP DTC. However, in practice this extra capacitance is difficult to achieve, as the aspect ratio of the blind DTC holes would also need to be 8 times higher. Unless the aspect ratio can increase, the hole spacing at the surface of the wafer would need to increase, reducing the capacitance by the square of the increase in hole spacing. The ability to effectively use the extra available silicon depth to increase the capacitance of the decoupling capacitors requires extensive design of experiments (DoE) for optimization, which is beyond the scope of this process description.

Use a robust oxide/nitride stack (e.g., SiO₂/SiNₓ) to passivate trenches and spring roots before Cu-RDL plating. Ensure low pin-hole density and good adhesion to survive handling at full-thickness.

### TSV Formation

The through-silicon via (TSV) process requires precise control of etch depth to expose the copper-filled TSVs while maintaining wafer integrity. The starting substrate comprises 300 mm silicon wafers with total thickness variation (TTV) of 5 μm, providing a thickness range of 770-780 μm. The TSVs themselves are etched and filled at this stage, with the critical etch depth controlled to maintain a minimum 25 μm margin from the wafer surface in the thinnest possible wafer (770 μm), resulting in a maximum TSV depth of 745 μm.

The first step comprises ALD of an Al₂O₃ hardmask. The ALD process is conducted at 300° C. using trimethylaluminum (TMA) and water vapor as precursors, with a pulse/purge sequence of 0.1s/4s. The self-limiting nature of ALD provides precise thickness control through cycle counting, with each cycle depositing approximately 1.1 Å of Al₂O₃. A total of 910 cycles (62 minutes) produces the target thickness of 100 nm, which provides excellent etch resistance for the subsequent deep silicon etch. The Al₂O₃ hardmask can achieve extremely high selectivity due to the formation of a non-volatile AlFx layer during the Bosch process, with etch rates as low as 0.01 nm/min when using optimized passivation step timing (Drost et al, 2022).

Photolithography begins with hexamethyldisilazane (HMDS) vapor prime at 150° C., followed by application of positive photoresist to a thickness of 1.2 μm via spin coating at 3000 rpm for 30 seconds. The resist undergoes a soft bake at 110° C. for 60 seconds. The resist is then exposed using a photomask defining the TSV pattern of 50 μm diameter holes, with an exposure dose of 150 mJ/cm². Post-exposure bake at 110° C. for 60 seconds is followed by development in tetramethylammonium hydroxide (TMAH)-based developer for 45 seconds and deionized water rinse.

The hardmask is then etched using BCl₃/C₂ plasma in a 3:1 ratio, with 600 W ICP power and 100 W bias power at 5 mTorr pressure and 60° C. The etch process requires approximately 15 seconds, with endpoint detection via optical emission spectroscopy and a 10% overetch to ensure complete clearing of the Al₂O₃. The remaining photoresist is stripped using O₂ plasma at 800 W and 200° C. for 3 minutes, followed by appropriate wet cleaning steps.

DRIE using the Bosch process creates the TSV holes. The process alternates between SF₆ etch steps (600 W source, 100 W bias) and C₄F₈ passivation steps (600 W source, 0 W bias), with cycle times of 5 and 3 seconds respectively. Chamber pressure is maintained at 20 mTorr, with substrate temperature controlled between −20° C. and 20° C., achieving an etch rate of 5-10 μm per minute. Process variation is controlled through several factors: loading effects contribute approximately 1% variation (±7.7 μm), ARDE effects result in up to 2% variation (±15.4 μm), temperature-induced variation is controlled to less than 0.5% (±3.9 μm), and chamber symmetry effects contribute approximately 1% (±7.7 μm).

Following the deep etch, thorough cleaning removes fluorocarbon polymers using 02 plasma at 1000 W for 10 minutes, followed by wet cleaning steps including hot piranha clean, deionized water rinse, dilute HF dip, and final rinse. The Al₂O₃ hardmask is then removed using 2.38% TMAH at room temperature for 2 minutes, followed by deionized water rinse and spin dry. This room-temperature TMAH process provides controlled removal of the hardmask using standard fab equipment and chemicals.

FIG. 18b shows the SCB cross section 358 after DRIE of blind holes for large diameter power and ground TSVs. An example DRIE etched hole for power or ground TSV 250 is shown. Due to the vastly different scales of features in the entire SCB assembly, only one TSV is shown. If the TSVs are 50 μm in diameter, and 100 μm pitch, a 300 mm wafer can fit approximately 7 million TSVs. A WSSCB may have several million TSVs in practice. The power/ground or slow signal TSV is surrounded by the TSV dielectric and stress relief linings.

A thermal oxide (SiO₂) is then grown at 950-1000° C. to a thickness of 1-2 μm, providing the primary dielectric isolation layer for the TSVs.

A stress-relief polymer layer, for example benzocyclobutene (BCB), is applied using spray coating equipment specialized for deep hole coverage. Multiple thin coats are applied with intermediate vacuum processing steps, followed by a final cure at 250° C., achieving a target thickness of 2-3 μm.

The conductive barrier and seed layers are deposited in two steps. First, a titanium nitride (TiN) barrier layer is deposited using metal-organic chemical vapor deposition (MOCVD) at 350-400° C. to a thickness of 50-100 nanometers, providing excellent conformality. This is followed by Cu seed layer deposition using enhanced-ionization PVD with RF bias for directional deposition, achieving a thickness of 200-300 nanometers.

Copper electroplating fills the TSVs using a three-component additive system comprising suppressor (polyethylene glycol-based), accelerator (sulfopropyl-based), and leveler compounds. The current density is ramped from an initial 0.5 ASD through main fill at 1.5-2 ASD, concluding at 1 ASD. The plating bath is maintained at 22-24° C. throughout the process.

Post-plating cleaning comprises deionized water rinse and dilute H₂SO₄ clean. The wafer then undergoes a two-step chemical-mechanical planarization process, beginning with bulk copper removal at high pressure and speed, followed by final polish at reduced pressure and speed. Optical endpoint detection ensures proper planarization to the original wafer surface.

Final cleaning steps include brush scrub cleaning, deionized water rinse, surface inspection, and ionic contamination testing.

Thermal cycling induces Cu microstructure evolution and vertical extrusion in TSVs. Control grain texture and heating rates during anneal to minimize pumping. (Zhang et al., 2018)

FIG. 18c shows the SCB cross section 358 at this processing stage. The power/ground or slow signal TSV 320 is surrounded by the TSV dielectric and stress relief linings 321.

### Formation of the RDL

The redistribution layer (RDL) formation process begins with the first-level interconnect layer connecting to the TSVs and decoupling capacitor structures. A silicon dioxide dielectric layer is deposited using PECVD at 350-400° C. to achieve a thickness of 2.0±0.2 μm. The deposition parameters maintain tensile stress below 100 MPa in the deposited film.

The first-level metallization employs a dual-damascene process creating both the contact via arrays and the redistribution traces in a single metal fill operation. Use dual-damascene or plated Cu with Ti/Ta barriers. (Semiconductor Packaging News, 2025; Amkor, 2020).

Contact openings are patterned as arrays of 0.5 μm diameter vias. For TSV contacts, there are many vias covering the TSV top surface. There may be as many as 1,800 vias, assuming 0.5 μm vias at a 1 μm pitch, on top of a 50 μm TSV. However, there will typically be many fewer, to allow for signal routing above the TSV, between power connection via and metal layer stacks. For decoupling capacitor polysilicon contacts, redundant vias are implemented. The via arrays provide redundancy in the contact structures while maintaining compatibility with subsequent RDL design rules.

Ar sputter cleaning is performed at 200-300 W RF bias power for 60 seconds. The SCB wafer is immediately transferred to the PVD chamber under N₂ purge to prevent native oxide formation.

The barrier and seed layers are then deposited. TSV and polysilicon decoupling contacts receive a stack of 30 nm Ti, 30 nm TiN, and 150 nm Cu seed layer.

Copper electroplating employs a bottom-up fill process with current density ramping from 0.5 to 1.5 ASD, conducted at 22±1° C. The plating continues until achieving 2 μm of overburden above the field areas. Post-plating anneal is performed at 150° C. for 30 minutes in N₂ atmosphere, using a controlled ramp rate of 3° C./minute.

The copper overburden is removed using a two-step CMP process, comprising initial bulk removal followed by fine polishing, with optical endpoint detection ensuring proper planarization.

Perform inspection and repair using an automated FIB circuit edit machine. Bridging short circuits can be repaired by ion beam sputtering. Open circuits can be repaired by using a focused beam of ions (typically Ga) to deposit conductive material (typically Pt or W)

Five subsequent redistribution layers are formed using a consistent process flow. For each layer deposit 2-4 μm of low-k dielectric, such as SiCOH using PECVD.

This is followed by a standard copper dual damascene process with a minimum line width and spacing of 0.5 μm at 1 μm pitch. This involves mask layers for vias and lines, both of which are stitched over the wafer, as an SCB is typically larger than the mask reticle, and a WSSCB is the size of the entire wafer.

These RDL layers are specifically designed to provide the high-density routing required for HBM4 and UCIe 2.0 connections, or subsequent versions of HBM and UCIe. The design incorporates redundant signal routing paths to enhance both manufacturing yield and operational fault tolerance.

Irrespective of the fault tolerance, each layer is automatically inspected and repaired using FIB circuit edit. Wafer scale WSSCBs are critical components of very high value systems and would likely have zero yield without extensive fault tolerance and intensive inspection and repair.

FIG. 18d shows the SCB cross section 358 at this processing stage. The RDL 328 is formed on the top surface of silicon 352. The RDL 328 contains multiple layers of signal lines 344. Almost all the signal lines 344 are shown end-on, as lines going into the page rather than across it. Here six layers of signal lines 344, at 0.5 μm at 1 μm pitch are shown, though the number of layers may vary depending on the application.

The ground planes between signal lines are not shown. If the SCB uses 6 individual signal layers, then 5 ground planes are required. If the SCB uses paired signal layers for redundancy, then only two ground planes are required (one between each of the 3 pairs of signal planes).

A signal microbump landing pad 348 is shown, connected to signal lines 344. A power or ground microbump landing pad 324 is shown on top of a stack of metal layers and arrays of vias connecting to the TSV 320. An edge seal 402 is shown on each side of the SCB edge region 254 and the spring gap regions 368 of the RDL 328. The wafer is still at the full wafer thickness 274.

Power distribution is accomplished through vertical stacks of metal aligned with power-designated TSVs, connected by dense arrays of copper-filled vias between adjacent metal layers. This approach provides low-resistance power delivery while maintaining redundancy through multiple parallel paths.

The final layer includes landing pad formation for microbump attachment. A 10 μm thick dielectric layer is deposited, and 50×50 μm pad regions are opened. The pad metallization consists of 3.0 μm Ni—P, 0.1 μm Pd, and 0.3 μm Au, maintaining surface roughness below 0.3 μm RMS.

If the wafer is to be an entire WSSCB, it is not singulated into individual SCBs, so there are no SCB edges in the mask set.

### Etch of the RDL Stack for the SCB Edges and Spring Gaps

The RDL stack etch process begins with the deposition of a TiN hardmask on the completed RDL stack. The TiN is deposited using PECVD at 350-400° C. to achieve a thickness of 250 nm. The deposition uses N₂/TiCl₄ chemistry at 1-2 Torr chamber pressure, achieving a deposition rate of approximately 2 nm/second.

Photolithography begins with HMDS vapor prime at 150° C. An ArF photoresist is applied at 3000 rpm to achieve 200 nm thickness, followed by a soft bake at 110° C. for 60 seconds. The resist is exposed using an ArF scanner (193 nm) at 30 mJ/cm². After a post-exposure bake at 110° C. for 60 seconds, the resist is developed in standard ArF TMAH developer for 30 seconds, followed by deionized water rinse and spin dry at 2000 rpm for 30 seconds.

The hardmask pattern is transferred using a Cl₂/BCl₃ plasma etch in equal ratio, with 400 W source power and 100 W bias power. The chamber pressure is maintained at 5 mTorr with 60 sccm total flow rate and platen temperature at 60° C. The etch requires approximately 60 seconds with endpoint detection on the underlying oxide. The remaining photoresist is stripped using O₂ plasma at 800 W and 300 mTorr pressure, with 1000 sccm O₂ flow at 250° C. for 2 minutes.

The main dielectric stack etch employs a single high-aspect-ratio anisotropic etch using CF₄/CHF₃/Ar plasma in a 45:45:10 ratio. The etch uses 2000 W source power and 200 W bias power at 10 mTorr pressure with 120 sccm total flow rate. The platen temperature is maintained at 15° C. At an expected etch rate of approximately 400 nm/minute, an initial timed etch of 54 minutes removes 90% of the target depth.

Endpoint detection employs multiple methods. Primary monitoring uses in-situ interferometry through endpoint windows incorporated in the empty corners of the SCB array. This is supplemented by RF bias voltage monitoring for silicon interface detection and periodic depth measurements using automated profilometry on the corner sites. After endpoint confirmation, a 10% timed overetch ensures complete clearing to the silicon surface. Total process time is around 65 minutes.

The hardmask is removed using SC1 clean (NH₄OH:H₂O₂:H₂O in 1:1:5 ratio) at 65° C. for 10 minutes, followed by deionized water rinse for 5 minutes and spin dry at 2000 rpm for 30 seconds.

Quality control includes optical microscope inspection of spring gaps and edges, profilometer measurement of etch depth in corner regions, scanning electron microscope (SEM) inspection of sidewall profile, and surface roughness measurement of exposed silicon.

The result of this process is shown in FIG. 18e, where the RDL 328 has been completely removed in the SCB edge region 254 and the spring gap regions 368, exposing the underlying silicon.

Because the SCB remains near full thickness, standard 300 mm handling is preferred. Use edge chamfers and polymer edge coats to suppress chipping during spring formation and subsequent handling.

### Inversion and Attachment to a Handle Wafer

This process begins with preparation of a prime grade 300 mm silicon handle wafer of standard 775 μm thickness, chosen for compatibility with automated wafer handling equipment. The handle wafer undergoes a thorough cleaning using a sulfuric peroxide mixture (H₂SO₄:H₂O₂=4:1) at 120° C. for 10 minutes, followed by deionized water rinse and spin dry. A dehydration bake at 200° C. for 5 minutes ensures complete removal of moisture.

A thermal release adhesive is applied to the handle wafer using spin coating. The adhesive is dispensed at 500 rpm for 5 seconds, then spread at 1500 rpm for 30 seconds to achieve a target thickness of 20 μm. Edge bead removal is performed using edge solvent dispense to ensure uniform adhesive thickness across the wafer. The adhesive undergoes a soft bake at 110° C. for 2 minutes to remove solvents and stabilize the film.

The SCB wafer surface is prepared using a mild O₂ plasma ash at 200 W for 30 seconds, carefully controlled to avoid damage to the exposed metal pads. This is followed by a dehydration bake at 200° C. for 5 minutes to ensure optimal bonding conditions.

The bonding process employs a specialized wafer bonding system with dual bond chucks. The handle wafer is loaded on the bottom chuck with the adhesive side up, while the SCB wafer is loaded on the top chuck facing downward. The wafers are aligned using an infrared alignment system with center alignment tolerance of 100 μm and angular alignment tolerance of 0.01°.

Initial contact between the wafers is made at the center under vacuum conditions. A uniform pressure of 0.3 MPa is applied across the wafer pair, and the temperature is ramped to 180° C. at 20° C./minute. The temperature and pressure are maintained for 3 minutes to ensure complete adhesive bonding. The bonded pair is then cooled to 40° C. while maintaining pressure, after which the vacuum is released and the bonded pair is separated from the bond chucks.

Quality control measures include acoustic microscopy inspection for void detection, infrared inspection for alignment verification, and edge inspection for adhesive overflow. The total thickness variation is measured, and bond strength is verified using calibrated pull tests on dummy samples processed under identical conditions.

FIG. 18f shows the SCB cross section 358 after inversion and attachment to the handle wafer 212 using the thermal release adhesive 332. The RDL and landing pad structures are now facing downward against the adhesive layer, while the backside of the silicon substrate of the SCB is exposed for subsequent processing steps.

At around 710 μm wafer thickness, it may be thought that the wafer can be handled free-standing. However, handle wafers are required as the silicon spring etch leaves islands of silicon that are connected by highly compliant springs. If it were not attached to a handle wafer, the WSSCB wafer would be “floppy” at the end of the silicon springs DRIE Bosch etch, and would not be able to be handled by wafer robots or transported in FOUPs. An SCB wafer would already be singulated, so could not be handled as a wafer.

### Exposure of the TSVs

The TSV exposure process begins with plasma etching of the silicon substrate to expose the copper-filled TSV structures. Backgrinding is intentionally omitted to eliminate mechanical stress on the wafer. The plasma etch employs SF₆/O₂ chemistry in an 80:20 ratio with 2,000 W source power and 30 W bias power, the latter kept intentionally low to minimize surface damage. Chamber pressure is maintained at 20 mTorr with 100 sccm total flow rate, while platen temperature is regulated at 15° C.

The etch targets a removal depth of 30 μm, to a level slightly beyond the TSV tips, with an expected etch rate of 2 μm/minute. Endpoint detection employs both optical emission spectroscopy for copper signal detection and RF bias voltage monitoring, with the regular array of TSVs providing a strong endpoint signal. The total etch time is approximately 15 minutes, including a brief overetch to ensure complete copper exposure.

The result of this process is shown in FIG. 18g, depicting SCB cross section 358 with a slightly protruding TSV 364.

### CMP of Back-Side of Wafer

Following the plasma etch, chemical mechanical planarization (CMP) employs a non-selective silica-based slurry with 2 psi down force. Platen and carrier speeds are set to 60 and 57 rpm respectively, with slurry flow maintained at 200 mL/minute. The CMP process continues for 35 μm (approximately 30 seconds) to achieve less than 50 nm step height between copper and silicon surfaces. Post-CMP cleaning utilizes PVA brush scrub followed by deionized water rinse and spin dry.

Quality control measurements include surface profilometry for co-planarity verification, optical microscopy for TSV exposure confirmation, AFM measurement of surface roughness, four-point probe testing for TSV electrical continuity, and cross-section SEM analysis of test structures.

The result of this process is shown in FIG. 18h, depicting the SCB cross section 358 with an exposed and planarized TSV 242 with minimal topography between copper and silicon surfaces. The final SCB thickness 382 remains approximately 710 μm, providing robust mechanical stability for subsequent handling steps.

The exact 710 μm thickness is not important—if previous processing variations allow, the CMP depth may be reduced, leaving the final SCB thickness greater than 710 μm.

### Dielectric Layer Deposition and Etch

A PECVD process deposits a silicon oxynitride (SiON) dielectric layer. The thickness of this layer is around 2 μm, optimized for dielectric isolation of the TSV connections. The deposition occurs at 350° C. with a base deposition rate of 80 nm/minute, using SiH₄, N₂O, and NH₃ as precursor gases. Chamber pressure is maintained at 3 Torr with 500 W RF power. While stress control through NH₃/N₂O ratio adjustment remains important for film integrity, the >700 μm silicon substrate thickness means this layer does not significantly influence wafer bow from RDL stress on the opposite side.

Photolithographic patterning of the dielectric layer begins with HMDS vapor prime, followed by application of thick positive photoresist. The resist thickness is 3 μm, with spin speed adjusted accordingly. The resist undergoes soft bake at 110° C. for 90 seconds. Exposure dose is 300 mJ/cm², followed by post-exposure bake at 110° C. for 90 seconds. Development uses TMAH-based chemistry for 90 seconds.

The dielectric etch employs CF₄/O₂/CHF₃ chemistry at 50 mTorr pressure, with 800 W ICP power and 200 W bias power. O₂ flow is adjusted to control sidewall profile. The etch rate approximates 200 nm/minute, with endpoint detection via optical emission spectroscopy and 10% overetch. Resist removal uses O₂ plasma at 800 W and 200° C., followed by wet cleaning.

### UBM Formation

Under-bump metallization (UBM) begins with in-situ sputter clean using Ar plasma at 300 W for 60 seconds at 5 mTorr. The UBM stack is deposited sequentially without breaking vacuum, comprising Ti adhesion layer (50 nm, 1000 W DC power, 3 mTorr), Ni barrier layer (500 nm, 1500 W DC power, 3 mTorr), and Au finish layer (100 nm, 1000 W DC power, 3 mTorr).

UBM patterning employs 4 μm thick positive photoresist, processed with soft bake at 110° C. for 90 seconds, exposure at 250 mJ/cm², post-exposure bake at 110° C. for 90 seconds, and TMAH-based development for 90 seconds. Ion beam etching at 500 V beam voltage and 300 mA beam current, with 750 angle and stage rotation, removes the metal stack. Etch times are approximately 2 minutes for Au, 8 minutes for Ni, and 1 minute for Ti, with endpoint detection for each layer.

Post-etch cleaning comprises O₂ plasma ash followed by wet clean sequence of acetone rinse, IPA rinse, and deionized water rinse. Final clean uses mild O₂ plasma followed by deionized water rinse and N₂ dry.

Quality control measurements include film stress at multiple process steps, physical measurements via profilometry, X-ray fluorescence, and scanning electron microscopy of test structures, and electrical testing for dielectric breakdown, TSV-to-UBM continuity, and isolation resistance.

Where CGA pillars are used for vertical card attach, design pad metallization and keep-out zones to accommodate column sway. Follow high-reliability CGA assembly guidelines (solder alloy, column geometry, underfill or staking as appropriate) and thermal-cycle screening per NASA/JPL data. (Ghaffarian, 2012a; 2012b).

The result of this process is shown in FIG. 18i, depicting the SCB cross section 358 with UBM 392. The final SCB thickness 382 remains approximately 710 μm.

### Hardmask and Passivation Etch for Spring Gaps and Edges

The process for forming the spring gaps and SCB edges proceeds through selective etching utilizing a hardmask. The hardmask provides etch resistance for both the dielectric removal and subsequent deep silicon etching, while design considerations ensure robust interface formation between layers.

The process begins with ALD of an Al₂O₃ hardmask layer. The ALD process is conducted at 300° C. using TMA and H₂O vapor as precursors, with a pulse/purge sequence of 0.1s/4s. The self-limiting nature of ALD provides precise thickness control through cycle counting, with each cycle depositing approximately 1.1 Å of Al₂O₃. A total of 910 cycles (62 minutes) produces the target thickness of 100 nm, which provides sufficient etch resistance for both the dielectric etch and subsequent deep silicon etch, given the extremely high selectivity of Al₂O₃ to the Bosch process (Drost et al., 2022).

A TiN hardmask is deposited on the on the Al₂O₃ hardmask to protect the Al₂O₃ during back-side dielectric etch. The TiN is deposited using PECVD at 350-400° C. to achieve a thickness of 100 nm. The deposition uses N₂/TiCl₄ chemistry at 1-2 Torr chamber pressure, achieving a deposition rate of approximately 2 nm/second.

Photolithography begins with HMDS vapor prime at 150° C., followed by application of positive photoresist to a thickness of 1.2 μm via spin coating at 3000 rpm for 30 seconds. The resist undergoes a soft bake at 110° C. for 60 seconds. The resist is then exposed using a photomask defining the spring gaps and SCB edges, with an exposure dose of 150 mJ/cm². The TiN hardmask is used to pattern the etch of the Al₂O₃ hardmask and the back-side dielectric.

Post-exposure bake occurs at 110° C. for 60 seconds, followed by development in TMAH-based developer for 45 seconds and deionized water rinse.

The hardmask stack is patterned using a Cl₂/BCl₃ plasma etch in equal ratio, with 600 W ICP source power and 100 W bias power. The chamber pressure is maintained at 5 mTorr with 60 sccm total flow rate and platen temperature at 60° C. The etch requires approximately 40 seconds with endpoint detection on the underlying oxide via optical emission spectroscopy, and a 10% overetch to ensure complete clearing of the Al₂O₃.

With the photoresist still in place, the 2 μm SiON dielectric layer is etched using CF₄/O₂/CHF₃ chemistry at 50 mTorr pressure, with 800 W ICP power and 200 W bias power. The O₂ flow is adjusted to achieve vertical sidewalls. The etch rate approximates 200 nm/minute, resulting in a total etch time of approximately 10 minutes. Endpoint detection via optical emission spectroscopy ensures complete removal of the dielectric layer, with a 10% overetch.

Following the dielectric etch, the photoresist is stripped using O₂ plasma at 800 W and 200° C. for 3 minutes, followed by appropriate wet cleaning steps. The removal of photoresist at this stage, rather than retaining it for subsequent processing, reduces organic contamination in the DRIE chamber used for the following process steps. This cleaning choice is enabled by the excellent selectivity of the Al₂O₃ hardmask, which alone is sufficient for the subsequent deep silicon etch.

The process includes inspection steps following the dielectric etch to verify pattern transfer and critical dimensions. Alignment of the pattern to the opposite side of the wafer is verified within standard backside alignment tolerances, with the RDL design rules accommodating normal alignment variations. This approach ensures reliable spring formation without requiring exceptionally tight alignment control.

FIG. 18j shows the SCB cross section 358 after these process steps. The hard mask 406 is shown with exaggerated thickness around 20 times the actual thickness. A 100 nm hardmask layer would not be visible on the scale of this cross section. The locations for the dielectric layer etch for the SCB edge 254 and the spring gaps 368 are shown. RDL-silicon indent

The pattern dimensions in this back-side mask are designed so that the spring gap and edge patterns are wider in the RDL etch than the final width at the bottom of the back-side of the deep silicon trench, accounting for maximum expected alignment variation and DRIE process variation.

This results in an RDL-silicon indent of approximately 10 μm. The exact amount is not critical, as long as there is no overhang of the RDL layers over the silicon.

The larger the RDL-silicon indent is, the less room there is for signal lines in the RDL layers of springs. Since large numbers of signal lines for HBM4 signals and UCIe 2.0 signals cross the springs, the RDL-silicon indent should not be excessively wide.

This design approach eliminates potential stress concentrators that could occur from RDL overhang into the spring gaps.

### Spring Gap and SCB Edge Etch

The spring gap and SCB edge formation process utilizes DRIE to create high-aspect-ratio trenches through the silicon substrate. The process benefits from trench geometry, where features exceed 100 μm in length, enabling aspect ratios of 100:1 or greater. This geometric advantage, compared to circular hole features, allows for more efficient material transport and enhanced etch performance. Minimum trench widths are maintained at around 8 μm to achieve controlled high-aspect-ratio etching.

The DRIE process employs a modified Bosch process optimized for deep trench etching. The chamber is maintained at −20° C. with backside helium cooling at 10 Torr pressure. The process alternates between etch and passivation cycles at 15 mTorr chamber pressure, optimized for deep trench penetration. During the etch cycle, SF₆ plasma is generated using 800 W source power and 120 W bias power for a duration of 6 seconds. The subsequent passivation cycle utilizes C₄F₈ chemistry with 600 W source power and no bias power for 2.5 seconds, with the reduced passivation time reflecting the enhanced transport characteristics of trench geometry.

The etch proceeds at 8-12 μm per minute, significantly faster than comparable hole etching processes, resulting in a total process time of 70-90 minutes. In-situ monitoring employs laser interferometry for depth tracking, while optical emission spectroscopy provides primary endpoint detection. The endpoint detection system monitors silicon etch products and detects interaction with the underlying thermal release adhesive layer, providing a clear signal of etch completion. Secondary endpoint verification utilizes laser interferometry signal changes, chamber pressure variations, and RF bias voltage shifts.

Process control focuses on maintaining vertical or slightly positive sidewall profiles, which can affect spring mechanical characteristics, and must meet the RDL etches to ensure there is no overhang of the RDL layer. The ion angular distribution is monitored and controlled through process parameters to achieve the desired profile. Particular attention is paid to minimizing sidewall scalloping, especially on spring surfaces where mechanical properties are relevant.

Upon initial endpoint detection, the etch continues for an additional 20 seconds to ensure complete pattern transfer through local variations in etch rate. The process concludes with a chamber clean cycle to remove adhesive interaction products and maintain process stability.

Quality control measurements include scanning electron microscopy inspection of spring profiles, trench width measurements, verification of RDL-silicon indent maintenance, sidewall angle measurement, and scallop size quantification. Particular attention is paid to detecting any micro-masking effects that could impact spring mechanical properties. The mechanical integrity of formed springs undergoes verification through appropriate test structures, which may be placed in the otherwise empty processor array corners.

The resulting structures exhibit clean, vertical profiles with controlled dimensions, enabling reliable spring operation and precise SCB edge definition. The process achieves complete wafer penetration while maintaining critical feature dimensions and avoiding RDL interaction.

FIG. 18k shows the SCB cross section 358 after spring gap 368 and SCB edge 254 through-silicon etches. The RDL-silicon indent 408 is shown.

Release from Handle Wafer, with No Dicing Step

The release process utilizes a temperature-controlled vacuum chuck with multi-zone heating capability to ensure uniform temperature distribution across the handle wafer. The chuck temperature increases at a controlled rate until reaching the adhesive release temperature of 150° C. The temperature maintains at this point for 60 seconds, with uniformity controlled to ±5° C. across the wafer surface. Force sensors monitor the adhesive state transition, providing verification of proper release conditions.

Following removal from the handle wafer, the WSSCB or singulated SCBs undergo a three-stage cleaning process to remove all adhesive residue. The initial stage employs a thermal adhesive removal solvent at 50° C. for 5 minutes with 40 kHz ultrasonic agitation. This solvent may vary according to the specifications of the manufacturer of the thermal release adhesive. A secondary cleaning stage consists of sequential 2-minute rinses in isopropyl alcohol and deionized water, followed by nitrogen drying. The final cleaning stage utilizes an O₂/Ar plasma at 200 W power and 200 mTorr pressure for 2 minutes, ensuring complete removal of any organic residues.

Quality control measures include visual inspection for adhesive residue and potential spring damage, along with surface cleanliness verification. Metrology steps verify final thickness, measure any warpage, and confirm spring and spring gap dimensions remain within specification. The process maintains traceability for each WSSCB or SCB, recording release yield data and cleaning effectiveness for each wafer processed.

This release and cleaning sequence completes the fabrication process, producing individual WSSCBs or SCBs ready for subsequent test and assembly operations. The process requires no additional dicing steps, for either a WSSCB, or a wafer with many individual SCBs. Any individual SCBs achieved full separation during the previous deep silicon etch process, simplifying handling and reducing the potential for damage to critical features. The use of through wafer silicon etch for singulation also allows irregular configurations of WSSCBs on a single wafer, which could not be singulated with a wafer saw. Singulating the wafer using the spring gap etch also results is less overall processing, cleaning, and yield loss.

A WSSCB has no etched SCB edges. Otherwise, the processing of a WSSCB and a wafer with many individual SCBs is essentially the same.

### WSSCB Functional Test

Passive systems of interconnects create a problem for testing, as there can be no JTAG or BIST circuits. An WSSCB wafer will typically have on the order of 20 million ultra-short reach (USR) wires in its RDL layer, being mostly HBM4 signal connections and UCIe 2.0 connections. These ~20 million USR wires will have ~40 million end points, connected to microbump landing pads. Although the wires have fault tolerance, and WSSCB is optically inspected and repaired at each RDL layer, the WSSCB should still be thoroughly tested, as the value of chips attached to a single wafer scale WSSCB—up to around 172 HBM4 memory stacks, and 172 logic stacks—can be significant. However, existing ATE is poorly suited for testing wafer scale passive structures such as the WSSCB. There are several problems:

The WSSCB cannot help with the testing of its ~20 million USR wires. With no JTAG or BIST, each wire must be tested individually for open or short circuits.

The microbump landing pads are small and high density (large arrays of 28 μm pads at 73 μm pitch for HBM3 and HBM4), making conventional probes unsuitable.

If there are only hundreds of probes on the test card, and a probe card lasts 1 million touchdowns, the probe card will wear out after only 10 wafers or so.

The ATE equipment is ‘overkill” for the application. The testing of a passive WSSCB does not need extremely fast ATE electronics with millions of test vectors.

### WSSCB Testing

The WSSCB testing process employs a specialized micro electromechanical systems (MEMS) test probe chip to enable simultaneous testing of all signal connections within each SCB module position. This probe chip, and the testing methodology is described in a subsequent section.

### Chip Attach

The chip attachment process for the WSSCB follows established microbump attachment procedures while accommodating multiple chip types and configurations. The process utilizes conventional thermal compression bonding techniques for microbump connections.

HBM4 and logic stacks are attached to the “go” positions identified during WSSCB testing. All chips maintain identical orientation to ensure consistent thermal and mechanical characteristics across the array.

Any “no-go” positions identified during testing are populated with physical dummy HBM stacks and passive RDL dummy logic stack chips. These dummy components maintain the mechanical and thermal uniformity of the array while providing signal bypass functionality through the passive RDL connections.

If the extensive fault tolerance of the WSSCB leads to sufficient yield so that any WSSCB with “no go” positions can be discarded, then the dummy chip stacks are not required, and don't need to be developed.

The WSSCB architecture supports varied logic stack configurations within a single array while maintaining a standardized BID interface between the logic stacks and WSSCB.

The CPU modules in this configuration handle high-speed computations not suitable for the main array, as commonly required in CPU-GPU systems for AI inference.

This flexibility extends to future implementations, where arrays of chips on a single WSSCB design can become increasingly varied and application-specific as new compatible logic stacks are developed.

The CPU stacks do not need to be leading edge. They only need to provide adequate compute power to load data to the main TRIMERA array, for transformer inference, and to provide associated computation that is not suitable for the main array.

The attachment process employs precision placement equipment with the following capabilities:
Placement accuracy: ±1 μm
Angular alignment: ±0.01°
Temperature control: ±2° C. across the attachment region
Force control: ±2% of target force

This level of precision ensures reliable microbump connections while preventing damage to the underlying WSSCB structure or the chips being attached.

Quality control measures include:
Real-time force and temperature monitoring
Post-attachment X-ray inspection
Electrical verification of attached components

The chip attachment process maintains consistent quality across all array configurations while accommodating the flexibility inherent in the WSSCB architecture, enabling diverse system implementations using standardized manufacturing processes.

FIG. 18l shows the SCB cross section 358 after chip attach of chip stacks 240. The chips copper pillar microbumps 308 provide the solder for the microbumps, and the SCB has the landing pads. A cross section of a silicon spring 204 with a spring gap 368 on either side is shown. The RDL-silicon indents 408 at the spring gap and SCB edges are shown.

### Underfill May not be Required

The purpose of the underfill is to keep contaminants out of the ZettaLith structure. It is not required (in fact, slightly counterproductive) for mechanical stability or heat conduction. If the coolant and operating environment of ZettaLith is sufficiently clean, an underfill should not be required.

### Underfill (if Required)

The SCB underfill process represents a significant departure from conventional underfill methods, both in materials and application technique. Traditional underfill processes employ high modulus epoxy polymers to distribute mechanical and thermal expansion stresses between chips and substrates. These materials and their application methods are unsuitable for the SCB for several reasons.

First, conventional high modulus underfills would interfere with the mechanical function of the silicon springs, which are designed to provide stress relief between chips and substrate. The springs function most effectively when not constrained by rigid materials.

Second, conventional underfill dispensing equipment, designed for individual chip attachment, becomes impractical for the SCB's array of closely-spaced chips. The standard process of dispensing underfill along chip edges and allowing capillary flow would require multiple transfers between chip attach and underfill equipment as each ring of chips is attached from the center outward. This would significantly increase handling of the high-value populated SCB and reduce manufacturing throughput.

Third, the complex geometry of the SCB, with its network of silicon springs and narrow gaps between chips, makes conventional edge dispensing complex and unreliable, as it could lead to void formation and incomplete filling of the spring structures.

These challenges are addressed by a fundamentally different (and far simpler) approach: dipping the populated SCB into a bath of low modulus elastomeric underfill material. This simple solution eliminates the complexity of edge dispensing and ensures complete filling of all spaces within the SCB structure. The elastomer naturally wicks through the silicon spring gaps from the underside of the SCB, using these gaps as a network of channels to reach all areas requiring underfill.

### Underfill Material

For this new process, KE-1280-A/B silicone elastomer from Shin-Etsu was selected. This two-component addition cure material forms a true elastomer with Shore A hardness of 24, providing minimal mechanical interference with the silicon spring structure while maintaining position after cure. The material offers excellent electrical properties (volume resistivity 1.0 TΩ·m, dielectric strength 25 kV/mm) and is UL 94 V-0 rated. Despite its relatively high viscosity (1700 cP), calculations indicate it should wick through the structure in less than 1 second due to capillary action.

Key advantages of KE-1280-A/B include:
Addition cure chemistry ensures complete cure in confined spaces with no byproducts
Good adhesion to silicon and circuit board materials
6-hour working time decouples underfill process from elastomer mixing
Heat cure at 120° C. for 1 hour
Operating temperature range of −40 to +180° C.
Self-leveling properties
Controlled low molecular weight siloxane content

If an underfill elastomer is to be used, chemical compatibility with the coolant needs to be established. This is 2-PIC coolant for JETSTREAM, and supercritical CO₂ for JETSCI. Preferably, the underfill elastomer would be compatible with both coolants.

### Underfill Process

The underfill process consists of five simple steps:

First, the fully populated SCB is lowered into a bath of uncured elastomeric underfill material. The immersion depth must reach above the bottom surface of the SCB but remain below the top surface, a tolerance easily achieved given the approximately 700 μm difference between these levels.

Second, the low viscosity elastomer wicks through the silicon spring gaps from the underside of the SCB. The spring gaps provide a network of channels allowing the elastomer to flow into the microbump regions under all chips in the array and up through the narrow gaps between chips.

Third, excess uncured elastomer is wiped from the bottom surface of the SCB. The silicon springs, being substantially more robust than typical silicon interposer structures, require no special protection during this step.

Fourth, the elastomer undergoes thermal cure. Extended cure times or elevated temperatures may be employed to ensure complete cure throughout the structure, as there are no adverse effects from overcure.

Finally, the bottom surface of the SCB undergoes O₂ plasma cleaning to remove any residual elastomer that could interfere with subsequent CGA column attachment. A second plasma cleaning step may be required if optical inspection reveals remaining elastomer residue.

This simplified process eliminates the complexity of conventional underfill dispensing while ensuring complete and void-free underfill coverage throughout the SCB structure.

FIG. 18m shows the SCB cross section 358 after underfill. The underfill silicone elastomer 262 wicks through the entire populated SCB via the spring gaps and into the microbump region under the chip stacks 240.

Summary of Key Differences Vs. Thin Interposers

Unlike thin interposers (50-100 μm), the SCB:
remains ~710 μm for mechanical robustness,
integrates silicon springs as compliant/mechanical features,
functions as a silicon circuit board replacing interposer, organic substrate, and FR4 PCB,
provisions board-level power planes and a multi-plane data fabric, and
supports normal-to-surface PCBs via CGA or other compliant verticals connections.

### Performance, Yield and Reliability

High frequency signal performance is achieved by routing all high frequency signals (HBM/HBF and UCIe 2.0) in the RDL adjacent to the active chiplets, and not through the TSVs. The exception to this is the UCIe 2.0 signals routed to off-SCB PCIe 6.0 converter chips for connection to external systems. However, these UCIe 2.0 signals are downrated to whatever the off-SCB systems will sustain, not the maximum frequency obtained through the RDL wiring between adjacent TRIMERA or CPU stacks.

Electrical yield and reliability is maintained through extensive fault tolerance, with all signals doubled on separate layers. The fault tolerance incorporated in HBM/HBF and UCIe 2.0 also contributes to overall yield and reliability.

Mechanical reliability risks are addressed by silicon springs, thick silicon, conservative TSV use and thick Cu-RDL design.

### WSSCB Testing

Existing ATE equipment and probe cards are poorly suited for testing passive SCBs and silicon interposers. A WSSCB may have millions of USR wires between two microbump landing pads. As there are no active devices in a WSSCB, there can be no BIST or JTAG, so each wire must be probed at each end to ensure continuity.

A MEMS test probe chip enables high-density, precision electrical testing of SCBs and WSSCBs, and can also be used for passive silicon interposers. The probe chip comprises an array of Archimedean spiral probe springs, each incorporating a triangular arrangement of contact tips at its center. The probe design minimizes contact scrub through continuous scrub direction change along the spiral, while maintaining required contact force and deflection characteristics.

### Test Springs Completely Unrelated to WSSCB Silicon Springs

It is important to note that the test probe springs are completely unrelated to the silicon springs that provide thermal and mechanical stress isolation within the WSSCB. The Archimedean spirals of the test probe chip are unrelated to the Fermat-Archimedean (FA) silicon springs of the WSSCB.

### Scale and Density

The MEMS test probe chip measures approximately 32 mm×19 mm and contains more than 112,000 individual probe springs, enabling simultaneous testing of all HBM and UCIe 2.0 signal lines of one SCB module of the WSSCB.

This includes approximately 6,000 HBM signal connections and 50,000 UCIe signal lines, each of which must be contacted at both ends to test them. There are also a small number of miscellaneous slow signals, and a large number of power and ground connections, so the total number of probe springs will be around 160,000.

The test probe springs have a spiral configuration to minimize scrub. Scrub magnitude is almost completely cancelled by the constantly rotating scrub direction along the length of spiral cantilever. Minimizing scrub is important to maintain probe chip lifetime.

The probe layout matches the SCB micro bump pattern of one SCB module, and the UCIe 2.0 connections of the surrounding SCB modules that connect to the current module SCB connections. This enables go/no-go testing of the WSSCB on a module-by-module basis. Any module regions of the WSSCB with defects can be logged, so that dummy chips are attached during chip attach which bypass the defective module and maintain physical properties such as chip height of the array.

### Force Characteristics

With each probe spring providing approximately 2 gram-force (gf) at operating deflection, the total contact force across all probes is approximately 64 kilogram-force (kgf). This substantial total force necessitates precise mechanical design of both the probe chip support structure and the test fixture to maintain uniform contact across the entire array while preventing mechanical damage to the WSSCB. Critically, the test chip must be precisely parallel to the WSSCB, to ensure that all spiral test contacts make contract with the WSSCB and are within the required deflection range. It is also essential that the test probe chip does not “crash into” the WSSCB, as contacting the WSSCB with 64 kgf could destroy both the WSSCB and the probe chip.

### Test Configuration

The probe array is configured in multiple test chains that enable verification of both conductivity and shorts between all signal lines. The test chains are arranged to efficiently test adjacent HBM signals and UCIe signals. This configuration enables 100% testing of all signal paths, which is critical for WSSCB functionality and cannot be achieved with conventional probe card technology. The probe chip and system is very simple—it just verifies opens and shorts in long chains of alternating connection in the WSSCB and the probe chip. It cannot isolate where a fault is in 16,000 wires simultaneously tested, but this is not necessary. All that is required is a go/no-go decision for the SCB module in the array.

### Structure and Dimensions

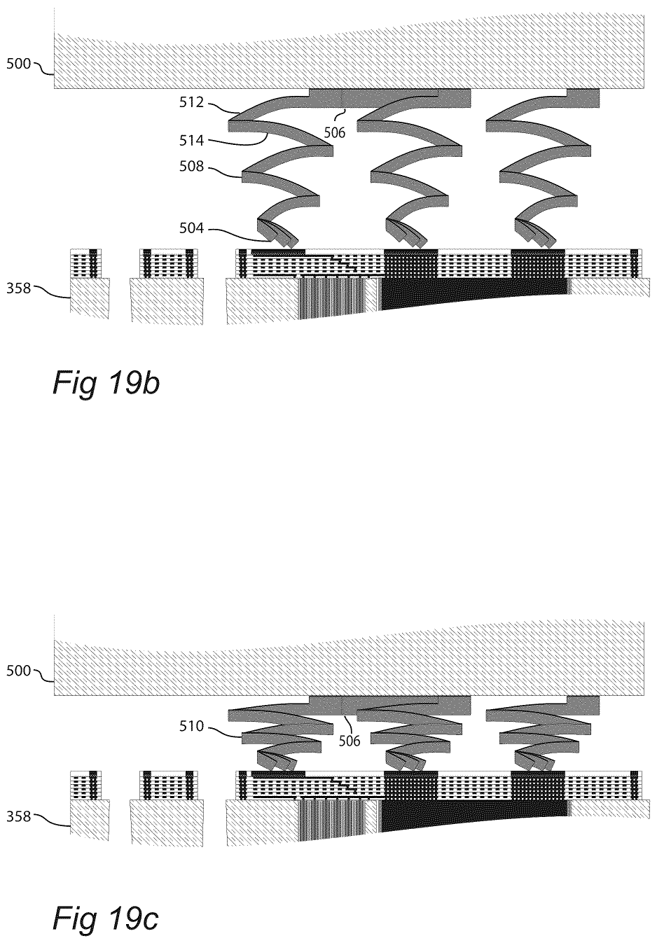

The probe chip is fabricated on a silicon substrate with an array of around 50,000 spiral probe springs. FIG. 19a shows a top view of a portion of the probe chip. Shown are the spiral probe springs 502, the probe tips 504, and the anchor and connection between springs 506.

Each spiral spring comprises an Archimedean spiral with an outer radius of 35 μm and a central void of 30 μm diameter. The spiral arm has a width of 8 μm with a 2 μm gap between turns, resulting in a 10 μm pitch per turn. The spiral completes 2.5 turns from its outer anchor to the central region, achieving a total spring path length of approximately 390 μm.

At the center of each spiral spring is a triangular arrangement of three contact tips, each 5 μm in width and spaced 120 degrees apart at a radius of 12 μm from the spiral center. The contact tips are plated with hard gold to ensure reliable electrical contact and wear resistance.

The probe array is configured with a 73 μm pitch between adjacent probes, to accommodate the HBM3 and HBM4 micro bump minimum pitch. Signal routing channels between probes are 10 μm in width, accommodating test chain connections while maintaining structural integrity.

### Layer Structure and Materials

The probe chip comprises multiple functional layers. The base substrate is a silicon wafer with a 2 μm thermal silicon dioxide isolation layer. The structural layer consists of 0.2 μm of silicon nitride followed by 0.1 μm of titanium nitride, providing mechanical strength and electrical conductivity. The main conductor layer is 3 μm of electroplated hard gold, with a hardness of around 200 HK25.

### Fabrication Process

The fabrication process employs standard MEMS manufacturing techniques. The process begins with thermal oxidation of the silicon wafer to form the sacrificial layer. Photoresist is applied and patterned to define a disk under the spiral cantilever probes. The remainder of the oxide layer, but especially the oxide under the anchors, the lines connecting test probes, and the bond pads, is etched using this mask.

Silicon nitride (SiN) is then deposited using low-pressure chemical vapor deposition (LPCVD), followed by physical vapor deposition (PVD) of the titanium nitride (TiN) layer. The SiN layer forms dielectric isolation of the probe anchors, wiring, and bond pads from the silicon wafer, and forms the low coefficient of thermal expansion (CTE) bottom layer of the cantilever springs. The TiN forms the relatively high CTE layer of the springs. The cantilever curl is affected by the layer thicknesses, the Young's modulus, the CTE and the difference between deposition temperature and operating temperature of each of the SiN, TiN, and hard gold layers.

A gold seed layer is deposited to enable subsequent electroplating. Photoresist is applied and patterned to define the spiral springs and contact tips. Hard gold is electroplated to the required thickness, followed by resist stripping and seed layer etching. The structural layer is then patterned using reactive ion etching, using the hard gold layer as a mask.

The final step is a release etch of the sacrificial oxide, freeing the spiral springs while maintaining anchor points at their outer radius. Critical point drying is employed to prevent stiction during the release process.

### Test Chain Configuration

The probes are connected in sequential chains to enable efficient testing of multiple contacts. The design incorporates redundant routing paths and daisy-chain verification capability. Multiple probe tips per contact ensure reliable electrical connection.

### Performance Specifications

The probe design achieves contact resistance below 100 milliohms and maintains functionality for over one million touch-downs. The maximum vertical deflection is 110 μm, with operation verified from −55° C. to 125° C. Positioning accuracy is maintained within ±2 μm.

The spiral geometry minimizes scrub damage through continuous direction change during deflection, resulting in theoretical scrub cancellation and practical scrub distances below 1 μm. This characteristic is particularly important for testing fine-pitch micro bump arrays without causing damage to the contact surfaces, and for test probe longevity.

### Test Methodology Integration

The probe chip design enables both serial and parallel testing configurations. The test chains can be arranged to test adjacent bumps sequentially or to test multiple bump pairs simultaneously. Each probe's three-point contact arrangement provides redundancy while maintaining precise positioning relative to the test target.

The probe springs exhibit consistent force-deflection characteristics across their operating range. The spring constant remains linear up to the maximum designed deflection of 110 μm, ensuring predictable contact force throughout the test cycle. The triangular arrangement of contact points provides mechanical stability during touchdown, preventing probe tip rotation or asymmetric loading.

### Design Optimization Considerations

The spiral geometry is optimized for several competing requirements. The outer radius of 35 μm and 2.5 turns provides sufficient spring length for the required compliance while maintaining the compact footprint necessary for high-density arrays. The 8 μm spring width balances mechanical strength against flexibility, while the 2 μm gap between turns prevents contact between adjacent segments during maximum deflection.

### Electrical Performance

The conductive path through each probe is designed to minimize electrical resistance while maintaining mechanical compliance. The titanium nitride layer provides additional current-carrying capacity parallel to the hard gold conductor layer. The total resistance of each probe, including contact resistance, remains below 100 milliohms throughout its operating lifetime.

### Manufacturing Considerations

Critical dimensions during fabrication must be controlled. The 2 μm gap between spiral turns represents the minimum feature size for the process. Mask alignment tolerance of ±0.5 μm is required to maintain proper registration between layers.

### Reliability and Quality Control

The probe design incorporates several features to ensure long-term reliability. The hard gold contact surface maintains its mechanical and electrical properties over multiple touch-down cycles, with minimal material transfer or surface degradation. The silicon nitride structural layer provides mechanical stability while preventing metal fatigue in the conductor layers.

Contact surface wear is monitored through periodic resistance measurements and physical inspection. The three-point contact arrangement ensures that testing can continue even if one contact point shows increased resistance.

### Operation of the Spiral Probes

FIG. 19b shows a side view of three spiral probes 508 of a MEMS test probe chip 500 at the instant they touch down on the landing pads in the RDL 538. Shown is a side view of uncompressed spiral probe spring 508, with the probe tips 504 in the process of making contact with the microbump landing pads of the SCB 538. The spiral probe 508 is composed of three layers:
a SiN layer,
a TiN layer, which are too thin to discern apart at this scale, so appear as a single ceramic layer 512, and
A relatively thick hard gold layer 514.

The spiral probe is anchored to the MEMS test probe chip 500 by the anchor and connection between springs 506.

FIG. 19a shows a side view of the three spiral probes 510 under full compression after they make full contact with the microbump landing pads of the SCB 538.

The spiral probe is anchored to the MEMS test probe chip by the anchor and connection between springs.

### Testing TSVs

The majority of TSVs in an WSSCB are power and ground TSVs. However, the WSSCB design also includes a small number of signal TSVs that connect microbump landing pads on the top surface to connections on the bottom surface of the WSSCB for I3C two-wire connections to the PSU PCBs, and GbE and PCIe connections. To simplify testing of these connections without requiring probe access to the bottom surface of the WSSCB, each signal TSV incorporates a connection verification microbump landing pad on the top surface. This verification pad connects independently to the TSV through the RDL layers. Testing the connectivity between the signal microbump landing pad and its corresponding verification pad effectively tests the TSV connection without requiring bottom-side probing, maintaining the simplicity of the single-sided test approach.

### Testing the Edges of the Array

The WSSCB employs a specialized routing strategy at the edges of the module array, which are adjacent to 800 GbE and PCIE 6.0 sites instead of other SCB modules (note: in some embodiments, the 800 GbE capability is omitted to reduce design and verification complexity). This strategy enables testing with a single probe chip design. Instead of direct point-to-point connections between the BIDs UCIe interfaces and the 800 GbE or PCIE 6.0 TSVs, the connections follow a loop-back pattern. From the BID each UCIe signal routes to its corresponding 800 GbE or PCIE 6.0 TSV, then continues to a test microbump landing pad positioned where the next module's UCIe connection would be if it were an interior position. This design eliminates the need for multiple probe chip configurations for testing interior, corner, and edge array positions.

### WSSCB Test System

The test system mechanical architecture consists of a heavily reinforced precision Z-axis stage supporting the MEMS probe chip, with force feedback control to prevent probe damage. The stage must handle a total contact force of around 320 kilogram-force (kgf) due to the approximately 160,000 individual probes in the array, each operating at around 2 grams-force (gf). Lower contact forces, such as 0.5 gf, can reduce the total probe force to approximately 40 kgf However, such low contact force requires specific attention to the probe design and may become unreliable after a smaller number of probe touchdowns. This substantial force necessitates highly robust mechanical design of both the Z-axis stage and the X-Y positioning stage. The stage maintains parallelism between the probe chip and WSSCB surface within ±10 arc-seconds to ensure uniform contact across all probe points. A precision X-Y stage positions each module location under the probe chip with ±2 μm accuracy, with sufficient stiffness to maintain position accuracy under the high contact forces.

The WSSCB is especially designed to withstand high contact forces in the presence of contaminants by the use of silicon springs.

The probe chip connects to simple continuity testing circuitry that verifies the integrity of daisy-chained connections through the probe array. The test sequence proceeds as follows:
The WSSCB wafer is loaded onto the test chuck and aligned using standard wafer handling equipment.
The system moves to the first module position and performs a probe touchdown with controlled force ramping.
The continuity test executes in under 100 milliseconds, checking all signal paths simultaneously.
The system records a binary go/no-go result for the module position.
The probe lifts and the X-Y stage moves the wafer to the next module position.
Steps 2-5 repeat until all module positions are tested.

The entire wafer test completes in a few minutes, with 172 touchdowns for a typical wafer-scale WSSCB. The system generates a wafer map indicating the status of each module position, which drives subsequent automated assembly decisions.

For WSSCBs meeting minimum yield criteria, the map determines chip attachment strategy:
“Go” positions receive known good die (KGD) HBM/HBF stacks and logic dies
“No-go” positions receive dummy mechanical HBM/HBF stacks and bypass-enabled logic dies

The bypass-enabled logic dies maintain system connectivity by routing UCIe 2.0 signals between adjacent modules, effectively removing the failed module from the logical topology while preserving mechanical and thermal characteristics of the array.

Each probe chip typically achieves one million touchdowns before replacement, enabling testing of approximately 6,000 wafers per probe. This allows for scheduled maintenance and probe replacement during regular system maintenance intervals.

The simplicity of this test methodology, combined with high parallelism and rapid execution, enables comprehensive testing of the passive WSSCB structures without requiring BIST or JTAG capabilities. This approach achieves extensive coverage of critical signal paths while maintaining practical test times and costs.

The test results provide essential data for:
Assembly optimization
Yield analysis and process control
System configuration management
Reliability prediction

This testing strategy balances thoroughness with throughput, enabling practical implementation of wafer-scale integration while maintaining system reliability through comprehensive interconnect verification.

The final test process is to laser mark the WSSCB and to maintain genealogy through assembly.

### REFERENCES

Agah, Amir & Fakhraie, S. & Emami, Azita. (2007). Tertiary-Tree 12-GHz 32-bit Adder in 65 nm Technology. 3006-3009. 10.1109/ISCAS.2007.377979.
Amkor Technology. (2020). A new RDL-first PoP fan-out wafer-level package process with chip-to-wafer bonding technology. https://amkor.com/wp-content/uploads/2020/11/A-New-RDL-First-PoP-Fan-Out-Wafer-Level-Package-Process-with-Chip-to-Wafer-Bonding-Technology.pdf
Drost, M., Marschmeyer, S., Fraschke, M., Fursenko, O., Barwolf, F., Costina, I., Mahadevaiah, M. K., Lisker, M. (2022). Etch mechanism of an Al₂O₃ hard mask in the Bosch process. Micro and Nano Engineering. Vol. 14, 2022, 100102. https://doi.org/10.1016/j.mne.2021.100102.
Frantar, E., & Alistarh, D. (2022). GPTQ: GPU-Friendly Post-Training Quantization for Large Language Models. arXiv preprint arXiv:2210.17323.
Fronk, Brian & Rattner, Alexander. (2016). High-Flux Thermal Management With Supercritical Fluids. Journal of Heat Transfer. 138. 10.1115/1.4034053.
Fuad, K. A. A., & Chen, L. (2023). A Survey on Sparsity Exploration in Transformer-Based Accelerators. Electronics, 12(10), 2299. https://doi.org/10.3390/electronics12102299
Ghaffarian, R. (2012a). Reliability of CGA/LGA/HDI package board/assembly (JPL Publication). NASA/NEPP. https://nepp.nasa.gov/files/22577/11_129_JPL_Ghaffarian_Reliability%20of%/20CGA %20LGA%20HDI%20Package%20Board%20Assembly%20JPL%20pub%2012-3_%20%20%20%20%20%202%2028%2012.pdf
Ghaffarian, R. (2012b). Mechanical methods for array package assembly (BOK). NASA/NEPP. https://nepp.nasa.gov/files/23824/12_139_JPL_Ghaffarian_BOK%20%20Mechanical%20Methods%20for%20Array%20Package%20Assembly%20jpl%20pub%2012_14%20r ec%209_29_12.pdf
Gholami, A., Kim, S., Dong, Z., Yao, Z., Mahoney, M. W., Keutzer, K. (2021). A Survey of Quantization Methods for Efficient Neural Network Inference. arXiv:2103.13630v3. https://doi.org/10.48550/arXiv.2103.13630.
Harwood, Mike & Warke, Nirmal & Simpson, Richard et al. (2007). A 12.5 Gb/s SerDes in 65 nm CMOS Using a Baud-Rate ADC with Digital Receiver Equalization and Clock Recovery. 436-591. 10.1109/ISSCC.2007.373481.
Hoang, C. H., Rangarajan, S., Manaserh, Y., Tradat, M., Mohsenian, G., Choobineh, L., Ortega, A., Schiffres, S., & Sammakia, B. (2023). A review of recent developments in pumped two-phase cooling technologies for electronic devices. IEEE (review). Heat flux demonstrations up to 910 W/cm² summarized.
Husain, A., Ariz, M., Al-Rawahi, N. Z. H., Ansari, M. Z. (2016). Thermal performance analysis of a hybrid micro-channel, -pillar and -jet impingement heat sink. Applied Thermal Engineering, Volume 102, 2016, Pages 989-1000, ISSN 1359-4311, https://doi.org/10.1016/j.applthermaleng.2016.03.048.
ITherm Conference Program (2023). Through-Silicon Microchannels for 3D Heterogeneous Integration—demo noting 1,365 W/cm² dissipation capability with two-phase water in through-silicon channels.
Jones, A., & Kelly, C. (2025). Code execution with MCP: Building more efficient agents. Anthropic Engineering Blog, available at https://www.anthropic.com/engineering/code-execution-with-mcp. Anthropic
Jouppi, N. P., Young, C., Patil, N., Patterson, D., Agrawal, G., Bajwa, R., Bates, S., Bhatia, S., Boden, N., Borchers, A., Boyle, R., Cantin, P.-L., Chao, C., Clark, C., Coriell, J., Daley, M., Dau, M., Dean, J., Gelb, B., . . . Yoon, D. H. (2017). In-datacenter performance analysis of a tensor processing unit. arXiv. https://arxiv.org/abs/1704.04760.
Kachris, C. (2025). A Survey on Hardware Accelerators for Large Language Models. Applied Sciences, 15(2), 586. https://doi.org/10.3390/app15020586
Kim, J., Bae, J., Kim, H. et al. (2024) The Activation Precision Bottleneck in Large Language Models, arXiv:2407.14435.
Kung, H. T., Leiserson, C. E. (1978). Systolic Arrays for (VLSI). CMU-CS-79-103.
Ren, R., Chen, S., Mao, H., Fu, W., Hu, Y., & Huang, J. (2022). ZeroQuant-FP: A Memory-Efficient Fine-tuning Approach for Large Language Models. arXiv preprint arXiv:2211.08395.
Ritchie, R. O. (2003). Failure of silicon: Crack formation and propagation [Lecture notes]. University of California, Berkeley. https://people.eecs.berkeley.edu/~pister/147/SiliconFailureRitchie2003.pdf
Semiconductor Packaging News. (2025). Current characterization of various Cu RDL designs in wafer-level packaging. https://www.semiconductorpackagingnews.com/uploads/2/2025_SPN_White_Paper_-_Current_Characterization_Of_Various_Cu_RDL_Designs_In_WLP.pdf
Shubin, I., Shubin, A., Vetury, R., & Oehler, S. (2010). A package demonstration with solder-free compliant flexible interconnects. https://npfet.com/publication/shubin_package 2010/shubin_package 2010.pdf
Silicon Valley Microelectronics, Inc. (2020). 300 mm silicon wafer (Product code SV027): Specifications [Datasheet]. https://svmi.com/wp-content/uploads/2020/09/SV027.pdf
Wang, Y., Zhang, Y., Zhao, H., & Li, X. (2024). Nanostructured compliant interconnections for advanced micro-electronic packaging. Materials & Design, 241, 112026. https://www.sciencedirect.com/science/article/pii/S0264127524005410
Xiao, G., Lin, J., Seznec, M., J., Wu, H., Demouth, J., Han, (2022). SmoothQuant: Accurate and Efficient Post-Training Quantization for Large Language Models. arXiv:2211.10438v7. https://doi.org/10.48550/arXiv.2211.10438
Yu, X., Dai, F. F., Irwin, J. D., & Jaeger, R. C. (2008). A 12 GHz 1.9 W Direct Digital Synthesizer MMIC Implemented in 0.18 m SiGe BiCMOS Technology. IEEE Journal of Solid-State Circuits, 43, 1384-1393.
Zhang, L., Seshadri, V., & Venkataramani, G. (2025) A Systematic Review of Sub-8-bit LLM Inference: Weight and Activation Precision Trade-offs arXiv:2501.01865.
Zhang, X., Huang, Y., Wang, Q., Zhang, L., & Sun, F. (2018). Heating-rate dependence of the mechanisms of copper pumping in through-silicon vias. Journal of Electronic Materials, 47(11), 6217-6226. https://doi.org/10.1007/s11664-018-6805-5
Zhao, Yatian & Zhao, Hongyue & He, Kai & Qi, Xiaowei & Zeng, Xianda & Liu, Hongkang. (2025). Heat transfer mechanism and influence factors in supercritical CO2 jet impingement cooling under unconventional physical property changes. Physics of Fluids. 37. 10.1063/5.0248844.
Zhuang, X., Wang, H., Lu, H., Yang, Z., & Guo, H. (2023). Numerical Investigation of Heat Transfer and Flow Characteristics of Supercritical CO2 in Solar Tower Microchannel Receivers at High Temperature. Energies, 16(18), 6445. https://doi.org/10.3390/en16186445

### General

This application describes an aspect of the high-performance AI inference architecture known as ZettaLith. Additional aspects of the overall system—including specific processing element designs, dataflow mappings, memory hierarchies, substrate implementations, interconnect fabrics, fault-tolerance mechanisms, power delivery architectures, and thermal management systems—are disclosed in the concurrently filed patent applications commonly assigned to the applicant (the “ZettaLith Portfolio”), each of which is incorporated herein by reference in its entirety.

The embodiments described herein are illustrative and not restrictive. Those skilled in the art will recognize that variations and modifications may be made without departing from the broad inventive concepts, all of which are intended to fall within the scope of the appended claims.

Throughout this specification and the claims, the terms “comprise,” “comprises,” and “comprising” indicate that the subsequent elements are non-exhaustive. When an exclusive list is intended, the phrase “consists of” or “consists essentially of” is used.

Technical and scientific terms not specifically defined herein carry their broadest meaning commonly understood in the relevant art while maintaining claim validity.

The invention may be embodied in many forms beyond those specifically disclosed. The examples and drawings illustrate principles of the invention and demonstrate its practical application but are not intended to limit the scope. Features described in connection with particular embodiments may be combined, substituted, or separated in whole or in part while remaining within the scope of the claims.

Where numerical ranges are stated, all values and sub-ranges within those limits are encompassed. Unless specifically stated otherwise, singular forms (“a,” “an,” “the”) include plural referents, and vice versa.

Functions, operations, and processes described herein—including those shown in block diagrams, flowcharts, or schematic representations—may be implemented in hardware, firmware, microcode, software executed by processors, programmable logic, or combinations thereof. Equivalent structures, materials, or acts performing substantially the same function in substantially the same way to achieve substantially the same result are intended to fall within the scope of the claims, even if not specifically described.

Terms such as ‘parameter,’ ‘weight,’ ‘activation,’ ‘tensor,’ ‘model,’ and ‘token’ refer to physically encoded data states stored in tangible, non-transitory memory or register structures (e.g., the HILT, HBM, or latch arrays described herein). Operations described as ‘inference,’ ‘calculation,’ ‘accumulation,’ or ‘learning’ refer to the deterministic transformation of these physical states via electromagnetic signaling within the processing elements and interconnects. These terms do not refer to mental processes or abstract mathematical concepts disjoint from the physical hardware that implements them.

Claim terms are to be construed according to their ordinary and customary meaning as understood by a person of ordinary skill in the art at the time of filing, unless explicitly redefined herein.

If any embodiment is described as employing or producing computer-readable media, such media are understood to be non-transitory tangible storage media (for example, magnetic, optical, or semiconductor memory devices) and expressly exclude propagated signals per 35 U.S.C. § 101.

To the extent an embodiment employs algorithmic logic, mathematical expressions, or artificial-intelligence inference structures, such descriptions are intended to represent corresponding physical, electrical, or computational implementations that perform equivalent functions. The applicant expresses no intention to invoke 35 U.S.C. § 112(f) (or pre-AIA sixth paragraph) for any claim element in this or any related application, unless the specific claim element is explicitly recited using the phrase ‘means for’ or ‘step for.’ The use of terms such as ‘unit,’ ‘module,’ ‘engine,’ ‘logic,’ ‘circuitry,’ or ‘element’ is intended to refer to hardware structures and not to invoke means-plus-function interpretation.

### Related Patent Applications (ZETTALITH Portfolio)

The present application is one of a set of concurrently filed applications, each of which is incorporated herein by reference in its entirety. The set comprises:
Application ZET001, entitled “Multi-Die Inference Accelerator With On-Stack Accumulation And Activation Distribution”; Application ZET002, entitled “Column-Array Systolic Computation with Accumulation During Execution (CASCADE)”; Application ZET003, entitled “Phase-Interleaved Column Architecture for High-Frequency Neural-Network Matrix Multiplication”; Application ZET004, entitled “Fault-Tolerant Logical-to-Physical Column Mapping for Column-Oriented Neural-Network Compute Arrays”; Application ZET005, entitled “Hierarchical Activation Broadcast Network For Column-Oriented Neural-Network Compute Arrays”; Application ZET006, entitled “Compiler and Firmware Mapping Framework for Column-Oriented Neural-Network Compute Arrays”; Application ZET007, entitled “Multi-Tile CASCADE Fabric for Scalable Column-Oriented Neural-Network Inference”; Application ZET008, entitled “Column-Retentive Activation Buffers for Column-Oriented Neural-Network Compute Arrays”; Application ZET009, entitled “Phase-Adaptive Clock Gating for Column-Oriented Neural-Network Compute Arrays”; Application ZET010, entitled “Adaptive Column-Redundancy Scheduling for Column-Oriented Neural-Network Compute Arrays”;
Application ZET011, entitled “Per-Column Bias-Initialized Output-Sum Recirculation for Column-Oriented Neural-Network Compute Arrays”; Application ZET012, entitled “Row-Synchronous Activation Broadcast with Column-Local Accumulation for Matrix Multiplication”; Application ZET013, entitled “Pipelined Fused Multiply-Add Processing Element for FP4 Weight Arithmetic with FP8 Accumulation”; Application ZET014, entitled “Dual-Polarity FP4 Weight Reuse Network for Pipelined Mixed-Precision Fused Multiply-Add Processing Elements”; Application ZET015, entitled “Two-Bit Exponent Combiner with Normalization Carry Injection for FP4 Processing Elements”; Application ZET016, entitled “Deterministic Dual-Stage Pipelined Mixed-Precision Processing Element for Distributed AI Inference Arrays”; Application ZET017, entitled “Bounded-Carry Fixed-Delay FP8 Accumulator for Pipelined Mixed-Precision Processing Elements”; Application ZET018, entitled “Local-Bias Adaptive Drive for Timing Stabilization in Pipelined Mixed-Precision Processing Elements”; Application ZET019, entitled “Single Wire Composite Signaling for Timing Control in Pipelined Mixed Precision Processing Elements”; Application ZET020, entitled “Delay-Isomorphic and Mirror-Symmetric Physical Layout for Pipelined Low-Precision Floating-Point Processing Elements”;
Application ZET021, entitled “Column Aligned Vertical Reduction Network for FP4 Weight and FP8 Activation Systolic Arrays”; Application ZET022, entitled “Hybrid-Bonded Three-Die Compute Stack Architecture for Zetta-Scale Computing Systems”; Application ZET023, entitled “Wafer-Scale Silicon Circuit Board for Zetta-Scale Rack-Level Computing Systems”; Application ZET024, entitled “Compliant-Spring Monolithic Substrate for Wafer- and Panel-Scale Electrical Interconnects”; Application ZET025, entitled “Targeted Jet-Cooling System for Zetta-Scale Computing Assemblies”; Application ZET026, entitled “Distributed Power-Partitioning Architecture with Inverted Board-to-Silicon Configuration for Wafer-Scale Computing Systems”; Application ZET027, entitled “Hierarchical Latch-Tree Memory Architecture for Large-Scale Parallel Computing Systems”; Application ZET028, entitled “Perpendicular Power-Supply Integration in a Unified Power-and-Signal Monolithic Substrate for Wafer-Scale Computing Systems”; Application ZET029, entitled “Adaptive Multi-Domain Signaling Architecture for Zetta-Scale Computing Systems”; Application ZET030, entitled “Activation Broadcast Latch Tree for AI Accelerators”;
Application ZET031, entitled “Cyclic Redundant Spare Testing (CREST)”; Application ZET032, entitled “Hybrid-Memory Substrate Accelerator With Substrate-Integrated Activation Broadcast Fabric”; Application ZET033, entitled “Tri-Die Inference Module With In-Module Activation Distribution and Accumulation”; Application ZET034, entitled “Hybrid-Bonded Full-Custom Compute-Peripheral Assembly for Early Advanced-Node Integration”; Application ZET035, entitled “Full-Custom Manually Designed Semiconductor Devices Exceeding One Billion Transistors”; Application ZET036, entitled “Pad-less Full-Custom Compute Die Relying Solely on Hybrid Bonded Inter-Die Connections”; Application ZET037, entitled “Mixed-Node Manual-Automated Integration Framework for Early Functional Compute Systems”; Application ZET038, entitled “Machine-Learned Surrogate-Rule and Wafer-Feedback Workflow for Early Design on Unqualified Semiconductor Nodes”; Application ZET039, entitled “Recursive Hybrid-Bonded Multi-Die Platform for Early Access to Unqualified Semiconductor Nodes”; Application ZET040, entitled “Manual Repetitive Compute-Tile Die With Ultra-High Density and Hybrid-Bond Interface”;
Application ZET041, entitled “Multi-Die SHAPE Product Family With Peripheral Reuse and Intermediate-Die Adaptation Across Process-Node Generations”; Application ZET042, entitled “Reusable Base Interface Die With Standardized External Interfaces for Heterogeneous Processing Stacks”; Application ZET043, entitled “Sea of SRAM”; Application ZET044, entitled “Inter-Layer Multiplexer Bypass Architecture for Fault-Tolerant Compute Arrays”; Application ZET045, entitled “Timing-Synchronized Multiplexer Control for Layer-Boundary Reconfiguration in Compute Arrays”; Application ZET046, entitled “Software-Managed Redundancy System for Column Substitution in Compute Arrays”; Application ZET047, entitled “Configuration-Map System for Multiplexer-Based Redundant Column Routing in Compute Arrays”; Application ZET048, entitled “Predictive Redundancy Optimization for Multiplexer-Controlled Compute Arrays”; Application ZET049, entitled “Integrated Diagnostic and Redundancy-Configuration System for Multiplexer-Controlled Compute Arrays”; Application ZET050, entitled “Package-Level Coordination of Intra-Die Column Redundancy for Bonded Compute Modules”;
Application ZET051, entitled “Secure Authentication and Distribution of Redundancy Configuration Data for Compute Modules”; Application ZET052, entitled “Redundancy-Aware Performance and Power Balancing for Compute Systems”; Application ZET053, entitled “Redundancy-State Telemetry Interface for Fleet-Level Analytics”; Application ZET054, entitled “Row-Level Activation Path Fault Tolerance Using Zero-Weight Substitution”; Application ZET055, entitled “Electrically Routed Through-Silicon Spring Substrate”; Application ZET056, entitled “Anisotropic Compliance Matrix with Integrated Thermal Isolation”; Application ZET057, entitled “Multi-Geometry Lithographic Spring Library for Wafer-Scale Substrates”; Application ZET058, entitled “Fracture-Arrest and Overstress Management in Through-Silicon Spring Structures”; Application ZET059, entitled “Thermal-Segmentation and Heat-Flow Management Using Through-Silicon Spring Networks”; Application ZET060, entitled “Fermat-Archimedean Spiral Stress Relief Structures in Silicon”;
Application ZET061, entitled “Fault-Tolerant Wiring for Silicon Redistribution Layers”; Application ZET062, entitled “High Current Column Grid Array Pillars”; Application ZET063, entitled “Wafer-Scale Silicon Circuit Boards”; Application ZET064, entitled “All-Silicon Domain Compute System Architecture”; Application ZET065, entitled “Wafer-Scale All-Silicon Computational Domain with Passive Silicon Compliance and Redundant Interconnect Architecture”; Application ZET066, entitled “Wafer-Scale Heterogeneous All-Silicon Computational Domain Integrating Logic and Memory Assemblies”; Application ZET067, entitled “Wafer-Scale Silicon Substrate with Vertically Integrated Multi-Domain Power Delivery”; Application ZET068, entitled “Parallel Jet-Impingement Cooling System for Wafer-Scale All Silicon Computational Domains”; Application ZET069, entitled “Additively Manufactured Metallic Jet Manifold with Integrated Flow-Equalization Baffles”; Application ZET070, entitled “Two-Phase Jet-Impingement Cooling System for Wafer-Scale Semiconductor Assemblies”;
Application ZET071, entitled “Supercritical-Fluid Jet-Impingement Cooling System for Wafer Scale Semiconductor Assemblies”; Application ZET072, entitled “Flow-Equalized Jet-Impingement Manifold for Wafer-Scale Semiconductor Cooling”; Application ZET073, entitled “Modular All-Silicon Domain Architecture for Exa-Scale Computing Modules”; Application ZET074, entitled “Hybrid Volatile and Non-Volatile High-Bandwidth Memory Architecture for All-Silicon Domain AI Systems”; Application ZET075, entitled “Scalable Power and Thermal Management for PCI Express ExaFLOPS Accelerators”; Application ZET076, entitled “Multi-Form-Factor Mechanical and Electrical Interchangeability for Exa-Scale Compute Modules”; Application ZET077, entitled “Secure Local Inference and Model Ownership Framework”; Application ZET078, entitled “Network-Attached ExaLith Clusters for Edge and Datacenter Inference”; Application ZET079, entitled “Software Compatibility and Cross-Platform Stack Abstraction for AI Accelerators”; Application ZET080, entitled “Automated Conversion of Transformer Models for All-Silicon Domain Execution”;
Application ZET081, entitled “Stacked Laminar Busbar with CGA-Pitch Alignment for Vertical Power Injection”; Application ZET082, entitled “PetaFLOPS-Scale AI Inference IP Block At Under 5 Watts For SoC Integration”; Application ZET083, entitled “Simultaneous Silicon Spring and Chip Singulation DRIE”; Application ZET084, entitled “Underfill Process for Silicon Circuit Boards and Interposers”; Application ZET085, entitled “Vertical Interconnect Verification Structures for Bonded Semiconductor Stacks”; Application ZET086, entitled “Verification Pads for Single-Sided Testing of Through-Silicon Vias in Passive Substrates”; Application ZET087, entitled “Loop-Back Routing for Testing Array Edges in Silicon Circuit Boards and Interposers”; Application ZET088, entitled “Test Probe Chip for High-Density Microbump Arrays”; Application ZET089, entitled “Manufacturing Process for Silicon Circuit Boards”; Application ZET090, entitled “BitNet b1.58 AI Inference Engine”; Application ZET091, entitled “Integrated Computing Structure with more than One Billion Processing Elements”; and Application ZET092, entitled “Wafer-Scale 3D Stacked AI Inference Engine”.

I claim:

1. A computing apparatus comprising a plurality of vertical columns of processing elements configured to accumulate partial sums locally within each column during a matrix-multiplication operation, a broadcast-distribution network configured for each processing row to concurrently deliver an activation value to all of the columns of processing elements, and the broadcast-distribution network implemented as a hierarchical latch tree or resonant mesh that fans out activation values within a clock period while maintaining timing alignment among the columns.

2. The apparatus of claim 1, wherein the hierarchical latch tree comprises multiple branching stages of latch buffers arranged to reduce capacitive loading on any single node of the network.

3. The apparatus of claim 1, wherein the resonant mesh comprises a grid of transmission lines tuned to distribute activation transitions simultaneously across the array with reduced clock skew.

4. The apparatus of claim 1, wherein the broadcast-distribution network includes phase-balanced routing segments of equal electrical length to maintain synchronous arrival of activation values at each column input.

5. The apparatus of claim 1, wherein the broadcast-distribution network is fabricated on an interposer or separate die coupled to the compute die through high-density hybrid bonds.

6. The apparatus of claim 1, wherein the broadcast-distribution network includes synchronization latches positioned at branch boundaries to isolate local timing variation between network stages.

7. The apparatus of claim 1, wherein the network further comprises local repeaters configured to restore signal amplitude and maintain uniform propagation delay.

8. The apparatus of claim 1, wherein activation values are encoded as differential signals propagated along matched impedance lines of the broadcast network.

9. The apparatus of claim 1, wherein multiple broadcast planes operate in parallel to deliver distinct activation groups to disjoint column subsets.

10. The apparatus of claim 1, wherein the broadcast network is configured to operate at a reference clock frequency lower than the local column computation frequency.

11. A three-dimensional integrated circuit stack comprising a first die including processing elements organized as columns that accumulate partial sums locally within each column, a second die including a hierarchical broadcast-distribution network configured, for each processing row, to concurrently deliver an activation value to all columns of the first die, and a plurality of vertical interconnects coupling the second die to the first die to provide activation signals with substantially equal delay.

12. The three-dimensional integrated circuit stack of claim 11, wherein the hierarchical broadcast-distribution network comprises latch-based fan-out stages implemented in metal layers of the second die and aligned with corresponding columns of the first die.

13. The three-dimensional integrated circuit stack of claim 11, wherein the second die further comprises a global clock mesh phase-locked to a reference source that drives the hierarchical latch tree for synchronous activation delivery.

14. The three-dimensional integrated circuit stack of claim 11, wherein the hybrid-bond interconnect pitch and placement correspond to the spatial pitch of the column inputs on the first die.

15. The three-dimensional integrated circuit stack of claim 11, wherein activation signals are pre-emphasized or equalized on the second die to compensate for frequency-dependent losses through the hybrid-bond interface.

16. A method of distributing activation values in a column-oriented compute array comprising generating a set of activation values for a processing row, propagating each activation value through a hierarchical latch tree or resonant mesh network to concurrently reach all columns of processing elements within a clock period, and maintaining timing alignment between columns while minimizing capacitive loading and signal skew.

17. The method of claim 16, further comprising fabricating the broadcast-distribution network on a separate die or interposer and coupling it to a compute die through high-density hybrid bonds.

18. The method of claim 16, further comprising equalizing electrical path lengths and balancing propagation delay between all column fan-out branches.

19. The method of claim 16, further comprising distributing multiple activation values concurrently through independent broadcast planes to support multi-tensor or multi-head inference operations.

20. The method of claim 16, further comprising adjusting phase or drive strength of the broadcast network according to temperature or supply-voltage variation to maintain timing uniformity across the columns.
